(19) United States
(12) Patent Application Publication
(10) Pub. No.: US 2019/0049700 A1
(43) Pub. Date: Feb. 14, 2019

(54) IMAGING LENS AND IMAGING APPARATUS

(71) Applicant: Sony Corporation, Tokyo (JP)

(72) Inventors: Shinya Kunimatsu, Kanagawa (JP); Hitoshi Fukuhori, Kanagawa (JP); Masaki Tamura, Kanagawa (JP); Daigo Katsuragi, Kanagawa (JP); Yoshio Hosono, Tokyo (JP); Yasuhide Nihei, Kanagawa (JP)

(21) Appl. No.: 16/080,393

(22) PCT Filed: Apr. 7, 2017
(86) PCT No.: PCT/JP2017/014504

§ 371 Date: Aug. 28, 2018

(30) Foreign Application Priority Data
May 19, 2016 (JP) 2016-100377

(51) Int. Cl. G02B 13/00; G02B 9/64; G02B 27/00

(52) U.S. Cl. CPC G02B 13/0045; G02B 27/0025; G02B 9/64

(57) ABSTRACT

An imaging lens of the present disclosure includes, in order from object side toward image plane side, a first lens having a meniscus shape, the meniscus shape having a shape that is positioned near an optical axis and includes a convex surface that faces the object side, a second lens including a convex surface that faces, near the optical axis, the object side, and having, near the optical axis, positive refractive power, a third lens having, near the optical axis, negative refractive power, a fourth lens, a fifth lens, a sixth lens having, near the optical axis, positive refractive power, and a seventh lens having, near the optical axis, negative refractive power, and including a lens surface, the lens surface being positioned on the image plane side, and having an aspherical shape that has an inflection point.

### TECHNICAL FIELD

The present disclosure relates to an imaging lens that forms an optical image of an object on an imaging device such as a CCD (Charge Coupled Device) and a CMOS (Complementary Metal Oxide Semiconductor), and to an imaging apparatus that is mounted with the imaging lens to perform photographing, such as a digital still camera, a mobile phone with a camera, and an information mobile terminal with a camera.

### BACKGROUND ART

A thin digital still camera such as a card type camera is fabricated year after year, and reduction in size of an imaging apparatus is demanded. In addition, reduction in size of the imaging apparatus is also demanded in a mobile phone in order to reduce the thickness of the terminal itself and to secure a space for a lot of functions to be mounted. Therefore, demand for further reduction in size of the imaging lens mounted on the imaging apparatus is increasing.

In addition, together with reduction in size of the imaging device such as a CCD and a CMOS, the number of pixels is greatly increased by microfabrication of the pixel pitch of the imaging device. In accordance therewith, high performance is also demanded for the imaging lens used in the imaging apparatus.

### CITATION LIST

### Patent Literature

PTL 1: Japanese Unexamined Patent Application Publication No. 2015-072404

PTL 2: Japanese Unexamined Patent Application Publication No. 2014-145961

### SUMMARY OF THE INVENTION

In recent years, to address an imaging device with the increased number of pixels, development has been demanded, as the imaging lens, of a lens system that has high image-forming performance in the range from a center angle of view to a peripheral angle of view while achieving reduction of the total length. Furthermore, reduction of image deterioration due to ghost or flare has been demanded.

It is desirable to provide an imaging lens that makes it possible to favorably correct various aberrations while the lens is small-sized, and reduce image deterioration caused due to unnecessary light, and an imaging apparatus that is mounted with such an imaging lens.

A first imaging lens according to an embodiment of the present disclosure includes, in order from object side toward image plane side, a first lens having a meniscus shape, the meniscus shape having a shape that is positioned near an optical axis and includes a convex surface that faces the object side, a second lens including a convex surface that faces, near the optical axis, the object side, and having, near the optical axis, positive refractive power, a third lens having, near the optical axis, negative refractive power, a fourth lens, a fifth lens, a sixth lens having, near the optical axis, positive refractive power, and a seventh lens having, near the optical axis, negative refractive power, and including a lens surface, the lens surface being positioned on the image plane side and having an aspherical shape that has an inflection point.

A first imaging apparatus according to an embodiment of the present disclosure is provided with an imaging lens and an imaging device that outputs an imaging signal based on an optical image formed by the imaging lens. The imaging lens includes the first imaging lens according to the embodiment of the above-described present disclosure.

A second imaging lens according to an embodiment of the present disclosure includes, in order from object side toward image plane side, a first lens, a second lens that has, near the optical axis, positive refractive power, a third lens that has, near the optical axis, negative refractive power, a fourth lens, a fifth lens, a sixth lens that has, near the optical axis, positive refractive power, and a seventh lens that has, near the optical axis, negative refractive power, and includes a lens surface, on the image plane side, that has an aspherical shape having an inflection point, in which a following conditional expression is satisfied,

−0.5<f/f1<0.23 (1)

where

f is a focal length of a lens system as a whole, and

f1 is a focal length of the first lens.

A second imaging apparatus according to an embodiment of the present disclosure is provided with an imaging lens and an imaging device that outputs an imaging signal based on an optical image formed by the imaging lens. The imaging lens includes the second imaging lens according to the embodiment of the present disclosure.

The first and second imaging lenses or the first and second imaging apparatuses according to the respective embodiments of the present disclosure each have a configuration including seven lenses as a whole, and the optimization of the configuration of each lens is achieved.

The first and second imaging lenses or the first and second imaging apparatuses according to the respective embodiments of the present disclosure each have a configuration including seven lenses as a whole, and the optimization of the configuration of each lens is achieved. This makes it possible to favorably correct various aberrations while the lens is small-sized, and to reduce image deterioration caused due to unnecessary light.

It is to be noted that effects described here are non-limiting. Any of effects described in the present disclosure may be provided.

### BRIEF DESCRIPTION OF DRAWINGS

FIG. 1 is a lens cross-sectional diagram illustrating a first configuration example of an imaging lens according to an embodiment of the present disclosure.

FIG. 2 is an aberration diagram illustrating various aberrations in Numerical Example 1 in which specific numeral values are applied to the imaging lens illustrated in FIG. 1.

FIG. 3 is a lens cross-sectional diagram illustrating a second configuration example of the imaging lens.

FIG. 4 is an aberration diagram illustrating various aberrations in Numerical Example 2 in which specific numeral values are applied to the imaging lens illustrated in FIG. 3.

FIG. 5 is a lens cross-sectional diagram illustrating a third configuration example of the imaging lens.

FIG. 6 is an aberration diagram illustrating various aberrations in Numerical Example 3 in which specific numeral values are applied to the imaging lens illustrated in FIG. 5.

FIG. 7 is a lens cross-sectional diagram illustrating a fourth configuration example of the imaging lens.

FIG. 8 is an aberration diagram illustrating various aberrations in Numerical Example 4 in which specific numeral values are applied to the imaging lens illustrated in FIG. 7.

FIG. 9 is a lens cross-sectional diagram illustrating a fifth configuration example of the imaging lens.

FIG. 10 is an aberration diagram illustrating various aberrations in Numerical Example 5 in which specific numeral values are applied to the imaging lens illustrated in FIG. 9.

FIG. 11 is a lens cross-sectional diagram illustrating a sixth configuration example of the imaging lens.

FIG. 12 is an aberration diagram illustrating various aberrations in Numerical Example 6 in which specific numeral values are applied to the imaging lens illustrated in FIG. 11.

FIG. 13 is a lens cross-sectional diagram illustrating a seventh configuration example of the imaging lens.

FIG. 14 is an aberration diagram illustrating various aberrations in Numerical Example 7 in which specific numeral values are applied to the imaging lens illustrated in FIG. 13.

FIG. 15 is a lens cross-sectional diagram illustrating an eighth configuration example of the imaging lens.

FIG. 16 is an aberration diagram illustrating various aberrations in Numerical Example 8 in which specific numeral values are applied to the imaging lens illustrated in FIG. 15.

FIG. 17 is a lens cross-sectional diagram illustrating a ninth configuration example of the imaging lens.

FIG. 18 is an aberration diagram illustrating various aberrations in Numerical Example 9 in which specific numeral values are applied to the imaging lens illustrated in FIG. 17.

FIG. 19 is a lens cross-sectional diagram illustrating a tenth configuration example of the imaging lens.

FIG. 20 is an aberration diagram illustrating various aberrations in Numerical Example 10 in which specific numeral values are applied to the imaging lens illustrated in FIG. 19.

FIG. 21 is a lens cross-sectional diagram illustrating an eleventh configuration example of the imaging lens.

FIG. 22 is an aberration diagram illustrating various aberrations in Numerical Example 11 in which specific numeral values are applied to the imaging lens illustrated in FIG. 21.

FIG. 23 is a lens cross-sectional diagram illustrating a twelfth configuration example of the imaging lens.

FIG. 24 is an aberration diagram illustrating various aberrations in Numerical Example 12 in which specific numeral values are applied to the imaging lens illustrated in FIG. 23.

FIG. 25 is a lens cross-sectional diagram illustrating a thirteenth configuration example of the imaging lens.

FIG. 26 is an aberration diagram illustrating various aberrations in Numerical Example 13 in which specific numeral values are applied to the imaging lens illustrated in FIG. 25.

FIG. 27 is a lens cross-sectional diagram illustrating a fourteenth configuration example of the imaging lens.

FIG. 28 is an aberration diagram illustrating various aberrations in Numerical Example 14 in which specific numeral values are applied to the imaging lens illustrated in FIG. 27.

FIG. 29 is a lens cross-sectional diagram illustrating a fifteenth configuration example of the imaging lens.

FIG. 30 is an aberration diagram illustrating various aberrations in Numerical Example 15 in which specific numeral values are applied to the imaging lens illustrated in FIG. 29.

FIG. 31 is a lens cross-sectional diagram illustrating a sixteenth configuration example of the imaging lens.

FIG. 32 is an aberration diagram illustrating various aberrations in Numerical Example 16 in which specific numeral values are applied to the imaging lens illustrated in FIG. 31.

FIG. 33 is a lens cross-sectional diagram illustrating a seventeenth configuration example of the imaging lens.

FIG. 34 is an aberration diagram illustrating various aberrations in Numerical Example 17 in which specific numeral values are applied to the imaging lens illustrated in FIG. 33.

FIG. 35 is a lens cross-sectional diagram illustrating an eighteenth configuration example of the imaging lens.

FIG. 36 is an aberration diagram illustrating various aberrations in Numerical Example 18 in which specific numeral values are applied to the imaging lens illustrated in FIG. 35.

FIG. 37 is a lens cross-sectional diagram illustrating a nineteenth configuration example of the imaging lens.

FIG. 38 is an aberration diagram illustrating various aberrations in Numerical Example 19 in which specific numeral values are applied to the imaging lens illustrated in FIG. 37.

FIG. 39 is a cross-sectional diagram illustrating a generation path of a veiling glare generated by a reflection between surfaces of a first lens in an imaging lens according to an embodiment.

FIG. 40 is a diagram illustrating a shape of a veiling glare generated by a reflection between surfaces of a first lens in an imaging lens according to an embodiment.

FIG. 41 is a diagram illustrating a shape of a veiling glare generated by a reflection between surfaces of a first lens in a case where an upper limit value of conditional expression (1) is exceeded.

FIG. 42 is a diagram illustrating a shape of a veiling glare generated by a reflection between surfaces of the first lens in a case where a lower limit value of conditional expression (1) is exceeded.

FIG. 43 is a cross-sectional diagram illustrating a generation path of a veiling glare that is generated by a bundle of rays being totally reflected on a lens surface, on image plane side, of a third lens, being further surface-reflected on a lens surface, on object side, of a first lens, and, thereafter, reaching an image plane, in an imaging lens according to an embodiment.

FIG. 44 is a diagram illustrating a shape of a veiling glare that is generated by a bundle of rays being totally reflected on a lens surface, on image plane side, of a third lens, and being further surface-reflected on a lens surface, on object side, of a first lens, in a case where an upper limit value of conditional expression (2) is exceeded.

FIG. 45 is a cross-sectional view illustrating a generation path of a veiling glare that is generated by a reflection between surfaces of a sixth lens in an imaging lens according to an embodiment.

FIG. 46 is a diagram illustrating a shape of a veiling glare generated by a reflection between surfaces of a first lens in a case where an upper limit value of conditional expression (4) is exceeded.

FIG. 47 is a front view of a configuration example of an imaging apparatus.

FIG. 48 is a back view of the configuration example of the imaging apparatus.

FIG. 49 is a diagram describing a surface angle.

### MODES FOR CARRYING OUT THE INVENTION

Some embodiments of the present disclosure are described in detail below with reference to drawings. It is to be noted that the description is given in the following order.

### 0. Comparative Example

### 1. Basic Configuration of Lenses

### 2. Workings and Effects

3. Application Example to Imaging apparatus

### 4. Numerical Examples of Lenses

### 5. Other Embodiments

### 0. Comparative Example

High resolution is demanded for an imaging lens used in an imaging device with high definition; however, the resolution is limited by an F value. It has become difficult to obtain sufficient performance by the F value of about 2.0 because a bright lens with a small F value provides high resolution. Accordingly, an imaging lens with the F value of about 1.6 that is suitable to the small-sized imaging device with a large number of pixels and high definition has been increasingly demanded. As the imaging lens for such a purpose, an imaging lens including seven lenses that allows for increase in aperture ratio and improvement in performance as compared with an imaging lens including five or six lenses has been proposed in PTL 1 (Japanese Unexamined Patent Application Publication No. 2015-072404) and PTL 2 (Japanese Unexamined Patent Application Publication No. 2014-145961).

For example, in the imaging lens including seven lenses described in PTL 1, a bright lens is proposed which includes, in order from object side toward image plane side, a first lens, a positive second lens, a third lens, a fourth lens, a fifth lens, a sixth lens, and a seventh lens. Further, in the imaging lens including seven lenses described in PTL 2, a lens with a brightness of the F value of about 1.6 is proposed which includes, in order from object side toward image plane side, a positive first lens having a convex surface facing the object side near an optical axis, a positive second lens having convex surfaces facing the object side and the image plane side near the optical axis, a negative third lens having a concave surface facing the image plane side near the optical axis, a fourth lens having at least one aspherical surface, a fifth lens having a meniscus shape in which the concave surface of the fifth lens faces the object side near the optical axis, and a sixth lens having both aspherical surfaces, and a seventh lens having a concave surface facing the image plane side near the optical axis and having negative refractive power, in which both faces are in an aspherical shape.

In recent years, to address the imaging device with the increased number of pixels, development of a lens system that has high image-forming performance in the range from a center angle of view to a peripheral angle of view while achieving reduction of the total length has been demanded as the imaging lens. A bright imaging lens with a large aperture is proposed in the above-described PTL 1; however, the shape of the lens surface of the first lens on the object side is concave on the object side, or the first lens has both convex shapes, which is an unfavorable shape for the purpose of reducing the total length. The ratio of a maximum image height to the total length is no less than 1.7. Further, a bright imaging lens, with the F value of 1.6, including seven lenses is proposed in the above-described PTL 2; however, the ratio of the maximum image height to the total length is no less than 1.8. There is room for improvement in the imaging lenses described in the above-described PTL 1 and PTL 2 for the purpose of reducing the optical length while maintaining the performance with a large aperture. Further, when the imaging lens is reduced in profile, the distance between an optical surface and an imaging surface becomes short. This causes reflected light to easily enter the imaging surface from the optical surface, and the tendency to generate ghost or flare becomes remarkable. In particular, in a case where an F number of the imaging lens is made small in accordance with a demand for increase in aperture of a lens in relation to improvement in performance, an effective diameter of the lens becomes large, and a diameter of a light shielding member accordingly becomes large, and moreover, the possibility of the above-described ghost or flare being increased becomes higher.

Accordingly, it is desirable to provide an imaging lens and an imaging apparatus that make it possible to efficiently suppress ghost or flare and to favorably correct various aberrations while being small-sized and having a large aperture.

### 1. Basic Configuration of Lenses

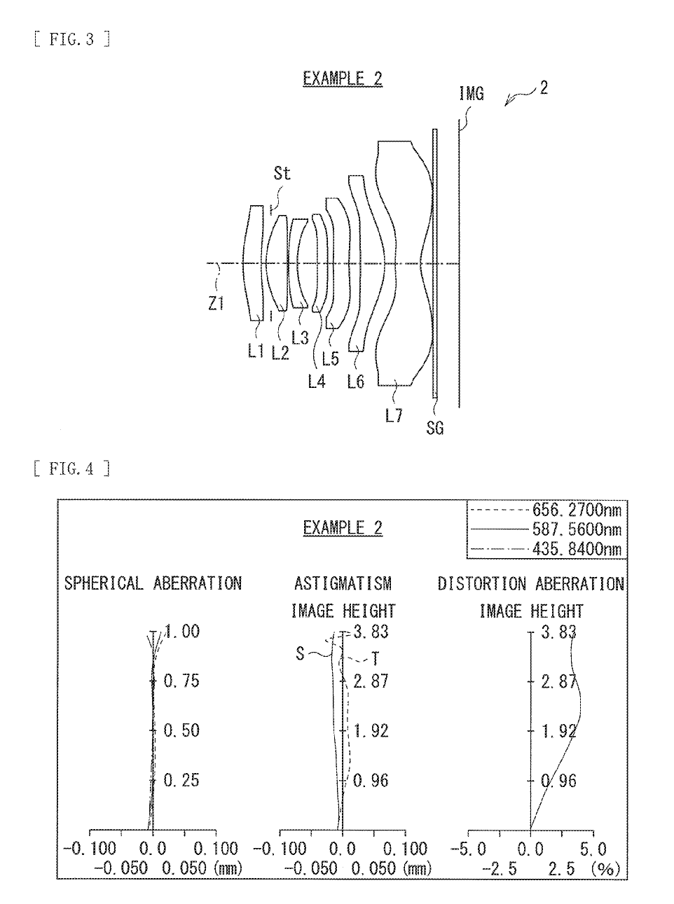

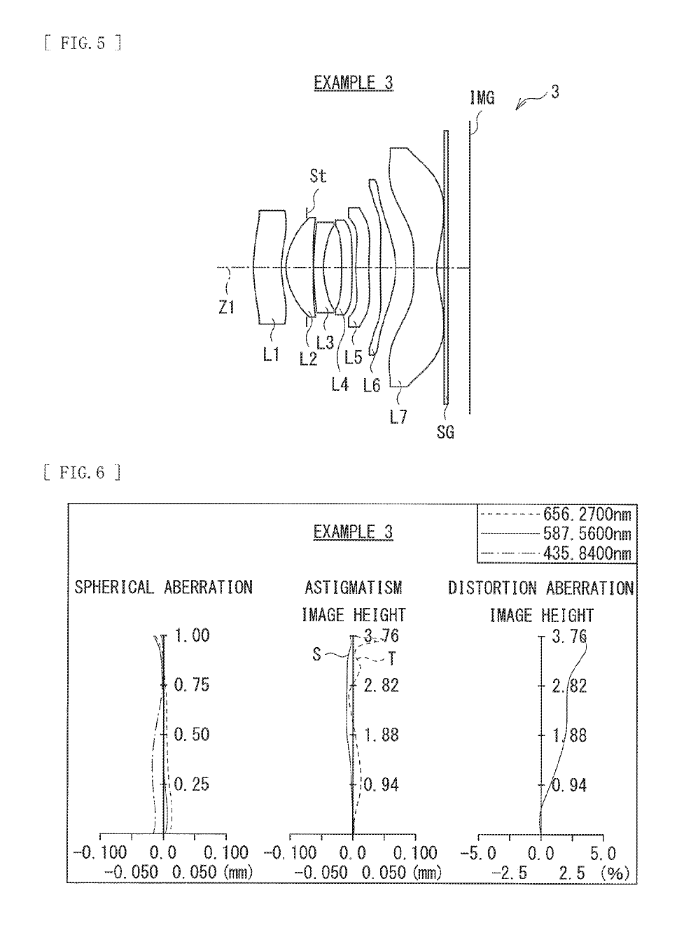

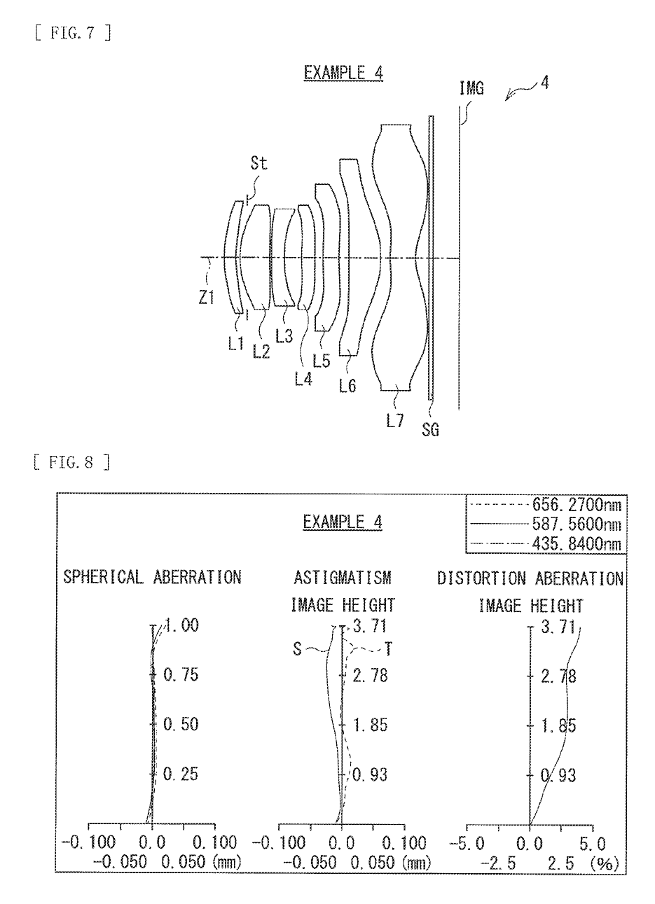

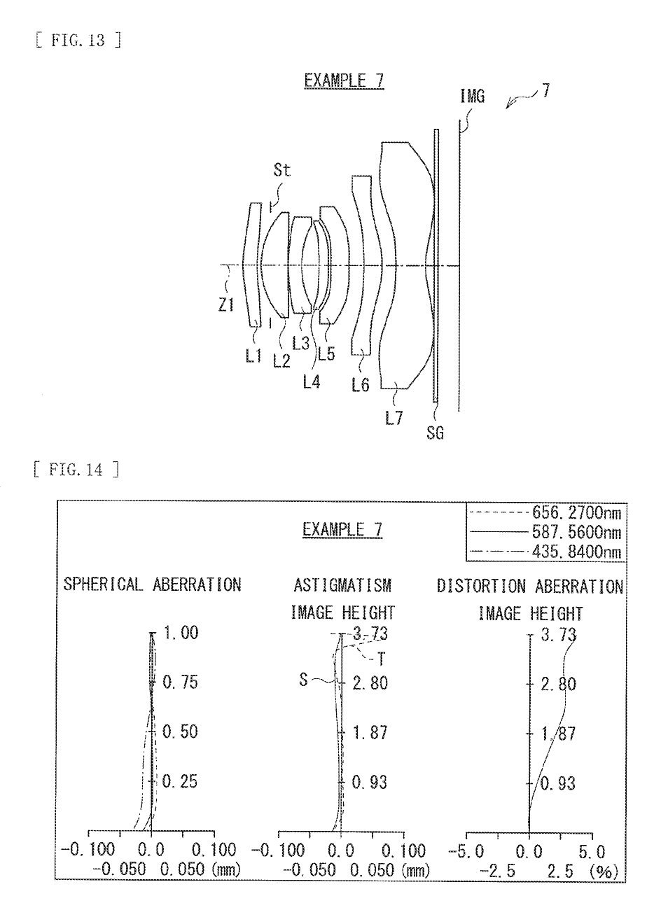

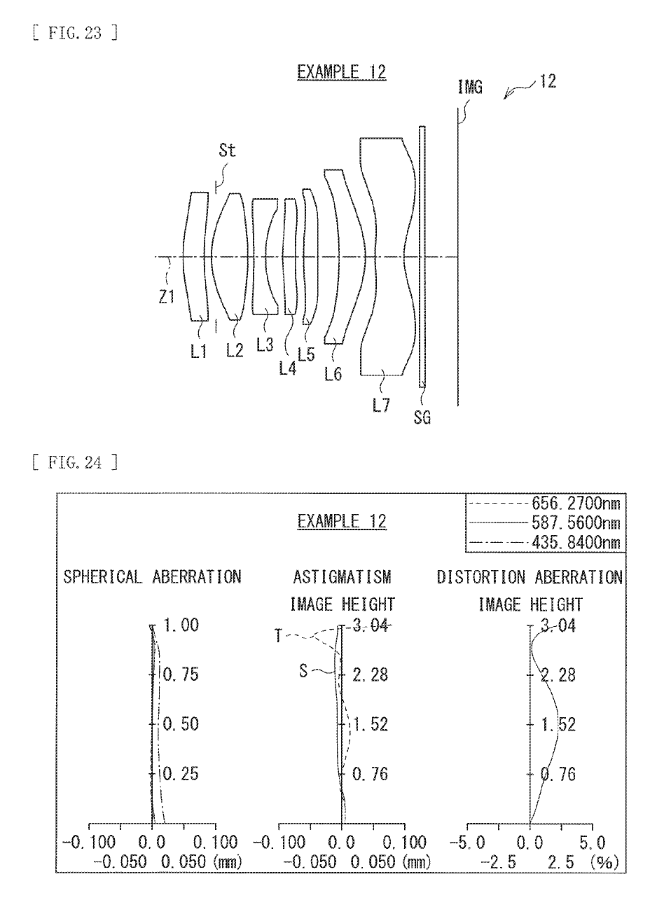

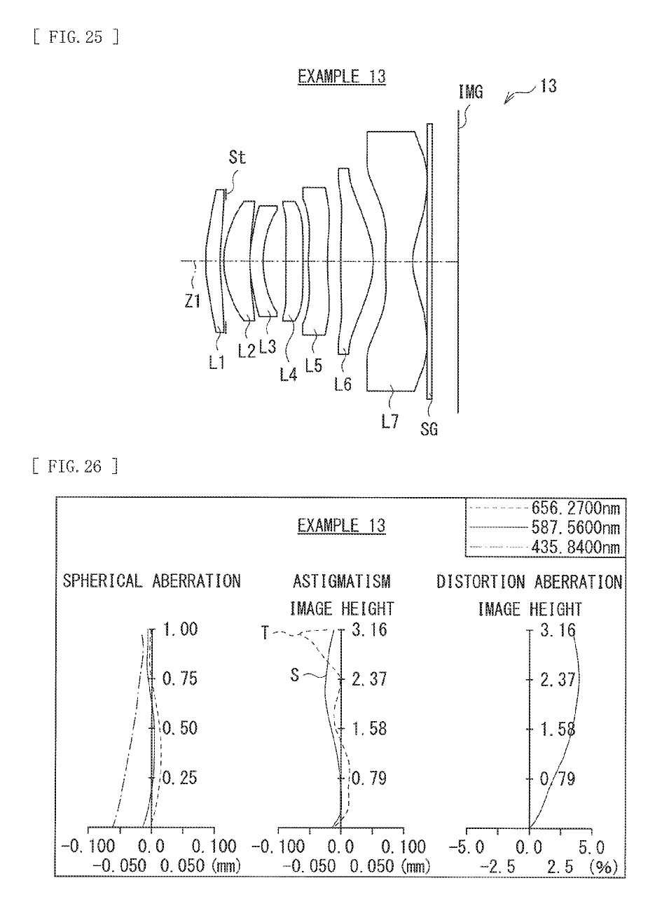

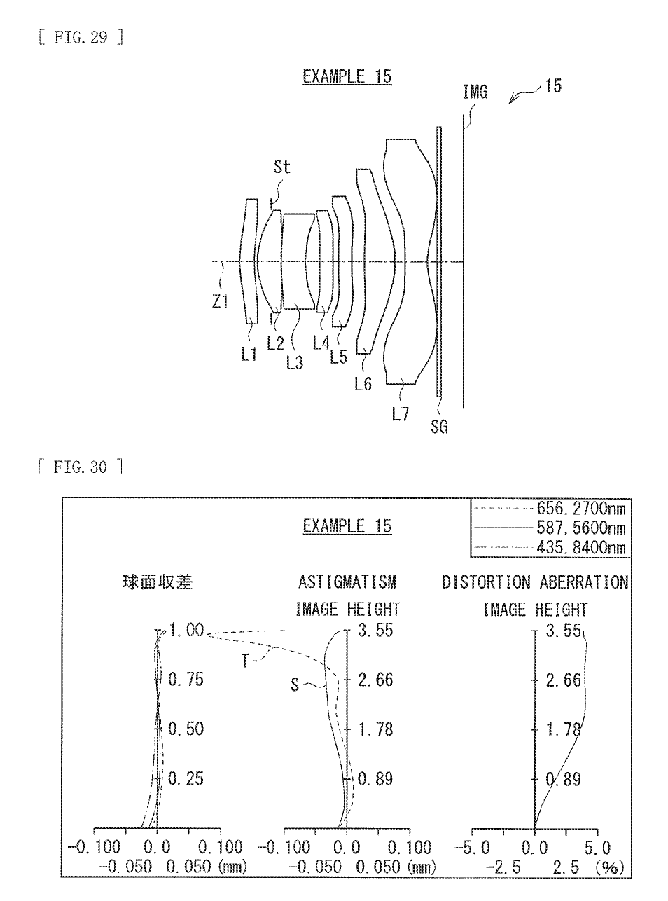

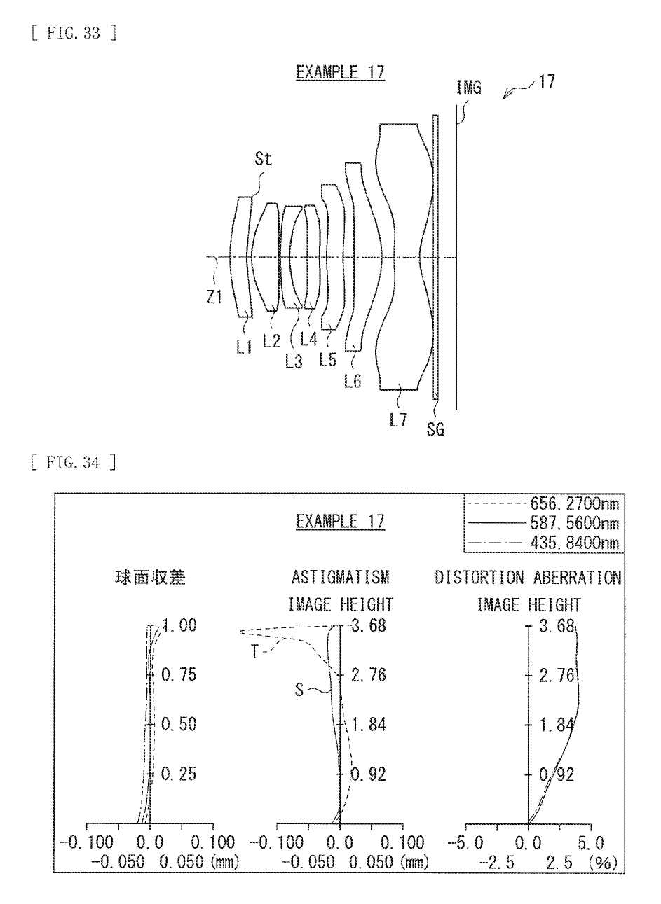

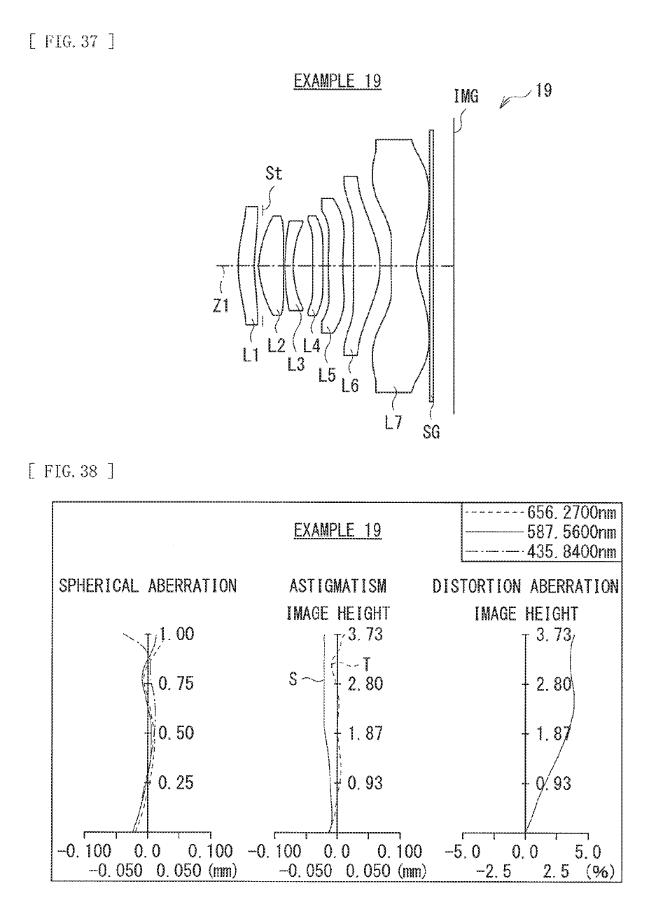

FIG. 1 illustrates a first configuration example of an imaging lens according to an embodiment of the present disclosure. FIG. 3 illustrates a second configuration example of the imaging lens. FIG. 5 illustrates a third configuration example of the imaging lens. FIG. 7 illustrates a fourth configuration example of the imaging lens. FIG. 9 illustrates a fifth configuration example of the imaging lens. FIG. 11 illustrates a sixth configuration example of the imaging lens. FIG. 13 illustrates a seventh configuration example of the imaging lens. FIG. 15 illustrates an eighth configuration example of the imaging lens. FIG. 17 illustrates a ninth configuration example of the imaging lens. FIG. 19 illustrates a tenth configuration example of the imaging lens. FIG. 21 illustrates an eleventh configuration example of the imaging lens. FIG. 23 illustrates a twelfth configuration example of the imaging lens. FIG. 25 illustrates a thirteenth configuration example of the imaging lens. FIG. 27 illustrates a fourteenth configuration example of the imaging lens. FIG. 29 illustrates a fifteenth configuration example of the imaging lens. FIG. 31 illustrates a sixteenth configuration example of the imaging lens. FIG. 33 illustrates a seventeenth configuration example of the imaging lens. FIG. 35 illustrates an eighteenth configuration example of the imaging lens. FIG. 37 illustrates a nineteenth configuration example of the imaging lens. Numerical Examples in which specific numeral values are applied to the configuration examples are described later.

In FIG. 1, etc., a reference symbol IMG, refers to an image plane, and a reference symbol Zl refers to an optical axis. A reference signal St refers to an aperture stop. An imaging device 101 such as a CCD and a CMOS may be disposed near the image plane IMG. A seal glass SG for protection of an imaging device and optical members such as various kinds of optical filters may be disposed between the imaging lens and the image plane IMG.

In the following, a configuration of the imaging lens according to the present embodiment is described, as appropriate, in association with configuration examples illustrated in FIG. 1, etc. However, a technology according to the present disclosure is not limited to the illustrated configuration examples.

The imaging lens according to the present embodiment substantially includes seven lenses in which a first lens L1, a second lens L2, a third lens L3, a fourth lens L4, a fifth lens L5, a sixth lens L6, and a seventh lens L7 are disposed along the optical axis Z1 in order from the object side toward the image plane side.

The first lens L1 desirably has a meniscus shape. The meniscus shape has a shape that is positioned near an optical axis and includes a convex surface that faces the object side. The first lens L1 desirably has, near the optical axis, positive or negative refractive power.

The second lens L2 desirably includes a convex surface that faces, near the optical axis, the object side. The second lens L2 desirably has, near the optical axis, positive refractive power.

The third lens L3 desirably has, near the optical axis, negative refractive power.

The fourth lens L4 desirably has, near the optical axis, positive or negative refractive power.

The fifth lens L5 desirably has, near the optical axis, positive or negative refractive power.

The sixth lens L6 desirably has, near the optical axis, positive refractive power.

The seventh lens L7 desirably has, near the optical axis, negative power. The seventh lens L7 includes a lens surface. The lens surface is positioned on image plane side and desirably has an aspherical shape that has an inflection point that changes a concave-convex shape in the middle thereof, as it goes from a center part to a peripheral part, and desirably has at least one inflection point at a part other than the intersection with the optical axis Z1. More specifically, the lens surface, on the image side, of the seventh lens L7 desirably has an aspherical shape including a concave shape near the optical axis and a convex shape at a peripheral part.

In addition, an imaging lens according to the present embodiment desirably satisfies a later-described predetermined conditional expression, etc.

### 2. Workings and Effects

Next, workings and effects of an imaging lens according to the present embodiment are described. A more desirable configuration in an imaging lens according to the present embodiment is described together.

It is to be noted that the effects described in the present specification are illustrative and non-limiting. Effects other than those described in the present specification may be provided.

An imaging lens according to the present embodiment has a configuration including seven lenses as a whole, and the optimization of the configuration of each lens is achieved. This makes it possible to favorably correct various aberrations while the lens is small-sized and has a large aperture, and to reduce image deterioration such as ghost or flare caused due to unnecessary light.

Further, in the imaging lens according to the present embodiment, forming the lens surface closest to the image plane side (the lens surface, on the image plane side, of the seventh lens L7) in a shape of an aspherical surface having a concave shape near the optical axis and a convex shape at a peripheral part suppresses an incident angle of the light that has been outputted from the seventh lens L7, to the image plane IMG.

An imaging lens according to the present embodiment desirably satisfies the following conditional expression (1),

−0.5<f/f1<0.23 (1)

where f is a focal length of a lens system as a whole, and
f1 is a focal length of the first lens L1.

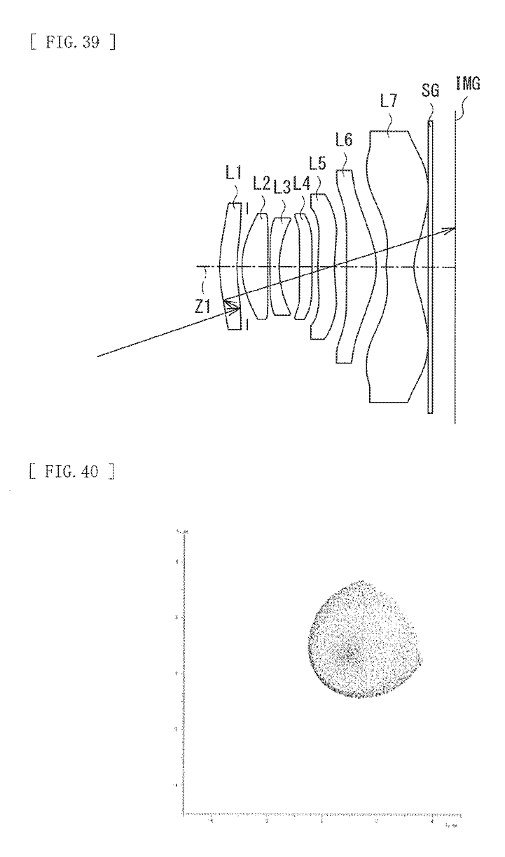

The above-described conditional expression (1) defines a ratio of the focal length of the first lens L1 to the focal length of a lens system as a whole. FIG. 39 illustrates an example of a generation path of a veiling glare that is generated by a reflection between surfaces of the first lens L1. By satisfying the conditional expression (1), it is possible to reduce a veiling glare even with a large aperture, and to ensure favorable resolution performance. FIG. 40 illustrates a shape of a veiling glare that is generated by the reflection between surfaces of the first lens L1 in the imaging lens 1 according to the first configuration example of FIG. 1. The relative intensity of the veiling glare at this occasion is set to 1.

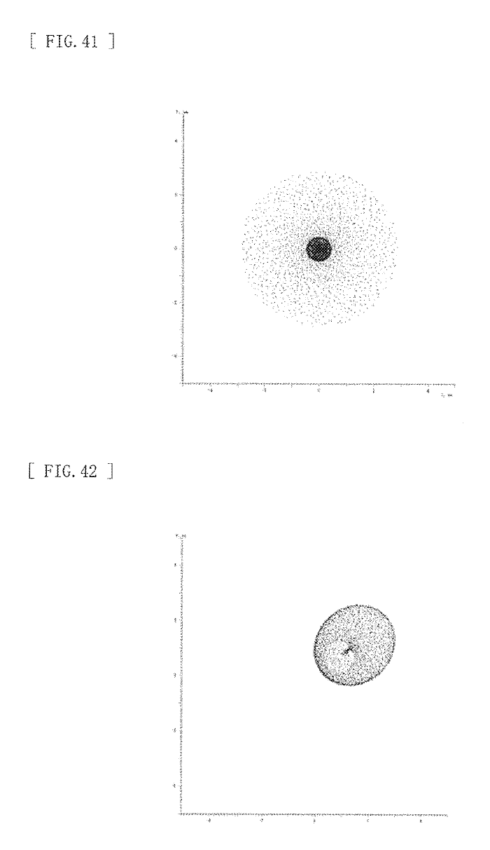

If f/f1 exceeds the upper limit value of the conditional expression (1), the positive refractive power of the first lens L1 is too intense. For example, as illustrated in FIG. 39, a portion of a bundle of rays that has entered the lens surface, on the object side, of the first lens L1 is surface-reflected on the lens surface, on the image plane side, of the first lens L1, and further surface-reflected on the lens surface on the object side, following which an image is formed near the image plane. As a result, for example, as illustrated in FIG. 41, an intense veiling glare that is formed by light being condensed on an arc and that has the relative intensity of about 3.9 is generated on the image plane. Further, if f/f1 falls below the lower limit value of the conditional expression (1), a portion of a bundle of rays near a main beam of light out of the bundle of rays that has entered the first lens L1 is surface-reflected on the lens surface, on the image plane side, of the first lens L1, and further surface-reflected on the lens surface on the object side, following which an image is formed near the image plane. As a result, for example, an intense veiling glare that is formed by light being condensed as illustrated in FIG. 42 and that has the relative intensity of about 24.4 is generated on the image plane.

It is to be noted that, in order to achieve, more favorably, an effect of the above-described conditional expression (1), a numerical range of the conditional expression (1) is desirably set as in the following conditional expression (1)′.

−0.20<f/f1<0.20 (1)′

In order to further achieve, more favorably, the effect of the above-described conditional expression (1), the numerical range of the conditional expression (1) is desirably set as in the following conditional expression (1)″.

−0.074<f/f1<0.092 (1)″

In an imaging lens according to the present embodiment, by satisfying the conditional expression (1)″, it is possible to reduce the veiling glare even with a large aperture and to ensure favorable resolution performance regardless of whether the lens surface, on the object side, of the first lens L1, the lens surface, on the image plane side, of the first lens L1, and the lens surface, on the object side, of the second lens L2 each are in a concave shape or in a convex shape near the optical axis.

Further, an imaging lens according to the present embodiment desirably satisfies the following further conditional expressions (2) and (3),

0<θmax(L1R1)<25 (2)

0.3<R(L3R2)/f<5 (3)

where θmax (L1R1) is a maximum value of a surface angle θ (L1R1) of the lens surface, on the object side, of the first lens L1 within an effective diameter, and

R(L3R2) is radius of curvature of the lens surface, on the image plane side, of the third lens L3.

FIG. 49 illustrates an example of the surface angle θ (L1R1) of the lens surface, on the object side, of the first lens L1. As illustrated in FIG. 49, for the surface angle θ (L1R1), the inclination of the lens surface toward the image plane side is set as positive, and the unit is “degree”. The same applies to surface angles of other lens surfaces in later-described other conditional expressions.

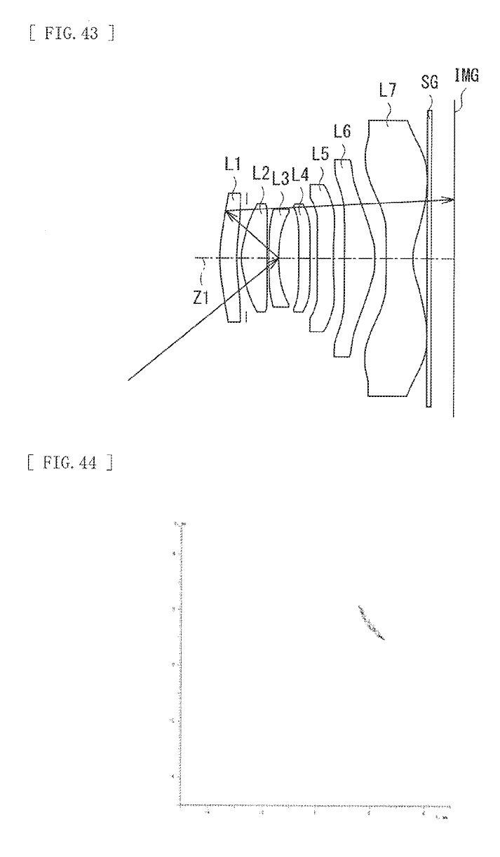

The above-described conditional expression (2) defines the maximum inclination angle of the lens surface, on the object side, of the first lens L1. Further, the conditional expression (3) defines the ratio of curvature of the lens surface, on the image plane side, of the third lens L3 to the focal length of the lens system as a whole. FIG. 43 illustrates one example of a generation path of a veiling glare that is generated by a bundle of rays being totally reflected on the lens surface, on the image plane side, of the third lens L3, further surface-reflected on the lens surface, on the object side, of the first lens L1, and, thereafter reaching the image plane IMG. By satisfying the conditional expressions (2) and (3), it is possible both to shorten an optical total length and to reduce or prevent the vailing glare.

If θmax (L1R1) falls below the lower limit value of the conditional expression (2), the lens surface, on the object side, of the first lens L1 becomes concave on the object side, and the optical total length substantially becomes longer. This is unfavorable in size reduction. Further, if θmax (L1R1) exceeds the upper limit value of the conditional expression (2), the refractive power of the lens surface, on the object side, of the first lens L1 becomes intense. Thus, a portion of bundle of rays that has entered the lens surface, on the object side, of the first lens L1 is totally reflected on the lens surface, on the image plane side, of the third lens L3, further surface-reflected on the lens surface, on the object side, of the first lens L1, and, thereafter, reaches the image plane IMG. As a result, a veiling glare formed by light being condensed is caused on the image plane, as illustrated in FIG. 44, for example. At this occasion, if R(L3R2)/f falls below the lower limit value of the conditional expression (3), a veiling glare having a broadened shape in which light is diffused by the lens surface, on the image plane side, of the third lens L3 is caused, and if R(L3R2)/f exceeds the upper limit value of the conditional expression (3), a diffusion effect is not obtainable by the reflection of the lens surface, on the image plane side, of the third lens L3, which causes more intense veiling glare.

It is to be noted that, in order to further achieve, more favorably, the effect of the above-described conditional expression (2), the numerical range of the conditional expression (2) is desirably set as in the following conditional expression (2)′.

5<θmax(L1R1)<18 (2)′

Further, an imaging lens according to the present embodiment desirably satisfies the following further conditional expressions (4) and (5),

−15<θmin(L6R1)<θmax(L6R1)<8 (4)

−31<θmin(L6R2)<θmax(L6R2)<−5 (5)

where θmax (L6R1) is a maximum value of a surface angle θ (L6R1) of a lens surface, on the object side, of the sixth lens L6 within a diameter of 30% of an effective diameter (where inclination of the lens surface toward the image plane side is defined as positive, and where a unit is “degree”),

θmin (L6R1) is a minimum value of the surface angle θ (L6R1) of the lens surface, on the object side, of the sixth lens L6 within the diameter of 30% of the effective diameter (where inclination of the lens surface toward the image plane side is defined as positive, and where a unit is “degree”),

θmax (L6R2) is a maximum value of a surface angle θ (L6R2) of a lens surface, on the image plane side, of the sixth lens L6 within a diameter of 70% of an effective diameter (where inclination of the lens surface toward the image plane side is defined as positive, and where a unit is “degree”), and

θmin (L6R2) is a minimum value of the surface angle θ (L6R2) of the lens surface, on the image plane side, of the sixth lens L6 within the diameter of 70% of the effective diameter (where inclination of the lens surface toward the image plane side is defined as positive, and where a unit is “degree”).

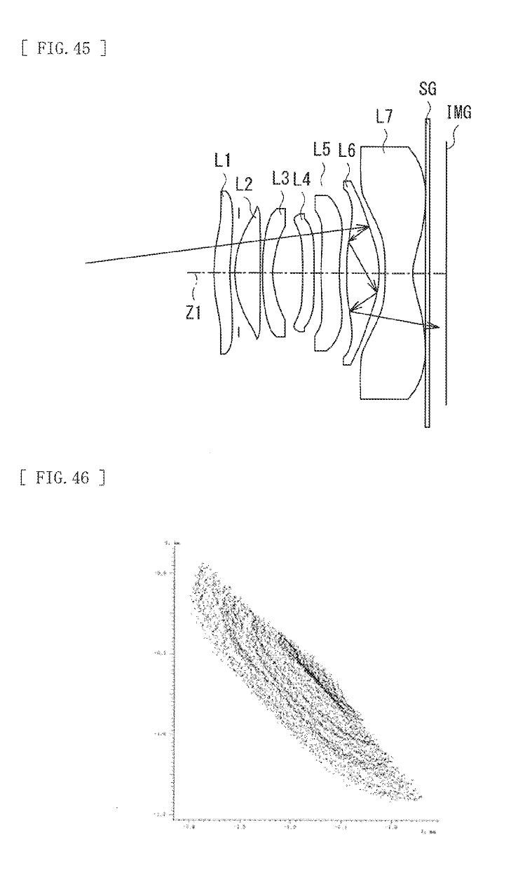

The above-described conditional expression (4) defines a range of the maximum value of a surface angle θ (L6R1) of the lens surface, on the object side, of the sixth lens L6 within a diameter of 30% of an effective diameter. FIG. 45 illustrates an example of a generation path of a veiling glare that is generated by a reflection between surfaces of the sixth lens L6. By satisfying the conditional expression (4), it is possible to reduce or prevent the veiling glare, and to ensure favorable performance. If θmax (L6R1) falls below the lower limit value of the conditional expression (4), and the lens surface, on the object side, of the sixth lens L6 has a substantially concave shape within a diameter of 30% of an effective diameter, power of concaveness of the lens surface, on the object side, of the sixth lens L6 is too intense, which causes lack in correction power of coma aberration and leads to deterioration of image quality. Further, if θmax (L6R1) exceeds the upper limit value of the conditional expression (4), and the lens surface, on the object side, of the sixth lens L6 has a substantially convex shape within a diameter of 30% of an effective diameter, a portion of an off-axial bundle of rays that has been surface-reflected on the lens surface, on the image plane side, of the sixth lens L6 is totally reflected on the lens surface, on the object side, of the sixth lens L6, totally reflected repeatedly within the sixth lens L6, thereafter, outputted from the lens surface, on the image plane side, of the sixth lens L6, and reaches the image plane IMG, as illustrated in FIG. 45, for example. As a result, an intense veiling glare formed by light being condensed is caused on the image plane, as illustrated in FIG. 46, for example.

The above-described conditional expression (5) defines a range of the maximum value of a surface angle θ (L6R2) of a lens surface, on the image plane side, of the sixth lens L6 within a diameter of 70% of an effective diameter. By satisfying the conditional expression (5), it is possible to ensure favorable performance. If θmax (L6R2) exceeds the upper limit value of the conditional expression (5), power of convexness of the lens surface, on the image plane side, of the sixth lens L6 is insufficient, which causes lack in correction power of off-axial coma aberration and leads to deterioration of image quality. Further, if θmax (L6R2) falls below the lower limit value of the conditional expression (5), a portion of an off-axial bundle of rays that has been surface-reflected on the lens surface, on the image plane side, of the sixth lens L6 is not outputted from the lens surface, on the object side, of the sixth lens L6 and totally reflected, totally reflected repeatedly within the sixth lens L6, thereafter, outputted from the lens surface, on the image plane side, of the sixth lens L6, and reaches the image plane IMG, as illustrated in FIG. 45, for example. As a result, an intense veiling glare formed by light being condensed is caused on the image plane, as illustrated in FIG. 46, for example.

It is to be noted that, in order to achieve, more favorably, the effect of the above-described conditional expression (4), the numerical range of the conditional expression (4) is desirably set as in the following conditional expression (4)′.

−10<θmin(L6R1)<θmax(L6R1)<8 (4)′

In order to further achieve, more favorably, the effect of the above-described conditional expression (4), the numerical range of the conditional expression (4) is desirably set as in the following conditional expression (4)″.

−6<θmax(L6R1)<7 (4)″

In addition, the numerical range of the conditional expression (5) is desirably set as in the following conditional expression (5)′.

−22<θmin(L6R2)<θmax(L6R2)<−8 (5)′

In addition, an imaging lens according to the present embodiment desirably satisfies the following further conditional expression (6),

5<θmax(L3R2)<40 (6)

where θmax (L3R2) is a maximum value of a surface angle θ (L3R2) of the lens surface, on the image plane side, of the third lens L3 within an effective diameter (where inclination of the lens surface toward the image plane side is defined as positive, and where a unit is “degree”).

The above-described conditional expression (6) defines a range of the maximum value of a surface angle θ (L3R2) of the lens surface, on the image plane side, of the third lens L3 within an effective diameter. By satisfying the conditional expression (6), it is possible to ensure favorable performance. If θmax (L3R2) falls below the lower limit value of the conditional expression (6), negative refractive power of the third lens L3 becomes weak, and it becomes difficult to favorably correct a spherical aberration or a coma aberration caused at the first lens L1 or the second lens L2. Further, if θmax (L3R2) exceeds the upper limit value of the conditional expression (6), the third lens L3 has excessive negative power, and it becomes difficult to correct the spherical aberration or the coma aberration. Furthermore, the surface angle is too large, which increases the degree of difficulty in manufacturing.

It is to be noted that, in order to achieve, more favorably, the effect of the above-described conditional expression (6), the numerical range of the conditional expression (6) is desirably set as in the following conditional expression (6)′.

15<θ(L3R2)<38 (6)′

Further, an imaging lens according to the present embodiment desirably satisfies the following further conditional expression (7),

0.3<f12/f<2.0 (7)

where f is a focal length of a lens system as a whole, and
f12 is a composite focal length of the first lens L1 and the second lens L2.

The conditional expression (7) defines the ratio of the composite focal length of the first lens L1 and the second lens L2 to the focal length of a lens system as a whole. By satisfying the conditional expression (7), it is possible to ensure favorable performance. If f12/f falls below the lower limit value of the conditional expression (7), composite power of the first lens L and the second lens L2 becomes too intense, and it becomes difficult to correct a spherical aberration, a coma aberration, or an astigmatism. Further, f12/f exceeds the upper limit value of the conditional expression (7), the composite power of the first lens L1 and the second lens L2 becomes too weak, and it is difficult to shorten the optical total length.

It is to be noted that, in order to achieve, more favorably an effect of the above-described conditional expression (7), a numerical range of the conditional expression (7) is desirably set as in the following conditional expression (7)′.

0.5<f12/f<1.5 (7)′

In addition, an imaging lens according to the present embodiment desirably satisfies the following further conditional expression (8),

−5<f3/f<−0.5 (8)

where f is a focal length of a lens system as a whole, and
f3 is a focal length of the third lens L3.

The above-described conditional expression (8) defines the ratio of the focal length of the third lens L3 to the focal length of a lens system as a whole. By satisfying the conditional expression (8), it is possible to ensure favorable performance. If f3/f falls below the lower limit value of the conditional expression (8), negative refractive power of the third lens L3 becomes weak, and it becomes difficult to favorably correct an on-axial chromatic aberration generated at the second lens L2. Further, if f3/f exceeds the upper limit value of the conditional expression (8), negative refractive power of the third lens L3 becomes too intense, it becomes difficult to shorten the optical total length.

It is to be noted that, in order to achieve, more favorably, an effect of the above-described conditional expression (8), a numerical range of the conditional expression (8) is desirably set as in the following conditional expression (8)′.

−3.5<f3/f<−1.0 (8)′

In addition, an imaging lens according to the present embodiment desirably satisfies the following further conditional expression (9),

0.023<T(L3)/f<0.15 (9)

where f is a focal length of a lens system as a whole, and
T (L3) is a center thickness of the third lens L3.

The above-described conditional expression (9) defines the ratio of a center thickness of the third lens L3 to the focal length of a lens system as a whole. If the third lens L3 has a thinner center thickness, it becomes difficult to mold a lens due to a concave meniscus shape while it becomes easy to correct a coma aberration. By allowing T(L3)/f to fall within the range of the conditional expression (9), it is possible to favorably maintain a coma aberration, and the formation becomes easy.

It is to be noted that, in order to achieve, more favorably, an effect of the above-described conditional expression (9), a numerical range of the conditional expression (9) is desirably set as in the following conditional expression (9)′.

0.045<T(L3)/f<0.1 (9)′

In addition, an imaging lens according to the present embodiment desirably satisfies the following further conditional expression (10),

νd(L1)>50 (10)

where νd (L1) is Abbe number of the first lens L1 to d line.

In addition, an imaging lens according to the present embodiment desirably satisfies the following further conditional expressions (11) and (12).

νd(L3)<35 (11)

νd(L5)<35 (12)

where νd (L3) is Abbe number of the third lens L3 to d line, and
νd (L5) is Abbe number of the fifth lens L5 to d line.

The above-described conditional expression (10) defines Abbe number of a glass material of the first lens L1 to d line. Further, the above-described conditional expressions (11) and (12) respectively define Abbe number of glass materials of the third lens L3 and the fifth lens L5 to d line. By satisfying the conditional expressions (10), and (11) and (12), it is possible to ensure favorable performance with a low profile. Abbe numbers of the third lens L3 and the fifth lens L5 respectively fall below the upper limit value of the conditional expressions (11) and (12), which thereby makes it possible to improve a correction effect of a chromatic aberration by the third lens L3 and the fifth lens L5.

In addition, an imaging lens according to the present embodiment desirably satisfies the following further conditional expressions (13), (14), and (15),

νd(L4)>50 (13)

νd(L6)>50 (14)

νd(L7)>50 (15)

where νd (L4) is Abbe number of the fourth lens L4 to d line,
νd (L6) is Abbe number of the sixth lens L6 to d line, and
νd (L7) is Abbe number of the seventh lens L7 to d line.

The conditional expressions (13), (14), and (15) respectively define Abbe numbers of glass materials of the fourth lens L4, the sixth lens L6, and the seventh lens L7 to d line. By satisfying the conditional expressions (13), (14), and (15), it is possible to ensure favorable performance with a low profile. Abbe numbers of the sixth lens L6 and the seventh lens L7 exceed the lower limit value of the conditional expressions (13), (14), and (15), which thereby makes it possible to improve a correction effect of a chromatic aberration.

### 3. Application Example to Imaging Apparatus

Next, an application example of an imaging lens according to the present embodiment to an imaging apparatus is described.

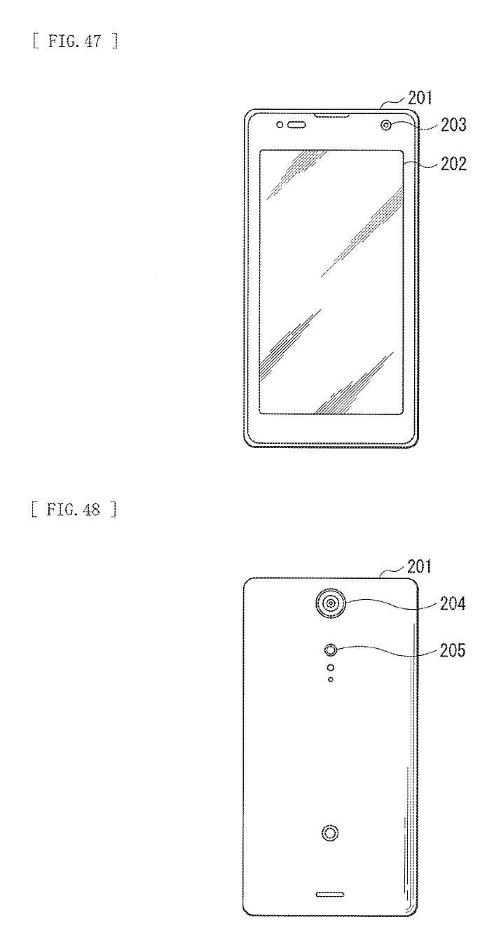

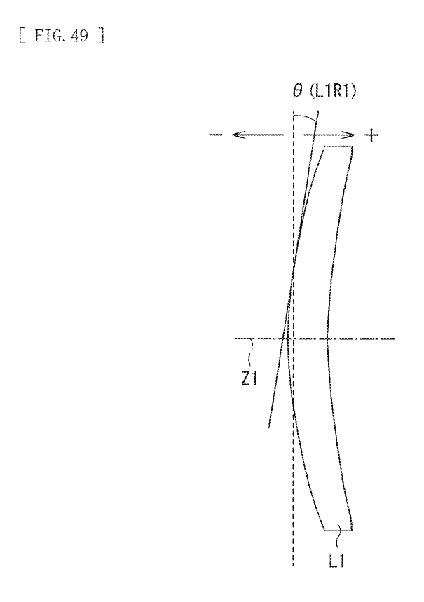

FIGS. 47 and 48 each illustrate a configuration example of an imaging apparatus to which an imaging lens according to the present embodiment is applied. The configuration example is an example of a mobile terminal apparatus (such as a mobile information terminal and a mobile phone terminal) including the imaging apparatus. The mobile terminal apparatus includes a substantially rectangular housing 201. For example, a display section 202 and a front camera section 203 are provided on front surface side of the housing 201 (FIG. 47). A main camera section 204 and a camera flash 205 are provided on rear surface side of the housing 201 (FIG. 48).

For example, the display section 202 is a touch panel that detects a contact state to a surface to allow for various kinds of operation. Therefore, the display section 202 has a display function of displaying various kinds of information and an input function of allowing for various kinds of input operation by a user. The display section 202 displays, for example, an operation state and various kinds of data such as an image photographed by the front camera section 203 or the main camera section 204.

For example, the imaging lens according to the present embodiment is applicable as a camera module lens of the imaging apparatus (the front camera section 203 or the main camera section 204) in the mobile terminal apparatus as illustrated in FIG. 47 and FIG. 48. When the imaging lens according to the present embodiment is used as such a camera module lens, an imaging device 101 such as a CCD and a CMOS is disposed near the image plane IMG of the imaging lens as illustrated in FIG. 1. The imaging device 101 outputs an imaging signal (an image signal) based on an optical image formed by the imaging lens. In this case, as illustrated in FIG. 1, the seal glass SG for protection of the imaging device and the optical members such as various kinds of optical filters may be disposed between the seventh lens L7 and the image plane IMG. Further, the seal glass SG for protection of the imaging device and the optical members may be disposed at any position as long as they are disposed between the seventh lens L7 and the image plane IMG.

It is noted that the imaging lens according to the present embodiment is not limited to the above-described mobile terminal apparatus but is applicable as an imaging lens of other electronic apparatuses such as a digital still camera and a digital video camera. In addition, the imaging lens according to the present embodiment is applicable to general small imaging apparatuses using a solid-state imaging device such as a CCD and a CMOS. Such small imaging apparatuses include, for example, an optical sensor, a mobile module camera, and a WEB camera. Further, such small imaging apparatuses also include a monitoring camera, for example.

### EXAMPLES

### 4. Numerical Examples of Lenses

Next, specific numerical examples of an imaging lens according to the present embodiment are described. Numerical Examples in which specific values are applied to the imaging lenses 1 to 19 in the respective configuration examples respectively illustrated in FIG. 1, FIG. 3, FIG. 5, FIG. 7, FIG. 9, FIG. 11, FIG. 13, FIG. 15, FIG. 17, FIG. 19, FIG. 21, FIG. 23, FIG. 25, FIG. 27, FIG. 29, FIG. 31, FIG. 33, FIG. 35, and FIG. 37 are described here.

It is to be noted that meanings, etc. of respective symbols indicated in the following tables and descriptions are as described below. “Si” indicates number of the i-th surface that is counted from the side closest to the object side. “Ri” indicates a value (mm) of paraxial radius of curvature of the i-th surface. “Di” indicates a value (mm) of a spacing on the optical axis between the i-th surface and the (i+1)th surface. “Ndi” indicates a value of a refractive index in d line (wavelength of 587.6 nm) of a material of an optical element having the i-th surface. “νdi” indicates a value of Abbe number in the d line of the material of the optical element having the i-th surface. A portion at which a value of “Ri” is “∞” is a flat surface, or a virtual surface. “Li” indicates a property of a surface. A surface denoted as “OBJ” in “Li” indicates an object surface. In “Li”, for example, “L1R1” indicates a lens surface, on the object side, of the first lens L1, and “L1R2” indicates a lens surface, on the image plane side, of the first lens L1. Similarly, in “Li”, “L2R1” indicates a lens surface, on the object side, of the second lens L2, and “L2R2” indicates a lens surface, on the image plane side, of the second lens L2. The same applies to other lens surfaces as well.

In “Si”, a surface denoted as “ASP” indicates an aspherical surface. The aspherical shape is defined by the following expression. It is to be noted that, in the respective tables showing aspherical surface coefficients described later, “E-i” represents an exponential expression having 10 as a base, i.e., “10⁻ⁱ”. For example, “0.12345E-05” represents “0.12345×10⁻⁵”.

### (Expression of Aspherical Surface)

Z=C·h²/{1+(1−(1+K)·C²·h²)^{1/2}}+ΣAn·hⁿ

(n is an integer of no less than three)
where Z is a depth of the aspherical surface,
C is a paraxial curvature that is equal to 1/R,
h is a distance from the optical axis to the lens surface,
K is an eccentricity (second-order aspherical surface coefficient), and
An is an n-th order aspherical surface coefficient.

### Configuration Common to Respective Numerical Examples

Any of the imaging lenses 1 to 19 to which respective numerical examples below are applied has a configuration that satisfies the above-described basic configuration of the lens. In other words, any of the imaging lenses 1 to 19 substantially includes seven lenses in which the first lens L1, the second lens L2, the third lens L3, the fourth lens L4, the fifth lens L5, the sixth lens L6, and the seventh lens L7 are disposed in order from the object side toward the image plane side.

The first lens L1 has a meniscus shape. The meniscus shape has a shape that is positioned near an optical axis and includes a convex surface that faces the object side. The second lens L2 includes a convex surface that faces, near the optical axis, the object side. The seventh lens L7 includes a lens surface. The lens surface is positioned on image plane side and has an aspherical shape that has an inflection point that changes a concave-convex shape in the middle thereof, as it goes from a center part to a peripheral part.

The aperture stop St is disposed between the lens surface, on the image plane side, of the first lens L1 and the lens surface, on the image plane side, of the second lens L2. The seal glass SG is disposed between the seventh lens L7 and the image plane IMG.

### Numerical Example 1

Table 1 shows basic lens data of Numerical Example 1 in which specific numerical values are applied to the imaging lens 1 illustrated in FIG. 1.

In the imaging lens 1 according to Numerical Example 1, both surfaces of each of the first lens L to the seventh lens L7 have aspherical shapes. Table 2 and Table 3 show values of coefficients representing these aspherical shapes.

In the imaging lens 1 according to Numerical Example 1, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 1
Example 1

| Si | Li | Ri | Di | Ndi | νdi |
|---|---|---|---|---|---|
| 1 | OBJ | ∞ | ∞ | | |
| 2 | L1R1 ASP | 3.3036 | 0.4325 | 1.5432 | 56.02 |
| 3 | L1R2 ASP | 3.5811 | 0.1190 | | |
| 4 | L2R1 ASP | 1.9984 | 0.6431 | 1.5432 | 56.02 |
| 5 | L2R2 ASP | −61.1248 | 0.0309 | | |
| 6 | L3R1 ASP | 7.8135 | 0.2400 | 1.6607 | 20.36 |
| 7 | L3R2 ASP | 2.8183 | 0.5154 | | |
| 8 | L4R1 ASP | 56.0194 | 0.2870 | 1.5432 | 56.02 |
| 9 | L4R2 ASP | 56.2062 | 0.1629 | | |
| 10 | L5R1 ASP | 7.7091 | 0.4168 | 1.6349 | 23.89 |
| 11 | L5R2 ASP | 6.8045 | 0.2864 | | |
| 12 | L6R1 ASP | −141.1090 | 0.7392 | 1.5432 | 56.02 |
| 13 | L6R2 ASP | −2.3618 | 0.2730 | | |
| 14 | L7R1 ASP | 4.3231 | 0.6790 | 1.5341 | 55.63 |
| 15 | L7R2 ASP | 1.3329 | 0.3448 | | |
| 16 | SGR1 | ∞ | 0.1100 | 1.5140 | 51.40 |
| 17 | SGR2 | ∞ | 0.5722 | | |

TABLE 2
Example 1

| | Si | | | |
|---|---|---|---|---|
| | 2 | 3 | 4 | 5 |
| C | 0.30270 | 0.27924 | 0.50040 | −0.01636 |
| K | 2.00665 | −10.00000 | −5.97674 | 10.00000 |
| A3 | 0.00000E+00 | 0.00000E+00 | 0.00000E+00 | 0.00000E+00 |
| A4 | −3.66801E−02 | −6.59255E−02 | 3.78002E−02 | 3.52471E−02 |
| A5 | 0.00000E+00 | 0.00000E+00 | 0.00000E+00 | 0.00000E+00 |
| A6 | −2.74311E−03 | 2.52241E−02 | −1.37598E−02 | −6.48846E−02 |
| A7 | 0.00000E+00 | 0.00000E+00 | 0.00000E+00 | 0.00000E+00 |
| A8 | −1.56922E−03 | −5.53970E−03 | 1.02208E−02 | 4.20239E−02 |
| A9 | 0.00000E+00 | 0.00000E+00 | 0.00000E+00 | 0.00000E+00 |
| A10 | 1.36839E−03 | 1.13490E−03 | −3.25556E−03 | −1.38868E−02 |
| A11 | 0.00000E+00 | 0.00000E+00 | 0.00000E+00 | 0.00000E+00 |
| A12 | −2.87598E−04 | −1.45440E−04 | −5.22448E−04 | 1.41782E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.12798 | 0.35482 | 0.01785 | 0.01779 |
| K | −1.70646 | −0.44326 | 10.00000 | 8.41151 |
| A3 | 0.00000E+00 | 0.00000E+00 | 0.00000E+00 | 0.00000E+00 |
| A4 | 4.68920E−03 | −1.54924E−02 | −4.04116E−02 | −1.48872E−02 |
| A5 | 0.00000E+00 | 0.00000E+00 | 0.00000E+00 | 0.00000E+00 |
| A6 | −1.60019E−02 | 3.37158E−02 | −1.35703E−02 | −1.02896E−01 |
| A7 | 0.00000E+00 | 0.00000E+00 | 0.00000E+00 | 0.00000E+00 |
| A8 | 1.79859E−02 | −2.30742E−02 | −1.82644E−02 | 1.12267E−01 |
| A9 | 0.00000E+00 | 0.00000E+00 | 0.00000E+00 | 0.00000E+00 |
| A10 | −2.75704E−03 | 2.37553E−02 | 3.42062E−02 | −7.76461E−02 |
| A11 | 0.00000E+00 | 0.00000E+00 | 0.00000E+00 | 0.00000E+00 |
| A12 | −1.28157E−04 | −1.46477E−02 | −3.60388E−02 | 2.30567E−02 |
| A13 | 0.00000E+00 | 0.00000E+00 | 0.00000E+00 | 0.00000E+00 |
| A14 | 1.39094E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 3
Example 1

| | Si | | | |
|---|---|---|---|---|
| | 10 | 11 | 12 | 13 |
| C | 0.12972 | 0.14696 | −0.00709 | −0.42341 |
| K | −9.33322 | −9.80322 | 10.00000 | −3.28274 |
| A3 | −2.02792E−02 | −2.49210E−02 | −3.27680E−02 | −6.83267E−02 |
| A4 | 7.04897E−02 | 6.92771E−02 | 1.08929E−01 | 6.40262E−02 |
| A5 | −1.73270E−01 | −1.03640E−01 | −7.10516E−02 | −4.66333E−03 |
| A6 | 5.42788E−02 | −1.08943E−02 | −3.19147E−04 | −1.12438E−02 |
| A7 | 1.35813E−02 | 2.62771E−02 | 1.23774E−04 | 3.65359E−03 |
| A8 | −5.72819E−03 | 2.94843E−03 | 1.49886E−03 | 2.11673E−03 |
| A9 | 6.13514E−03 | −7.53235E−04 | −8.45430E−04 | −6.87493E−04 |
| A10 | 2.62845E−03 | −2.36372E−03 | 3.53567E−04 | −4.18077E−04 |
| A11 | −1.92174E−03 | −1.10439E−05 | 5.20880E−04 | −1.82893E−05 |
| A12 | −5.71433E−03 | −1.49514E−04 | −3.06018E−04 | 1.75496E−05 |
| A13 | −1.45082E−03 | −4.63541E−05 | 1.25024E−04 | 3.97152E−05 |
| A14 | 1.55776E−03 | 2.37766E−04 | −9.67703E−05 | 7.09287E−06 |
| A15 | 9.41358E−04 | 9.08870E−05 | 4.26436E−05 | −4.30409E−06 |
| A16 | 6.01655E−04 | 6.02556E−06 | 1.52410E−05 | −7.72950E−07 |
| A17 | 1.36093E−04 | −2.76187E−05 | −2.77128E−06 | −2.30790E−07 |
| A18 | −1.89019E−04 | −1.99834E−05 | −5.85299E−06 | −6.41820E−08 |
| A19 | −2.52852E−04 | 1.78249E−06 | −6.26689E−07 | 1.11223E−08 |
| A20 | 6.96785E−05 | 2.41915E−06 | 8.21682E−07 | 1.89410E−08 |
| | 14 | 15 | | |
| C | 0.23132 | 0.75026 | | |
| K | 0.07699 | −5.40490 | | |
| A3 | −5.70882E−02 | 3.72276E−02 | | |
| A4 | −1.89340E−01 | −1.44194E−01 | | |
| A5 | 7.93147E−02 | 7.36590E−02 | | |
| A6 | 1.28538E−02 | 6.61521E−04 | | |
| A7 | −2.04027E−03 | −1.02991E−02 | | |
| A8 | −3.02607E−03 | 2.22597E−03 | | |
| A9 | 7.45294E−05 | 1.91507E−06 | | |
| A10 | 2.20307E−04 | 2.65282E−05 | | |
| A11 | 4.55773E−06 | 6.56022E−06 | | |
| A12 | −1.21183E−05 | −1.32969E−05 | | |
| A13 | 4.50454E−07 | −1.67064E−07 | | |
| A14 | 4.99510E−07 | 1.03566E−06 | | |
| A15 | −3.49458E−08 | −2.65923E−08 | | |
| A16 | −1.83582E−09 | −2.21856E−08 | | |
| A17 | −2.29751E−09 | −1.38453E−11 | | |
| A18 | −9.38704E−10 | 1.87132E−10 | | |
| A19 | −9.61616E−11 | −3.56009E−11 | | |
| A20 | 8.75545E−11 | −4.59896E−12 | | |

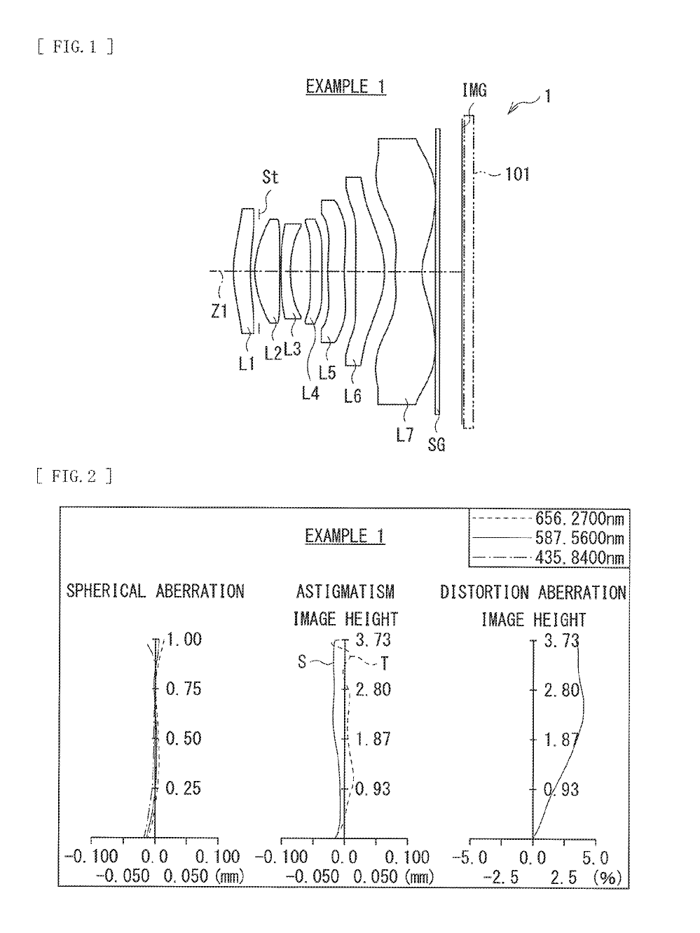

Various aberrations in Numerical example 1 above are illustrated in FIG. 2. FIG. 2 illustrates, as the various aberrations, a spherical aberration, an astigmatism (field curvature), and a distortion aberration. In the respective aberration diagrams, aberrations with d line (587.56 nm) as a reference wavelength are illustrated. In the spherical aberration diagram, aberrations to g line (435.84 nm) and C line (656.27 nm) are also illustrated. In the aberration diagram of the astigmatism, a solid line (S) indicates a value on a sagittal image plane, and a broken line (T) indicates a value on a tangential image plane. The same applies to aberration diagrams in the following other Numerical examples as well.

As can be appreciated from the respective aberration diagrams, it is clear that, in the imaging lens 1 according to Numerical Example 1, the various aberrations are favorably corrected while the lens is small-sized, and excellent optical performance is achieved.

### Numerical Example 2

Table 4 shows basic lens data of Numerical Example 2 in which specific numerical values are applied to the imaging lens 2 illustrated in FIG. 3.

In the imaging lens 2 according to Numerical Example 2, both surfaces of each of the first lens L1 to the seventh lens L7 have aspherical shapes. Table 5 and Table 6 show values of coefficients representing these aspherical shapes.

In the imaging lens 2 according to Numerical Example 2, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 4
Example 2

| Si | Li | Ri | Di | Ndi | νdi |
|---|---|---|---|---|---|
| 1 | OBJ | ∞ | ∞ | | |
| 2 | L1R1 ASP | 3.2745 | 0.4930 | 1.5455 | 56.02 |
| 3 | L1R2 ASP | 4.4802 | 0.1367 | | |
| 4 | L2R1 ASP | 2.1965 | 0.5788 | 1.5455 | 56.02 |
| 5 | L2R2 ASP | −49.5779 | 0.0313 | | |
| 6 | L3R1 ASP | 7.5067 | 0.2329 | 1.6683 | 20.36 |
| 7 | L3R2 ASP | 2.6936 | 0.5428 | | |
| 8 | L4R1 ASP | 78.5216 | 0.2682 | 1.5455 | 56.02 |
| 9 | L4R2 ASP | 127.5360 | 0.1657 | | |
| 10 | L5R1 ASP | 9.6775 | 0.4304 | 1.6432 | 23.58 |
| 11 | L5R2 ASP | 8.2965 | 0.3037 | | |
| 12 | L6R1 ASP | −34.2383 | 0.6596 | 1.5455 | 56.02 |
| 13 | L6R2 ASP | −2.3320 | 0.2896 | | |
| 14 | L7R1 ASP | 4.5850 | 0.6787 | 1.5364 | 55.63 |
| 15 | L7R2 ASP | 1.3487 | 0.3443 | | |
| 16 | SGR1 | ∞ | 0.1100 | 1.5140 | 51.40 |
| 17 | SGR2 | ∞ | 0.5780 | | |

TABLE 5
Example 2

| | Si | | | |
|---|---|---|---|---|
| | 2 | 3 | 4 | 5 |
| C | 0.30539 | 0.22320 | 0.45528 | −0.02017 |
| K | 1.95637 | −9.23478 | −6.73799 | 10.00000 |
| A3 | 0.00000E+00 | 0.00000E+00 | 0.00000E+00 | 0.00000E+00 |
| A4 | −3.56151E−02 | −6.60216E−02 | 3.81514E−02 | 3.51217E−02 |
| A5 | 0.00000E+00 | 0.00000E+00 | 0.00000E+00 | 0.00000E+00 |
| A6 | −3.50392E−03 | 2.49250E−02 | −1.29013E−02 | −6.47118E−02 |
| A7 | 0.00000E+00 | 0.00000E+00 | 0.00000E+00 | 0.00000E+00 |
| A8 | −1.68658E−03 | −5.55273E−03 | 1.02643E−02 | 4.21645E−02 |
| A9 | 0.00000E+00 | 0.00000E+00 | 0.00000E+00 | 0.00000E+00 |
| A10 | 1.42028E−03 | 1.21053E−03 | −3.35619E−03 | −1.38194E−02 |
| A11 | 0.00000E+00 | 0.00000E+00 | 0.00000E+00 | 0.00000E+00 |
| A12 | −2.80766E−04 | −1.44261E−04 | −4.76235E−04 | 1.42929E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.13321 | 0.37126 | 0.01274 | 0.00784 |
| K | −1.48215 | −0.50856 | 10.00000 | 8.41151 |
| A3 | 0.00000E+00 | 0.00000E+00 | 0.00000E+00 | 0.00000E+00 |
| A4 | 4.76114E−03 | −1.60663E−02 | −4.20317E−02 | −1.65738E−02 |
| A5 | 0.00000E+00 | 0.00000E+00 | 0.00000E+00 | 0.00000E+00 |
| A6 | −1.61685E−02 | 3.43301E−02 | −1.48500E−02 | −1.03758E−01 |
| A7 | 0.00000E+00 | 0.00000E+00 | 0.00000E+00 | 0.00000E+00 |
| A8 | 1.79716E−02 | −2.30018E−02 | −1.80858E−02 | 1.12231E−01 |
| A9 | 0.00000E+00 | 0.00000E+00 | 0.00000E+00 | 0.00000E+00 |
| A10 | −2.58083E−03 | 2.42604E−02 | 3.43000E−02 | −7.75912E−02 |
| A11 | 0.00000E+00 | 0.00000E+00 | 0.00000E+00 | 0.00000E+00 |
| A12 | −1.28159E−04 | −1.46477E−02 | −3.60388E−02 | 2.30756E−02 |
| A13 | 0.00000E+00 | 0.00000E+00 | 0.00000E+00 | 0.00000E+00 |
| A14 | 1.39094E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 6
Example 2

| | Si | | | |
|---|---|---|---|---|
| | 10 | 11 | 12 | 13 |
| C | 0.10333 | 0.12053 | −0.02921 | −0.42882 |
| K | −9.33322 | −9.80322 | 10.00000 | −3.28274 |
| A3 | −1.98976E−02 | −2.84014E−02 | −3.29563E−02 | −6.55556E−02 |
| A4 | 6.93141E−02 | 6.96336E−02 | 1.09369E−01 | 6.42116E−02 |
| A5 | −1.72921E−01 | −1.03694E−01 | −7.08830E−02 | −4.88978E−03 |
| A6 | 5.46194E−02 | −1.09934E−02 | −2.90243E−04 | −1.12817E−02 |
| A7 | 1.36867E−02 | 2.64706E−02 | 1.43585E−04 | 3.65606E−03 |
| A8 | −5.76864E−03 | 2.93710E−03 | 1.48793E−03 | 2.11986E−03 |
| A9 | 6.11752E−03 | −7.86384E−04 | −8.54026E−04 | −6.85971E−04 |
| A10 | 2.63281E−03 | −2.37866E−03 | 3.51219E−04 | −4.17389E−04 |
| A11 | −1.95615E−03 | −2.42498E−05 | 5.20253E−04 | −1.80112E−05 |
| A12 | −5.72675E−03 | −1.54009E−04 | −3.06334E−04 | 1.75832E−05 |
| A13 | −1.44801E−03 | −4.84083E−05 | 1.25016E−04 | 3.97213E−05 |
| A14 | 1.57188E−03 | 2.37670E−04 | −9.67817E−05 | 7.09375E−06 |
| A15 | 9.47584E−04 | 9.06972E−05 | 4.26630E−05 | −4.28883E−06 |
| A16 | 6.02882E−04 | 5.85405E−06 | 1.52466E−05 | −7.68979E−07 |
| A17 | 1.34308E−04 | −2.76055E−05 | −2.76752E−06 | −2.30609E−07 |
| A18 | −1.92048E−04 | −1.99487E−05 | −5.85063E−06 | −6.65283E−08 |
| A19 | −2.55338E−04 | 1.75055E−06 | −6.25374E−07 | 1.10947E−08 |
| A20 | 6.74467E−05 | 2.40064E−06 | 8.22332E−07 | 1.89278E−08 |
| | 14 | 15 | | |
| C | 0.21810 | 0.74148 | | |
| K | 0.07699 | −5.40490 | | |
| A3 | −5.66991E−02 | 3.30597E−02 | | |
| A4 | −1.89291E−01 | −1.42440E−01 | | |
| A5 | 7.93470E−02 | 7.35209E−02 | | |
| A6 | 1.28632E−02 | 6.03280E−04 | | |
| A7 | −2.03811E−03 | −1.03077E−02 | | |
| A8 | −3.02545E−03 | 2.22488E−03 | | |
| A9 | 7.46906E−05 | 1.70641E−06 | | |
| A10 | 2.20350E−04 | 2.64668E−05 | | |
| A11 | 4.56942E−06 | 6.54204E−06 | | |
| A12 | −1.21137E−05 | −1.33012E−05 | | |
| A13 | 4.50894E−07 | −1.67862E−07 | | |
| A14 | 4.99644E−07 | 1.03559E−06 | | |
| A15 | −3.48214E−08 | −2.65475E−08 | | |
| A16 | −1.81809E−09 | −2.21552E−08 | | |
| A17 | −2.29819E−09 | −7.45867E−13 | | |
| A18 | −9.39370E−10 | 1.92086E−10 | | |
| A19 | −9.72470E−11 | −3.37773E−11 | | |
| A20 | 8.69155E−11 | −3.99036E−12 | | |

Various aberrations in Numerical example 2 above are illustrated in FIG. 4. As can be appreciated from the respective aberration diagrams, it is clear that the various aberrations are favorably corrected while the lens is small-sized, and excellent optical performance is achieved.

### Numerical Example 3

Table 7 shows basic lens data of Numerical Example 3 in which specific numerical values are applied to the imaging lens 3 illustrated in FIG. 5.

In the imaging lens 3 according to Numerical Example 3, both surfaces of each of the first lens L1 to the seventh lens L7 have aspherical shapes. Table 8 and Table 9 show values of coefficients representing these aspherical shapes.

In the imaging lens 3 according to Numerical Example 3, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has positive refractive power near the optical axis. The sixth lens L6 has positive refractive power near the optical axis. The seventh lens L7 has negative refractive power near the optical axis.

TABLE 7
Example 3

| Si | Li | Ri | Di | Ndi | νdi |
|---|---|---|---|---|---|
| 1 | OBJ | ∞ | ∞ | | |
| 2 | L1R1 ASP | 3.8405 | 0.7506 | 1.5432 | 56.02 |
| 3 | L1R2 ASP | 1.9940 | 0.1310 | | |
| 4 | L2R1 ASP | 1.2793 | 0.7421 | 1.5432 | 56.02 |
| 5 | L2R2 ASP | −35.9773 | 0.0018 | | |
| 6 | L3R1 ASP | 5.4502 | 0.2800 | 1.6607 | 20.37 |
| 7 | L3R2 ASP | 2.4107 | 0.4832 | | |
| 8 | L4R1 ASP | −12.0645 | 0.2800 | 1.5432 | 56.02 |
| 9 | L4R2 ASP | 39.5916 | 0.1121 | | |
| 10 | L5R1 ASP | 5.5705 | 0.3475 | 1.6349 | 23.91 |
| 11 | L5R2 ASP | 5.9211 | 0.3178 | | |
| 12 | L6R1 ASP | 19.5664 | 0.4074 | 1.5432 | 56.02 |
| 13 | L6R2 ASP | −2.4314 | 0.5078 | | |
| 14 | L7R1 ASP | −135.6330 | 0.6173 | 1.5341 | 55.63 |
| 15 | L7R2 ASP | 1.8141 | 0.1914 | | |
| 16 | SGR1 | ∞ | 0.1100 | 1.5140 | 51.40 |
| 17 | SGR2 | ∞ | 0.5756 | | |

TABLE 8
Example 3

| | Si | | | |
|---|---|---|---|---|
| | 2 | 3 | 4 | 5 |
| C | 0.26038 | 0.50152 | 0.78165 | −0.02780 |
| K | 2.27464 | −10.00000 | −3.88604 | −20.00000 |
| A3 | 0.00000E+00 | 0.00000E+00 | 0.00000E+00 | 0.00000E+00 |
| A4 | −3.70894E−02 | −7.23105E−02 | 6.07793E−02 | 6.38072E−02 |
| A5 | 0.00000E+00 | 0.00000E+00 | 0.00000E+00 | 0.00000E+00 |
| A6 | 4.76024E−03 | 2.02626E−02 | −7.45571E−03 | −6.35383E−02 |
| A7 | 0.00000E+00 | 0.00000E+00 | 0.00000E+00 | 0.00000E+00 |
| A8 | −3.14871E−03 | −5.52342E−03 | 4.85399E−03 | 4.86555E−02 |
| A9 | 0.00000E+00 | 0.00000E+00 | 0.00000E+00 | 0.00000E+00 |
| A10 | 7.58617E−04 | 1.06607E−03 | 8.57674E−05 | −1.62723E−02 |
| A11 | 0.00000E+00 | 0.00000E+00 | 0.00000E+00 | 0.00000E+00 |
| A12 | −9.59953E−05 | −1.11828E−04 | 1.88158E−04 | 1.48466E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.18348 | 0.41483 | −0.08289 | 0.02526 |
| K | −10.00000 | −3.79529 | 10.00000 | 8.41151 |
| A3 | 0.00000E+00 | 0.00000E+00 | 0.00000E+00 | 0.00000E+00 |
| A4 | −3.95936E−02 | −3.53020E−02 | −4.37316E−02 | −3.19596E−02 |
| A5 | 0.00000E+00 | 0.00000E+00 | 0.00000E+00 | 0.00000E+00 |
| A6 | 9.89257E−03 | 8.05403E−02 | −2.94212E−02 | −1.05192E−01 |
| A7 | 0.00000E+00 | 0.00000E+00 | 0.00000E+00 | 0.00000E+00 |
| A8 | 1.65185E−02 | −5.07331E−02 | −4.95799E−04 | 1.12413E−01 |
| A9 | 0.00000E+00 | 0.00000E+00 | 0.00000E+00 | 0.00000E+00 |
| A10 | −6.74145E−03 | 3.30992E−02 | 2.97127E−02 | −7.79336E−02 |
| A11 | 0.00000E+00 | 0.00000E+00 | 0.00000E+00 | 0.00000E+00 |
| A12 | −1.28175E−04 | −1.46477E−02 | −3.60388E−02 | 2.30756E−02 |
| A13 | 0.00000E+00 | 0.00000E+00 | 0.00000E+00 | 0.00000E+00 |
| A14 | 1.39096E−04 | 5.04826E−03 | 1.44093E−02 | −6.42620E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 9
Example 3

| | Si | | | |
|---|---|---|---|---|
| | 10 | 11 | 12 | 13 |
| C | 0.17952 | 0.16889 | 0.05111 | −0.41128 |
| K | −9.33322 | −9.80322 | 10.00000 | −3.28274 |
| A3 | −3.17128E−02 | −4.509621−02 | −5.78348E−02 | −4.69792E−02 |
| A4 | 4.69374E−02 | 4.04521E−02 | 1.03134E−01 | 6.08276E−02 |
| A5 | −1.67595E−01 | −9.79155E−02 | −7.05540E−02 | −7.30364E−03 |
| A6 | 5.90082E−02 | −3.05466E−03 | 8.32855E−04 | −1.17462E−02 |
| A7 | 1.32698E−02 | 2.75476E−02 | 5.31137E−04 | 3.77075E−03 |
| A8 | −8.19208E−03 | 1.22342E−03 | 1.59695E−03 | 2.24929E−03 |
| A9 | 3.35642E−03 | −2.22999E−03 | −8.34632E−04 | −6.31599E−04 |
| A10 | 5.84031E−04 | −3.08634E−03 | 3.46129E−04 | −4.07283E−04 |
| A11 | −3.13818E−03 | −2.11410E−04 | 5.16409E−04 | −1.80679E−05 |
| A12 | −6.27142E−03 | −9.12592E−05 | −3.07863E−04 | 1.64959E−05 |
| A13 | −1.53711E−03 | 5.63127E−05 | 1.24307E−04 | 3.90338E−05 |
| A14 | 1.79206E−03 | 3.11475E−04 | −9.69609E−05 | 6.78081E−06 |
| A15 | 1.23997E−03 | 1.35269E−04 | 4.25957E−05 | −4.45504E−06 |
| A16 | 8.64631E−04 | 2.79533E−05 | 1.52314E−05 | −8.30419E−07 |
| A17 | 3.06443E−04 | −1.88176E−05 | −2.77278E−06 | −2.46521E−07 |
| A18 | −1.29636E−04 | −1.99545E−05 | −5.85248E−06 | −7.06378E−08 |
| A19 | −3.04190E−04 | −3.08819E−07 | −6.26844E−07 | 1.24733E−08 |
| A20 | −4.75093E−05 | 4.02755E−08 | 8.21459E−07 | 2.01717E−08 |
| | 14 | 15 | | |
| C | −0.00737 | 0.55123 | | |
| K | 0.07699 | −5.40490 | | |
| A3 | −9.88794E−03 | −1.20056E−02 | | |
| A4 | −1.88169E−01 | −1.15589E−01 | | |
| A5 | 7.87812E−02 | 6.91845E−02 | | |
| A6 | 1.26345E−02 | −5.18375E−04 | | |
| A7 | −2.09368E− 03 | −1.03427E−02 | | |
| A8 | −3.03704E−03 | 2.25456E−03 | | |
| A9 | 7.35961E−05 | 1.09539E−05 | | |
| A10 | 2.20647E−04 | 2.80296E−05 | | |
| A11 | 4.73334E−06 | 6.69719E−06 | | |
| A12 | −1.20368E−05 | −1.33054E−05 | | |
| A13 | 4.78905E·07 | −1.73914E−07 | | |
| A14 | 5.06584E−07 | 1.03448E−06 | | |
| A15 | −3.22968E−08 | −2.64697E−08 | | |
| A16 | −1.50032E−09 | −2.19662E−08 | | |
| A17 | −2.23416E−09 | 7.57712E−11 | | |
| A18 | −9.67432E−10 | 2.11017E−10 | | |
| A19 | −1.13130E−10 | −3.23379E−11 | | |
| A20 | 7.49782E−11 | −5.60717E−12 | | |

Various aberrations in Numerical example 3 above are illustrated in FIG. 6. As can be appreciated from the respective aberration diagrams, it is clear that the various aberrations are favorably corrected while the lens is small-sized, and excellent optical performance is achieved.

### Numerical Example 4

Table 10 shows basic lens data of Numerical Example 4 in which specific numerical values are applied to the imaging lens 4 illustrated in FIG. 7.

In the imaging lens 4 according to Numerical Example 4, both surfaces of each of the first lens L1 to the seventh lens L7 have aspherical shapes. Table 11 and Table 12 show values of coefficients representing these aspherical shapes.

In the imaging lens 4 according to Numerical Example 4, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 10
Example 4

| Si | Li | Ri | Di | Ndi | νdi |
|---|---|---|---|---|---|
| 1 | OBJ | ∞ | ∞ | | |
| 2 | L1R1 ASP | 3.1335 | 0.2996 | 1.5432 | 56.02 |
| 3 | L1R2 ASP | 3.0909 | 0.0983 | | |
| 4 | L2R1 ASP | 1.9240 | 0.7700 | 1.5432 | 56.02 |
| 5 | L2R2 ASP | 78.9803 | 0.0334 | | |
| 6 | L3R1 ASP | 9.9859 | 0.3324 | 1.6607 | 20.37 |
| 7 | L3R2 ASP | 2.9910 | 0.4470 | | |
| 8 | L4R1 ASP | 24.3781 | 0.3313 | 1.5432 | 56.02 |
| 9 | L4R2 ASP | 253.1360 | 0.2038 | | |
| 10 | L5R1 ASP | 10.1848 | 0.4174 | 1.6349 | 23.91 |
| 11 | L5R2 ASP | 8.3776 | 0.2644 | | |
| 12 | L6R1 ASP | −165.2870 | 0.8165 | 1.5432 | 56.02 |
| 13 | L6R2 ASP | −2.3739 | 0.2458 | | |
| 14 | L7R1 ASP | 4.2657 | 0.6447 | 1.5341 | 55.63 |
| 15 | L7R2 ASP | 1.3361 | 0.3410 | | |
| 16 | SGR1 | ∞ | 0.1100 | 1.5140 | 51.40 |
| 17 | SGR2 | ∞ | 0.6629 | | |

TABLE 11
Example 4

| | Si | | | |
|---|---|---|---|---|
| | 2 | 3 | 4 | 5 |
| C | 0.31914 | 0.32353 | 0.51976 | 0.01266 |
| K | 2.13977 | −7.80938 | −5.76020 | −20.00000 |
| A3 | 0.00000E+00 | 0.00000E+00 | 0.00000E+00 | 0.00000E+00 |
| A4 | −3.30024E−02 | −5.98859E−02 | 3.47967E−02 | 3.39056E−02 |
| A5 | 0.00000E+00 | 0.00000E+00 | 0.00000E+00 | 0.00000E+00 |
| A6 | −1.28951E−03 | 2.81366E−02 | −1.50173E−02 | −6.30581E−02 |
| A7 | 0.00000E+00 | 0.00000E+00 | 0.00000E+00 | 0.00000E+00 |
| A8 | −6.64077E−04 | −4.55535E−03 | 1.05047E−02 | 3.87031E−02 |
| A9 | 0.00000E+00 | 0.00000E+00 | 0.00000E+00 | 0.00000E+00 |
| A10 | 1.68923E−03 | 1.15936E−03 | −3.06916E−03 | −1.32936E−02 |
| A11 | 0.00000E+00 | 0.00000E+00 | 0.00000E+00 | 0.00000E+00 |
| A12 | −3.42424E−04 | 4.36248E−05 | −4.98638E−04 | 1.47529E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.10014 | 0.33433 | 0.04102 | 0.00395 |
| K | 8.83316 | −0.57950 | 10.00000 | −2.66236 |
| A3 | 0.00000E+00 | 0.00000E+00 | 0.00000E+00 | 0.00000E+00 |
| A4 | 7.20270E−03 | −1.59397E−02 | −4.29663E−02 | −9.13934E−03 |
| A5 | 0.00000E+00 | 0.00000E+00 | 0.00000E+00 | 0.00000E+00 |
| A6 | −1.83288E−02 | 3.11059E−02 | −8.05876E−03 | −1.03768E−01 |
| A7 | 0.00000E+00 | 0.00000E+00 | 0.00000E+00 | 0.00000E+00 |
| A8 | 1.86510E−02 | −2.20027E−02 | −2.12177E−02 | 1.13796E−01 |
| A9 | 0.00000E+00 | 0.00000E+00 | 0.00000E+00 | 0.00000E+00 |
| A10 | −3.70472E−03 | 2.24063E−02 | 3.55230E−02 | −7.80466E−02 |
| A11 | 0.00000E+00 | 0.00000E+00 | 0.00000E+00 | 0.00000E+00 |
| A12 | −2.18125E−04 | −1.46477E−02 | −3.60389E−02 | 2.30758E−02 |
| A13 | 0.00000E+00 | 0.00000E+00 | 0.00000E+00 | 0.00000E+00 |
| A14 | 1.39100E−04 | 5.04830E−03 | 1.44093E−02 | −6.42600E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 12
Example 4

| | Si | | | |
|---|---|---|---|---|
| | 10 | 11 | 12 | 13 |
| C | 0.09819 | 0.11937 | −0.00605 | −0.42126 |
| K | −10.00000 | −3.04083 | 10.00000 | −3.40316 |
| A3 | −1.26156E−02 | −2.04566E−02 | −3.51968E−02 | −6.62062E−02 |
| A4 | 7.53827E−02 | 7.39419E−02 | 1.08705E−01 | 6.34198E−02 |
| A5 | −1.71386E−01 | −1.04485E−01 | −6.92813E−02 | −4.73389E−03 |
| A6 | 5.20656E−02 | −1.07454E−02 | 4.31788E−05 | −1.11779E−02 |
| A7 | 1.25673E−02 | 2.61948E−02 | 1.78951E−04 | 3.68290E−03 |
| A8 | −5.68982E−03 | 2.77069E−03 | 1.49857E−03 | 2.11984E−03 |
| A9 | 6.31815E−03 | −8.51413E−04 | −8.60675E−04 | −6.87435E−04 |
| A10 | 2.70078E−03 | −2.40677E−03 | 3.43801E−04 | −4.18339E−04 |
| A11 | −1.94929E−03 | −2.64449E−05 | 5.16081E−04 | −1.85367E−05 |
| A12 | −5.76850E−03 | −1.51359E−04 | −3.08026E−04 | 1.75039E−05 |
| A13 | −1.49718E−03 | −4.36074E−05 | 1.24398E−04 | 3.96692E−05 |
| A14 | 1.53079E−03 | 2.40773E−04 | −9.69584E−05 | 7.06065E−06 |
| A15 | 9.30194E−04 | 9.30516E−05 | 4.26179E−05 | −4.31022E−06 |
| A16 | 6.00630E−04 | 7.25398E−06 | 1.52233E−05 | −7.72476E−07 |
| A17 | 1.40069E−04 | −2.70896E−05 | −2.76914E−06 | −2.30863E−07 |
| A18 | −1.84379E−04 | −1.97839E−05 | −5.85132E−06 | −6.21252E−08 |
| A19 | −2.48339E−04 | 1.75064E−06 | −6.26028E−07 | 1.03546E−08 |
| A20 | 7.28413E−05 | 2.28920E−06 | 8.21907E−07 | 1.86145E−08 |
| | 14 | 15 | | 15 |
| C | 0.23443 | 0.74846 | A21 | 3.64925E−13 |
| K | 0.09666 | −5.49363 | A22 | −1.27429E−13 |
| A3 | −5.51620E−02 | 3.54134E−02 | A23 | −4.70041E−14 |
| A4 | −1.89421E−01 | −1.46241E−01 | | |
| A5 | 7.93138E−02 | 7.36094E−02 | | |
| A6 | 1.28451E−02 | 7.38652E−04 | | |
| A7 | −2.04106E−03 | −1.03460E−02 | | |
| A8 | −3.02477E−03 | 2.21986E−03 | | |
| A9 | 7.49579E−05 | 6.05129E−06 | | |
| A10 | 2.20498E−04 | 2.79067E−05 | | |
| A11 | 4.62616E−06 | 6.91169E−06 | | |
| A12 | 1.21046E−05 | −1.32253E−05 | | |
| A13 | 4.51106E−07 | −1.56002E−07 | | |
| A14 | 4.99167E−07 | 1.03320E−06 | | |
| A15 | −3.58990E−08 | −2.77004E−08 | | |
| A16 | −2.12234E−09 | −2.25313E−08 | | |
| A17 | −2.41482E−09 | −1.01342E−10 | | |
| A18 | −9.52919E−10 | 1.70464E−10 | | |
| A19 | −9.72488E−11 | −3.19372E−11 | | |
| A20 | 9.44016E−11 | −2.13874E−12 | | |

Various aberrations in Numerical example 4 above are illustrated in FIG. 8. As can be appreciated from the respective aberration diagrams, it is clear that the various aberrations are favorably corrected while the lens is small-sized, and excellent optical performance is achieved.

### Numerical Example 5

Table 13 shows basic lens data of Numerical Example 5 in which specific numerical values are applied to the imaging lens 5 illustrated in FIG. 9.

In the imaging lens 5 according to Numerical Example 5, both surfaces of each of the first lens L1 to the seventh lens L7 have aspherical shapes. Table 14 and Table 15 show values of coefficients representing these aspherical shapes.

In the imaging lens 5 according to Numerical Example 5, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has negative refractive power near the optical axis. The sixth lens L6 has positive refractive power near the optical axis. The seventh lens L7 has negative refractive power near the optical axis.

TABLE 13
Example 5

| Si | Li | Ri | Di | Ndi | νdi |
|---|---|---|---|---|---|
| 1 | OBJ | ∞ | ∞ | | |
| 2 | L1R1 ASP | 3.0078 | 0.2800 | 1.5432 | 56.02 |
| 3 | L1R2 ASP | 2.9386 | 0.1397 | | |
| 4 | L2R1 ASP | 1.7334 | 0.6470 | 1.5432 | 56.02 |
| 5 | L2R2 ASP | 8.4689 | 0.1419 | | |
| 6 | L3R1 ASP | −12.8011 | 0.2800 | 1.6607 | 20.36 |
| 7 | L3R2 ASP | 22.3614 | 0.3812 | | |
| 8 | L4R1 ASP | −13.7085 | 0.2800 | 1.5432 | 56.02 |
| 9 | L4R2 ASP | −13.9851 | 0.1112 | | |
| 10 | L5R1 ASP | −7.9516 | 0.4317 | 1.6607 | 20.36 |
| 11 | L5R2 ASP | −30.9942 | 0.4246 | | |
| 12 | L6R1 ASP | 11.2870 | 0.7344 | 1.5432 | 56.02 |
| 13 | L6R2 ASP | −2.2394 | 0.7516 | | |
| 14 | L7R1 ASP | 21.9957 | 0.3400 | 1.5341 | 55.63 |
| 15 | L7R2 ASP | 1.5004 | 0.2268 | | |
| 16 | SGR1 | ∞ | 0.1100 | 1.5140 | 51.40 |
| 17 | SGR2 | ∞ | 0.5747 | | |

TABLE 14
Example 5

| | Si | | | |
|---|---|---|---|---|
| | 2 | 3 | 4 | 5 |
| C | 0.33247 | 0.34030 | 0.57691 | 0.11808 |
| K | 1.35865 | −9.94463 | −4.40367 | −20.00000 |
| A3 | 0.00000E+00 | 0.00000E+00 | 0.00000E+00 | 0.00000E+00 |
| A4 | −4.02457E−02 | −6.50502E−02 | 2.95943E−02 | −5.63790E−03 |
| A5 | 0.00000E+00 | 0.00000E+00 | 0.00000E+00 | 0.00000E+00 |
| A6 | −2.06154E−03 | 2.43067E−02 | −6.43411E−03 | −4.84272E−02 |
| A7 | 0.00000E+00 | 0.00000E+00 | 0.00000E+00 | 0.00000E+00 |
| A8 | −2.18869E−03 | −5.47476E−03 | 1.06931E−02 | 4.22460E−02 |
| A9 | 0.00000E+00 | 0.00000E+00 | 0.00000E+00 | 0.00000E+00 |
| A10 | 1.53725E−03 | 1.22020E−03 | −4.54245E−03 | −1.16993E−02 |
| A11 | 0.00000E+00 | 0.00000E+00 | 0.00000E+00 | 0.00000E+00 |
| A12 | −3.12117E−04 | −1.97982E−04 | 1.06889E−03 | 8.86296E−04 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | −0.07812 | 0.04472 | −0.07295 | −0.07150 |
| 1K | −10.00000 | 10.00000 | 10.00000 | 8.41151 |
| A3 | 0.00000E+00 | 0.00000E+00 | 0.00000E+00 | 0.00000E+00 |
| A4 | 2.62432E−02 | 4.15400E−02 | −6.61784E−02 | −3.56831E−02 |
| A5 | 0.00000E+00 | 0.00000E+00 | 0.00000E+00 | 0.00000E+00 |
| A6 | −1.05804E−02 | 1.89181E−02 | −3.03490E−02 | −1.28089E−01 |
| A7 | 0.00000E+00 | 0.00000E+00 | 0.00000E+00 | 0.00000E+00 |
| A8 | 2.16883E−02 | −9.66722E−03 | 1.19178E−03 | 1.06965E−01 |
| A9 | 0.00000E+00 | 0.00000E+00 | 0.00000E+00 | 0.00000E+00 |
| A10 | −7.04247E−03 | 1.47546E−02 | 2.99337E−02 | −6.63468E−02 |
| A11 | 0.00000E+00 | 0.00000E+00 | 0.00000E+00 | 0.00000E+00 |
| A12 | 1.08237E−05 | −1.46477E−02 | −3.60388E−02 | 2.30782E−02 |
| A13 | 0.00000E+00 | 0.00000E+00 | 0.00000E+00 | 0.00000E+00 |
| A14 | 1.39095E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 15
Example 5

| | Si | | | |
|---|---|---|---|---|
| | 10 | 11 | 12 | 13 |
| C | −0.12576 | −0.03226 | 0.08860 | −0.44654 |
| K | −9.33322 | −9.80322 | 10.00000 | −3.28274 |
| A3 | −2.40183E−02 | −2.09770E−02 | −1.57746E−02 | −2.01999E−03 |
| A4 | 4.46754E−02 | 5.65584E−03 | 5.70692E−02 | 3.27724E−02 |
| A5 | −1.82203E−01 | −8.00767E−02 | −6.58452E−02 | −1.26508E−02 |
| A6 | 5.29289E−02 | 4.40358E−03 | 1.23827E−02 | −1.12421E−02 |
| A7 | 9.49729E−03 | 2.56972E−02 | 3.66369E−03 | 4.60600E−03 |
| A8 | −1.04921E−02 | −1.88916E−04 | 1.10088E−03 | 2.60300E−03 |
| A9 | 2.72847E−03 | −2.45156E−03 | −1.64178E−03 | −5.71418E−04 |
| A10 | 1.44133E−03 | −2.80712E−03 | −5.44925E−05 | −4.07022E−04 |
| A11 | −1.52266E−03 | −7.98810E−05 | 3.99935E−04 | −2.78033E−05 |
| A12 | −4.80481E−03 | −1.73008E−05 | −3.24549E−04 | 1.15302E−05 |
| A13 | −5.55250E−04 | 7.34580E−05 | 1.30225E−04 | 3.71620E−05 |
| A14 | 2.29764E−03 | 3.11067E−04 | −8.97753E−05 | 6.24024E−06 |
| A15 | 1.54124E−03 | 1.24198E−04 | 4.69216E−05 | −4.50087E−06 |
| A16 | 1.01953E−03 | 1.87439E−05 | 1.70210E−05 | −8.13904E−07 |
| A17 | 4.39316E−04 | −2.33597E−05 | −2.27530E−06 | −2.27393E−07 |
| A18 | −9.75719E−05 | −1.96413E−05 | −5.75296E−06 | −5.59474E−08 |
| A19 | −3.80695E−04 | 1.98199E−06 | −6.78808E−07 | 1.56708E−08 |
| A20 | −2.29518E−04 | 1.53800E−06 | 7.39437E−07 | 2.07072E−08 |

| | 14 | 15 |
|---|---|---|
| C | 0.04546 | 0.66650 |
| K | 0.07699 | −5.40490 |
| A3 | −2.94566E−02 | −2.47037E−02 |
| A4 | −1.91447E−01 | −1.03274E−01 |
| A5 | 7.68986E−02 | 6.48877E−02 |
| A6 | 1.30826E−02 | −6.08467E−04 |
| A7 | −1.88600E−03 | −9.80529E−03 |
| A8 | −2.98522E−03 | 2.35534E−03 |
| A9 | 8.21219E−05 | −2.20557E−06 |
| A10 | 2.21018E−04 | 2.04566E−05 |
| A11 | 4.36322E−06 | 5.36821E−06 |
| A12 | −1.22666E−05 | −1.35400E−05 |
| A13 | 3.91152E−07 | −1.80959E−07 |
| A14 | 4.80721E−07 | 1.04247E−06 |
| A15 | −4.00236E−08 | −2.26045E−08 |
| A16 | −2.93351E−09 | −2.09821E−08 |
| A17 | −2.43830E−09 | 2.56865E−10 |
| A18 | −9.07748E−10 | 2.19582E−10 |
| A19 | −6.43680E−11 | −4.49053E−11 |
| A20 | 1.03436E−10 | −1.34354E−11 |

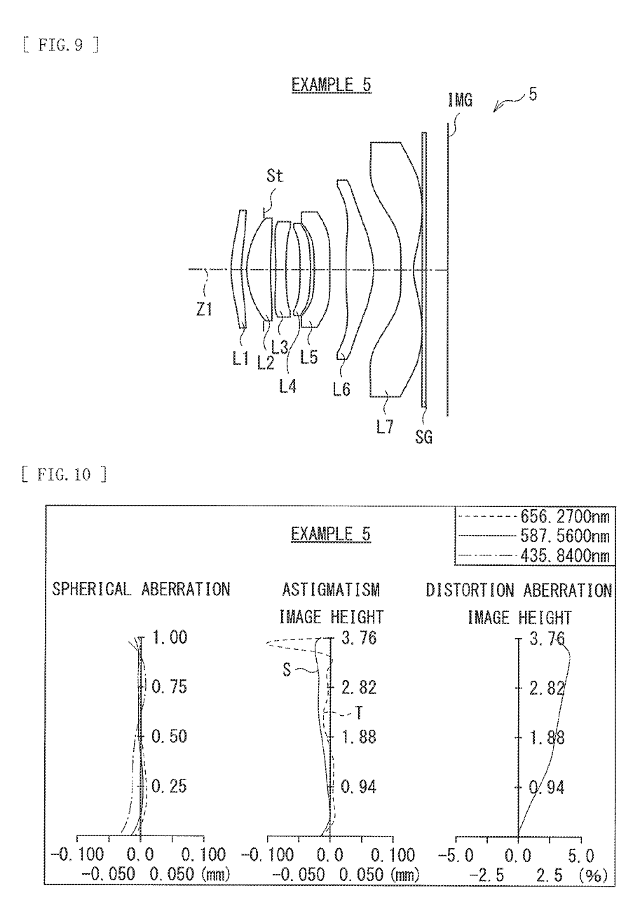

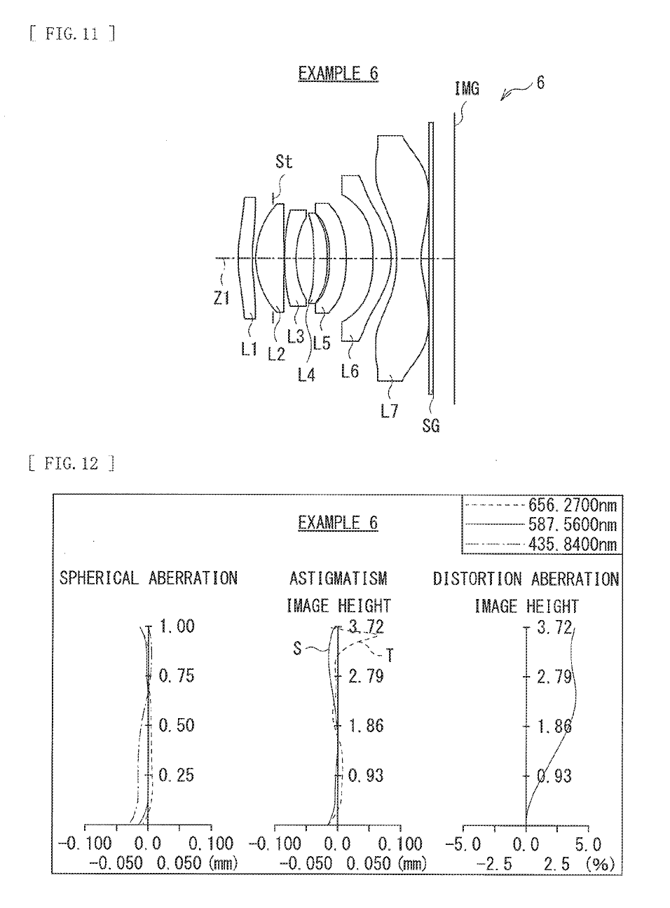

Various aberrations in Numerical example 5 above are illustrated in FIG. 10. As can be appreciated from the respective aberration diagrams, it is clear that the various aberrations are favorably corrected while the lens is small-sized, and excellent optical performance is achieved.

### Numerical Example 6

Table 16 shows basic lens data of Numerical Example 6 in which specific numerical values are applied to the imaging lens 6 illustrated in FIG. 11.

In the imaging lens 6 according to Numerical Example 6, both surfaces of each of the first lens L1 to the seventh lens L7 have aspherical shapes. Table 17 and Table 18 show values of coefficients representing these aspherical shapes.

In the imaging lens 6 according to Numerical Example 6, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has positive refractive power near the optical axis. The sixth lens L6 has positive refractive power near the optical axis. The seventh lens L7 has negative refractive power near the optical axis.

TABLE 16
Example 6

| Si | Li | Ri | Di | Ndi | νdi |
|---|---|---|---|---|---|
| 1 | OBJ | ∞ | ∞ | | |
| 2 | L1R1 ASP | 3.3370 | 0.3880 | 1.5432 | 56.02 |
| 3 | L1R2 ASP | 3.5933 | 0.0968 | | |
| 4 | L2R1 ASP | 2.0099 | 0.7695 | 1.5432 | 56.02 |
| 5 | L2R2 ASP | −30.8318 | 0.0099 | | |
| 6 | L3R1 ASP | 4.4066 | 0.3098 | 1.6607 | 20.36 |
| 7 | L3R2 ASP | 2.1741 | 0.4911 | | |
| 8 | L4R1 ASP | −9.3600 | 0.3654 | 1.5432 | 56.02 |
| 9 | L4R2 ASP | −4.3353 | 0.0483 | | |
| 10 | L5R1 ASP | −5.3199 | 0.4525 | 1.6425 | 22.70 |
| 11 | L5R2 ASP | −4.8300 | 0.7250 | | |
| 12 | L6R1 ASP | −5.8656 | 0.4900 | 1.5432 | 56.02 |
| 13 | L6R2 ASP | −1.8582 | 0.1505 | | |
| 14 | L7R1 ASP | −4.3640 | 0.6622 | 1.5341 | 55.63 |
| 15 | L7R2 ASP | 2.0640 | 0.2110 | | |
| 16 | SGR1 | ∞ | 0.1100 | 1.5140 | 51.40 |
| 17 | SGR2 | ∞ | 0.5744 | | |

TABLE 17
Example 6

| | Si | | | |
|---|---|---|---|---|
| | 2 | 3 | 4 | 5 |
| C | 0.29967 | 0.27829 | 0.49754 | −0.03243 |
| K | 1.94785 | −4.65680 | −5.18915 | −19.17803 |
| A3 | 0.00000E+00 | 0.00000E+00 | 0.00000E+00 | 0.00000E+00 |
| A4 | −4.46980E−02 | −7.88429E−02 | 4.50994E−02 | 5.11153E−02 |
| A5 | 0.00000E+00 | 0.00000E+00 | 0.00000E+00 | 0.00000E+00 |
| A6 | −5.59408E−03 | 2.36096E−02 | −5.34662E−03 | −6.55484E−02 |
| A7 | 0.00000E+00 | 0.00000E+00 | 0.00000E+00 | 0.00000E+00 |
| A8 | 4.04327E−04 | −3.86601E−03 | 8.46452E−03 | 3.86402E−02 |
| A9 | 0.00000E+00 | 0.00000E+00 | 0.00000E+00 | 0.00000E+00 |
| A10 | 1.28505E−03 | 1.15494E−03 | −3.91889E−03 | −1.11212E−02 |
| A11 | 0.00000E+00 | 0.00000E+00 | 0.00000E+00 | 0.00000E+00 |
| A12 | −2.97425E−04 | −1.70964E−04 | 7.65100E−04 | 1.33224E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.22693 | 0.45996 | −0.10684 | −0.23067 |
| K | −9.99766 | −2.90621 | 10.00000 | 8.41151 |
| A3 | 0.00000E+00 | 0.00000E+00 | 0.00000E+00 | 0.00000E+00 |
| A4 | −1.34327E−02 | −2.73150E−02 | −2.82298E−02 | −5.95692E−02 |
| A5 | 0.00000E+00 | 0.00000E+00 | 0.00000E+00 | 0.00000E+00 |
| A6 | −8.41098E−03 | 5.65246E−02 | −2.43234E−02 | −7.72489E−02 |
| A7 | 0.00000E+00 | 0.00000E+00 | 0.00000E+00 | 0.00000E+00 |
| A8 | 1.18303E−02 | −3.47003E−02 | −5.63823E−04 | 1.27972E−01 |
| A9 | 0.00000E+00 | 0.00000E+00 | 0.00000E+00 | 0.00000E+00 |
| A10 | 1.32496E−03 | 3.07773E−02 | 3.43154E−02 | −7.99639E−02 |
| A11 | 0.00000E+00 | 0.00000E+00 | 0.00000E+00 | 0.00000E+00 |
| A12 | −1.99275E−03 | −1.51211E−02 | −3.58286E−02 | 2.17011E−02 |
| A13 | 0.00000E+00 | 0.00000E+00 | 0.00000E+00 | 0.00000E+00 |
| A14 | 1.37839E−04 | 5.05003E−03 | 1.44080E−02 | −6.39347E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 18
Example 6

| | Si | | | |
|---|---|---|---|---|
| | 10 | 11 | 12 | 13 |
| C | −0.18797 | −0.20704 | −0.17049 | −0.53816 |
| K | −9.33322 | −9.80322 | 10.00000 | −3.28274 |
| A3 | −3.71143E−02 | −3.56504E−02 | −4.80819E−02 | −4.76973E−03 |
| A4 | 5.83171E−03 | −1.97891E−03 | 1.78920E−02 | −3.04997E−02 |
| A5 | −1.68396E−01 | −4.37521E−02 | −7.11207E−02 | −5.69695E−03 |
| A6 | 7.38284E−02 | 6.57259E−05 | 2.21278E−02 | 1.08825E−05 |
| A7 | 2.04582E−02 | 1.95667E−02 | 8.44543E−03 | 7.74648E−03 |
| A8 | −4.01419E−03 | −1.08239E−03 | 2.09304E−03 | 2.70985E−03 |
| A9 | 7.71757E−03 | −1.96879E−03 | −2.40422E−03 | −9.03904E−04 |
| A10 | 2.93893E−03 | −2.72322E−03 | −7.64028E−04 | −5.98231E−04 |
| A11 | −3.92279E−03 | −8.50315E−05 | −1.54265E−05 | −9.05266E−05 |
| A12 | −1.00975E−02 | −3.52770E−04 | −4.67258E−04 | −6.47535E−06 |
| A13 | −5.02434E−03 | −1.33605E−04 | 1.41123E−04 | 3.42580E−05 |
| A14 | −4.99797E−04 | 2.28460E−04 | −4.82812E−05 | 6.96778E−06 |
| A15 | 7.07897E−04 | 1.33047E−04 | 8.55113E−05 | −3.57247E−06 |
| A16 | 2.33106E−03 | 8.77158E−05 | 3.98935E−05 | −2.50531E−07 |
| A17 | 2.17625E−03 | 3.04453E−05 | 8.44173E−06 | 1.25127E−09 |
| A18 | 1.34502E−03 | 6.31125E−06 | −3.53704E−06 | 3.24397E−08 |
| A19 | 1.75333E−04 | 2.91993E−06 | −2.48862E−06 | 1.77465E−08 |
| A20 | −1.74563E−03 | −2.39742E−05 | −2.83722E−06 | −3.55200E−09 |

| | 14 | 15 |
|---|---|---|
| C | −0.22915 | 0.48450 |
| K | 0.07699 | −5.40490 |
| A3 | 3.46245E−02 | 4.19300E−03 |
| A4 | −1.49056E−01 | −1.11130E−01 |
| A5 | 6.77791E−02 | 6.51307E−02 |
| A6 | 1.04983E−02 | −2.44571E−03 |
| A7 | −2.19035E−03 | −9.41720E−03 |
| A8 | −2.97190E−03 | 2.46674E−03 |
| A9 | 1.01647E−04 | −4.52468E−06 |
| A10 | 2.28887E−04 | 1.05322E−05 |
| A11 | 6.72364E−06 | 2.85422E−06 |
| A12 | −1.16817E−05 | −1.36309E−05 |
| A13 | 4.94813E−07 | −7.28839E−08 |
| A14 | 4.83719E−07 | 1.09425E−06 |
| A15 | −4.77098E−08 | −8.46784E−09 |
| A16 | −7.62173E−09 | −1.83165E−08 |
| A17 | −4.21417E−09 | 5.07185E−10 |
| A18 | −1.37900E−09 | 1.36152E−10 |
| A19 | −9.34541E−11 | −1.09602E−10 |
| A20 | 1.75900E−10 | −3.70423E−11 |

Various aberrations in Numerical example 6 above are illustrated in FIG. 12. As can be appreciated from the respective aberration diagrams, it is clear that the various aberrations are favorably corrected while the lens is small-sized, and excellent optical performance is achieved.

### Numerical Example 7

Table 19 shows basic lens data of Numerical Example 7 in which specific numerical values are applied to the imaging lens 7 illustrated in FIG. 13.

In the imaging lens 7 according to Numerical Example 7, both surfaces of each of the first lens L1 to the seventh lens L7 have aspherical shapes. Table 20 and Table 21 show values of coefficients representing these aspherical shapes.

In the imaging lens 7 according to Numerical Example 7, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has positive refractive power near the optical axis. The sixth lens L6 has positive refractive power near the optical axis. The seventh lens L7 has negative refractive power near the optical axis.

TABLE 19
Example 7

| Si | Li | Ri | Di | Ndi | νdi |
|---|---|---|---|---|---|
| 1 | OBJ | ∞ | ∞ | | |
| 2 | L1R1 ASP | 3.2564 | 0.3796 | 1.5432 | 56.02 |
| 3 | L1R2 ASP | 3.5218 | 0.1090 | | |
| 4 | L2R1 ASP | 1.9718 | 0.7234 | 1.5432 | 56.02 |
| 5 | L2R2 ASP | −177.0150 | 0.0010 | | |
| 6 | L3R1 ASP | 4.5426 | 0.3596 | 1.6607 | 20.36 |
| 7 | L3R2 ASP | 2.1989 | 0.4744 | | |
| 8 | L4R1 ASP | −13.3713 | 0.2600 | 1.5432 | 56.02 |
| 9 | L4R2 ASP | −7.4124 | 0.0778 | | |
| 10 | L5R1 ASP | −12.4760 | 0.4800 | 1.6382 | 23.37 |
| 11 | L5R2 ASP | −10.3046 | 0.4015 | | |
| 12 | L6R1 ASP | −6.7554 | 0.4900 | 1.5432 | 56.02 |
| 13 | L6R2 ASP | −2.2640 | 0.3639 | | |
| 14 | L7R1 ASP | −27.3710 | 0.8124 | 1.5341 | 55.63 |
| 15 | L7R2 ASP | 1.8792 | 0.2375 | | |
| 16 | SGR1 | ∞ | 0.1100 | 1.5140 | 51.40 |
| 17 | SGR2 | ∞ | 0.5746 | | |

TABLE 20
Example 7

| | Si | | | |
|---|---|---|---|---|
| | 2 | 3 | 4 | 5 |
| C | 0.30709 | 0.28395 | 0.50716 | −0.00565 |
| K | 1.82156 | −5.56795 | −5.05409 | 10.00000 |
| A3 | 0.00000E+00 | 0.00000E+00 | 0.00000E+00 | 0.00000E+00 |
| A4 | −4.56783E−02 | −7.70907E−02 | 4.66440E−02 | 4.63216E−02 |
| A5 | 0.00000E+00 | 0.00000E+00 | 0.00000E+00 | 0.00000E+00 |
| A6 | −4.21544E−03 | 2.42870E−02 | −6.27884E−03 | −6.27276E−02 |
| A7 | 0.00000E+00 | 0.00000E+00 | 0.00000E+00 | 0.00000E+00 |
| A8 | −1.31283E−04 | −4.03336E−03 | 8.86767E−03 | 3.82656E−02 |
| A9 | 0.00000E+00 | 0.00000E+00 | 0.00000E+00 | 0.00000E+00 |
| A10 | 1.38408E−03 | 1.07726E−03 | −3.99988E−03 | −1.14366E−02 |
| A11 | 0.00000E+00 | 0.00000E+00 | 0.00000E+00 | 0.00000E+00 |
| A12 | −2.99666E−04 | −1.30242E−04 | 7.30622E−04 | 1.38319E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.22014 | 0.45476 | −0.07479 | −0.13491 |
| K | −7.22390 | −1.88306 | 10.00000 | 8.41151 |
| A3 | 0.00000E+00 | 0.00000E+00 | 0.00000E+00 | 0.00000E+00 |
| A4 | −6.81438E−03 | −2.33024E−02 | −4.08461E−02 | −7.51388E−02 |
| A5 | 0.00000E+00 | 0.00000E+00 | 0.00000E+00 | 0.00000E+00 |
| A6 | −1.28814E−02 | 5.20419E−02 | −1.56488E−02 | −9.47023E−02 |
| A7 | 0.00000E+00 | 0.00000E+00 | 0.00000E+00 | 0.00000E+00 |
| A8 | 1.55288E−02 | −3.24797E−02 | −1.83845E−02 | 1.29149E−01 |
| A9 | 0.00000E+00 | 0.00000E+00 | 0.00000E+00 | 0.00000E+00 |
| A10 | −7.65335E−04 | 3.07177E−02 | 4.00243E−02 | −7.82033E−02 |
| A11 | 0.00000E+00 | 0.00000E+00 | 0.00000E+00 | 0.00000E+00 |
| A12 | −1.49912E−03 | −1.51211E−02 | −3.58286E−02 | 2.17011E−02 |
| A13 | 0.00000E+00 | 0.00000E+00 | 0.00000E+00 | 0.00000E+00 |
| A14 | 1.37839E−04 | 5.05003E−03 | 1.44080E−02 | −6.39347E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 21
Example 7

| | Si | | | |
|---|---|---|---|---|
| | 10 | 11 | 12 | 13 |
| C | −0.08015 | −0.09704 | −0.14803 | −0.44169 |
| K | −9.33322 | −9.80322 | 10.00000 | −3.28274 |
| A3 | −2.41266E−02 | −1.45528E−02 | −1.09663E−02 | 5.26194E−03 |
| A4 | 9.70739E−03 | 7.43660E−03 | 8.79682E−02 | 2.50895E−02 |
| A5 | −1.98282E−01 | −8.04180E−02 | −7.54831E−02 | 1.36427E−03 |
| A6 | 6.76577E−02 | −3.56914E−03 | 4.99605E−03 | −8.23065E−03 |
| A7 | 3.15271E−02 | 2.68430E−02 | 3.34977E−03 | 3.96379E−03 |
| A8 | 2.94948E−03 | 3.77848E−03 | 2.59547E−03 | 1.99276E−03 |
| A9 | 7.16090E−03 | −6.43556E−04 | −5.98150E−04 | −7.86431E−04 |
| A10 | 1.82131E−04 | −2.82764E−03 | 2.89136E−04 | −4.57276E−04 |
| A11 | −5.02751E−03 | −3.31673E−04 | 4.40359E−04 | −3.24583E−05 |
| A12 | −8.17360E−03 | −4.29082E−04 | −3.49997E−04 | 1.40543E−05 |
| A13 | −2.25172E−03 | −1.27523E−04 | 1.04126E−04 | 3.86974E−05 |
| A14 | 1.75237E−03 | 2.76560E−04 | −1.05002E−04 | 7.44707E−06 |
| A15 | 1.61836E−03 | 1.67673E−04 | 4.15654E−05 | −3.99198E−06 |
| A16 | 1.50632E−03 | 8.99442E−05 | 1.56761E−05 | −5.84054E−07 |
| A17 | 7.36242E−04 | 2.38657E−05 | −2.36197E−06 | −1.61313E−07 |
| A18 | 3.03821E−05 | −5.73617E−06 | −5.50205E−06 | −4.11576E−08 |
| A19 | −4.48544E−04 | −7.04668E−06 | −4.98797E−07 | 1.18626E−08 |
| A20 | −4.86151E−04 | −2.20647E−05 | 8.33219E−07 | 9.97531E−09 |

| | 14 | 15 |
|---|---|---|
| C | −0.03654 | 0.53213 |
| K | 0.07699 | −5.40490 |
| A3 | 1.80549E−02 | −5.08470E−03 |
| A4 | −1.67100E−01 | −1.01901E−01 |
| A5 | 7.07477E−02 | 6.30676E−02 |
| A6 | 1.12365E−02 | −2.28400E−03 |
| A7 | −2.14880E−03 | −9.43935E−03 |
| A8 | −2.98786E−03 | 2.47053E−03 |
| A9 | 9.42698E−05 | −1.27490E−06 |
| A10 | 2.26763E−04 | 1.21889E−05 |
| A11 | 6.24130E−06 | 3.04394E−06 |
| A12 | −1.17684E−05 | −1.36866E−05 |
| A13 | 4.90215E−07 | −1.17626E−07 |
| A14 | 4.88938E−07 | 1.07797E−06 |
| A15 | −4.42965E−08 | −1.33230E−08 |
| A16 | −6.15159E−09 | −1.92852E−08 |
| A17 | −3.71798E−09 | 4.02020E−10 |
| A18 | −1.27004E−09 | 1.61928E−10 |
| A19 | −1.00804E−10 | −8.04939E−11 |
| A20 | 1.49267E−10 | −2.40200E−11 |

Various aberrations in Numerical example 7 above are illustrated in FIG. 14. As can be appreciated from the respective aberration diagrams, it is clear that the various aberrations are favorably corrected while the lens is small-sized, and excellent optical performance is achieved.

### Numerical Example 8

Table 22 shows basic lens data of Numerical Example 8 in which specific numerical values are applied to the imaging lens 8 illustrated in FIG. 15.

In the imaging lens 8 according to Numerical Example 8, both surfaces of each of the first lens L1 to the seventh lens L7 have aspherical shapes. Table 23 and Table 24 show values of coefficients representing these aspherical shapes.

In the imaging lens 8 according to Numerical Example 8, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has negative refractive power near the optical axis. The sixth lens L6 has positive refractive power near the optical axis. The seventh lens L7 has negative refractive power near the optical axis.

TABLE 22
Example 8

| Si | Li | Ri | Di | Ndi | νdi |
|---|---|---|---|---|---|
| 1 | OBJ | ∞ | ∞ | | |
| 2 | L1R1 ASP | 3.1593 | 0.4425 | 1.5432 | 56.02 |
| 3 | L1R2 ASP | 3.2388 | 0.1258 | | |
| 4 | L2R1 ASP | 1.8567 | 0.6171 | 1.5432 | 56.02 |
| 5 | L2R2 ASP | 14.5216 | 0.0782 | | |
| 6 | L3R1 ASP | −35.8510 | 0.2600 | 1.6607 | 20.36 |
| 7 | L3R2 ASP | 9.1313 | 0.4785 | | |
| 8 | L4R1 ASP | −9.2413 | 0.2600 | 1.5432 | 56.02 |
| 9 | L4R2 ASP | −9.8644 | 0.0781 | | |
| 10 | L5R1 ASP | −16.0925 | 0.4294 | 1.6607 | 20.36 |
| 11 | L5R2 ASP | 220.7580 | 0.4539 | | |
| 12 | L6R1 ASP | 9.5550 | 0.6991 | 1.5432 | 56.02 |
| 13 | L6R2 ASP | −2.4874 | 0.6751 | | |
| 14 | L7R1 ASP | 12.6384 | 0.3400 | 1.5341 | 55.63 |
| 15 | L7R2 ASP | 1.4105 | 0.2324 | | |
| 16 | SGR1 | ∞ | 0.1100 | 1.5140 | 51.40 |
| 17 | SGR2 | ∞ | 0.5747 | | |

TABLE 23
Example 8

| | Si | | | |
|---|---|---|---|---|
| | 2 | 3 | 4 | 5 |
| C | 0.31652 | 0.30876 | 0.53858 | 0.06886 |
| K | 0.88829 | −9.44705 | −4.41067 | −9.41149 |
| A3 | 0.00000E+00 | 0.00000E+00 | 0.00000E+00 | 0.00000E+00 |
| A4 | −3.01360E−02 | −7.11942E−02 | 1.50511E−02 | −7.94006E−03 |
| A5 | 0.00000E+00 | 0.00000E+00 | 0.00000E+00 | 0.00000E+00 |
| A6 | −1.69763E−03 | 2.60547E−02 | −3.41973E−03 | −3.80863E−02 |
| A7 | 0.00000E+00 | 0.00000E+00 | 0.00000E+00 | 0.00000E+00 |
| A8 | −3.12343E−03 | −4.95405E−03 | 1.37468E−02 | 3.40655E−02 |
| A9 | 0.00000E+00 | 0.00000E+00 | 0.00000E+00 | 0.00000E+00 |
| A10 | 2.15498E−03 | 1.30666E−03 | −6.10290E−03 | −6.52513E−03 |
| A11 | 0.00000E+00 | 0.00000E+00 | 0.00000E+00 | 0.00000E+00 |
| A12 | −4.03136E−04 | −3.52159E−04 | 1.71998E−03 | −1.00282E−04 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | −0.02789 | 0.10951 | −0.10821 | −0.10137 |
| K | −7.51379 | −10.00000 | 10.00000 | 8.41151 |
| A3 | 0.00000E+00 | 0.00000E+00 | 0.00000E+00 | 0.00000E+00 |
| A4 | 4.38132E−03 | 1.73059E−02 | −5.08354E−02 | −3.98588E−02 |
| A5 | 0.00000E+00 | 0.00000E+00 | 0.00000E+00 | 0.00000E+00 |
| A6 | −1.16648E−02 | 7.46705E−03 | −2.83474E−02 | −1.22620E−01 |
| A7 | 0.00000E+00 | 0.00000E+00 | 0.00000E+00 | 0.00000E+00 |
| A8 | 1.94062E−02 | −1.25052E−02 | −1.43315E−02 | 1.19837E−01 |
| A9 | 0.00000E+00 | 0.00000E+00 | 0.00000E+00 | 0.00000E+00 |
| A10 | −7.31610E−03 | 1.22966E−02 | 4.00731E−02 | −7.20370E−02 |
| A11 | 0.00000E+00 | 0.00000E+00 | 0.00000E+00 | 0.00000E+00 |
| A12 | 1.15832E−04 | −1.46575E−02 | −3.60389E−02 | 2.30782E−02 |
| A13 | 0.00000E+00 | 0.00000E+00 | 0.00000E+00 | 0.00000E+00 |
| A14 | 1.39090E−04 | 5.02008E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 24
Example 8

| | Si | | | |
|---|---|---|---|---|
| | 10 | 11 | 12 | 13 |
| C | −0.06214 | 0.00453 | 0.10466 | −0.40203 |
| K | −9.33322 | −9.80322 | 10.00000 | −3.28274 |
| A3 | −1.88071E−02 | −1.25236E−02 | −9.84907E−03 | −3.45420E−03 |
| A4 | 6.13731E−03 | −2.92738E−02 | 4.76734E−02 | 5.51757E−02 |
| A5 | −1.74171E−01 | −7.00619E−02 | −6.66739E−02 | −2.68810E−02 |
| A6 | 6.50469E−02 | 1.69394E−02 | 1.31591E−02 | −1.30232E−02 |
| A7 | 1.64481E−02 | 2.75920E−02 | 3.96977E−03 | 5.41795E−03 |
| A8 | −7.45127E−03 | −3.07328E−03 | 1.14423E−03 | 3.00255E−03 |
| A9 | 3.21667E−03 | −4.77334E−03 | −1.67906E−03 | −4.80460E−04 |
| A10 | 3.18443E−04 | −3.58474E−03 | −8.23934E−05 | −3.98991E−04 |
| A11 | −3.51918E−03 | 4.22520E−05 | 3.93265E−04 | −3.29003E−05 |
| A12 | −6.75194E−03 | 3.31725E−04 | −3.24606E−04 | 8.18098E−06 |
| A13 | −2.01794E−03 | 3.33399E−04 | 1.31436E−04 | 3.58372E−05 |
| A14 | 1.49572E−03 | 4.10243E−04 | −8.86113E−05 | 5.85155E−06 |
| A15 | 1.33716E−03 | 1.32352E−04 | 4.75346E−05 | −4.57884E−06 |
| A16 | 1.29133E−03 | −4.25025E−05 | 1.72399E−05 | −8.14668E−07 |
| A17 | 7.09422E−04 | −7.73290E−05 | −2.22477E−06 | −2.17519E−07 |
| A18 | 1.63623E−04 | −4.79626E−05 | −5.74136E−06 | −4.92144E−08 |
| A19 | −2.76610E−04 | 3.00044E−06 | −6.92126E−07 | 1.85613E−08 |
| A20 | −5.64472E−04 | 2.45629E−05 | 7.25592E−07 | 2.16599E−08 |

| | 14 | 15 |
|---|---|---|
| C | 0.07912 | 0.70897 |
| K | 0.07699 | −5.40490 |
| A3 | −4.85488E−02 | −3.25106E−02 |
| A4 | −1.86338E−01 | −9.77192E−02 |
| A5 | 7.52174E−02 | 6.48209E−02 |
| A6 | 1.32484E−02 | −1.64417E−03 |
| A7 | −1.75239E−03 | −9.63981E−03 |
| A8 | −2.94894E−03 | 2.42312E−03 |
| A9 | 8.71465E−05 | 4.02498E−06 |
| A10 | 2.19999E−04 | 1.34269E−05 |
| A11 | 3.66167E−06 | 3.99956E−06 |
| A12 | −1.25514E−05 | −1.37050E−05 |
| A13 | 2.94867E−07 | −1.62729E−07 |
| A14 | 4.53567E−07 | 1.05898E−06 |
| A15 | −4.62597E−08 | −1.62949E−08 |
| A16 | −3.84527E−09 | −1.92630E−08 |
| A17 | −2.35905E−09 | 6.28064E−10 |
| A18 | −7.44465E−10 | 2.57270E−10 |
| A19 | 2.23786E−11 | −6.48109E−11 |
| A20 | 1.40489E−10 | −2.90792E−11 |

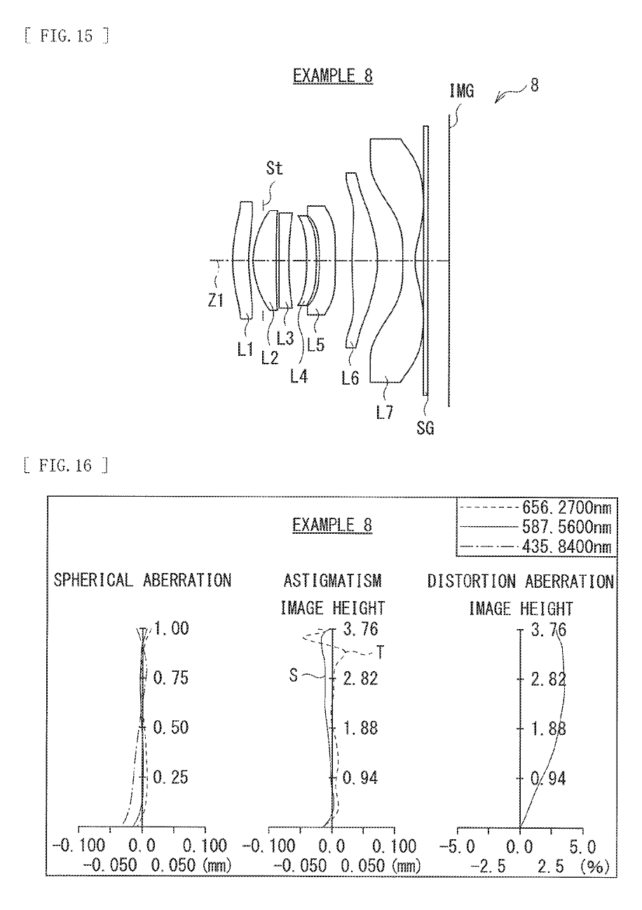

Various aberrations in Numerical example 8 above are illustrated in FIG. 16. As can be appreciated from the respective aberration diagrams, it is clear that the various aberrations are favorably corrected while the lens is small-sized, and excellent optical performance is achieved.

### Numerical Example 9

Table 25 shows basic lens data of Numerical Example 9 in which specific numerical values are applied to the imaging lens 9 illustrated in FIG. 17.

In the imaging lens 9 according to Numerical Example 9, both surfaces of each of the first lens L1 to the seventh lens L7 have aspherical shapes. Table 26 and Table 27 show values of coefficients representing these aspherical shapes.

In the imaging lens 9 according to Numerical Example 9, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 25
Example 9

| Si | Li | Ri | Di | Ndi | νdi |
|---|---|---|---|---|---|
| 1 | OBJ | ∞ | ∞ | | |
| 2 | L1R1 ASP | 3.1137 | 0.2800 | 1.5432 | 56.02 |
| 3 | L1R2 ASP | 3.2472 | 0.1302 | | |
| 4 | L2R1 ASP | 1.8614 | 0.7144 | 1.5432 | 56.02 |
| 5 | L2R2 ASP | 18.0844 | 0.0010 | | |
| 6 | L3R1 ASP | 3.4043 | 0.2800 | 1.6605 | 20.37 |
| 7 | L3R2 ASP | 2.0163 | 0.5044 | | |
| 8 | L4R1 ASP | −28.1087 | 0.2800 | 1.5432 | 56.02 |
| 9 | L4R2 ASP | −11.1406 | 0.1357 | | |
| 10 | L5R1 ASP | −16.5029 | 0.5436 | 1.6350 | 23.89 |
| 11 | L5R2 ASP | −160.4460 | 0.3717 | | |
| 12 | L6R1 ASP | 328.6390 | 0.7010 | 1.5432 | 56.02 |
| 13 | L6R2 ASP | −2.0972 | 0.3333 | | |
| 14 | L7R1 ASP | −14.5242 | 0.6602 | 1.5341 | 55.63 |
| 15 | L7R2 ASP | 1.6775 | 0.2318 | | |
| 16 | SGR1 | ∞ | 0.1100 | 1.5140 | 51.40 |
| 17 | SGR2 | ∞ | 0.5775 | | |

TABLE 26
Example 9

| | Si | | | |
|---|---|---|---|---|
| | 2 | 3 | 4 | 5 |
| C | 0.32116 | 0.30795 | 0.53724 | 0.05530 |
| K | 1.39312 | −6.38089 | −4.50094 | −18.75740 |
| A3 | 0.00000E+00 | 0.00000E+00 | 0.00000E+00 | 0.00000E+00 |
| A4 | −4.86763E−02 | −7.21635E−02 | 5.03453E−02 | 2.91489E−02 |
| A5 | 0.00000E+00 | 0.00000E+00 | 0.00000E+00 | 0.00000E+00 |
| A6 | −3.30324E−04 | 2.34273E−02 | −9.77534E−03 | −5.73531E−02 |
| A7 | 0.00000E+00 | 0.00000E+00 | 0.00000E+00 | 0.00000E+00 |
| A8 | −1.13808E−03 | −4.33503E−03 | 8.83092E−03 | 4.02763E−02 |
| A9 | 0.00000E+00 | 0.00000E+00 | 0.00000E+00 | 0.00000E+00 |
| A10 | 1.46980E−03 | 1.18811E−03 | −3.55544E−03 | −1.34789E−02 |
| A11 | 0.00000E+00 | 0.00000E+00 | 0.00000E+00 | 0.00000E+00 |
| A12 | −2.58736E−04 | −1.10347E−04 | 5.40638E−04 | 1.80505E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.29374 | 0.49595 | −0.03558 | −0.08976 |
| K | −8.98536 | −1.72806 | 10.00000 | 8.41151 |
| A3 | 0.00000E+00 | 0.00000E+00 | 0.00000E+00 | 0.00000E+00 |
| A4 | −9.21187E−03 | −2.70805E−02 | −1.94440E−02 | −1.25487E−02 |
| A5 | 0.00000E+00 | 0.00000E+00 | 0.00000E+00 | 0.00000E+00 |
| A6 | −1.30462E−02 | 5.07159E−02 | −2.52847E−02 | −1.15247E−01 |
| A7 | 0.00000E+00 | 0.00000E+00 | 0.00000E+00 | 0.00000E+00 |
| A8 | 2.38634E−02 | −2.61384E−02 | −7.30802E−03 | 1.11537E−01 |
| A9 | 0.00000E+00 | 0.00000E+00 | 0.00000E+00 | 0.00000E+00 |
| A10 | −5.91764E−03 | 2.70137E−02 | 3.54301E−02 | −7.01356E−02 |
| A11 | 0.00000E+00 | 0.00000E+00 | 0.00000E+00 | 0.00000E+00 |
| A12 | −2.23002E−04 | −1.46199E−02 | −3.60388E−02 | 2.30781E−02 |
| A13 | 0.00000E+00 | 0.00000E+00 | 0.00000E+00 | 0.00000E+00 |
| A14 | 1.24588E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 27
Example 9

| | Si | | | |
|---|---|---|---|---|
| | 10 | 11 | 12 | 13 |
| C | −0.06060 | −0.00623 | 0.00304 | −0.47682 |
| K | −9.33322 | −9.80322 | 10.00000 | −3.28274 |
| A3 | −1.85295E−02 | −1.69204E−02 | −1.19490E−02 | −2.96632E−03 |
| A4 | 3.50692E−02 | 2.69054E−02 | 7.33287E−02 | 2.82009E−02 |
| A5 | −1.68759E−01 | −8.55468E−02 | −7.31222E−02 | −1.25454E−02 |
| A6 | 5.65892E−02 | 1.34004E−04 | 7.14177E−03 | −9.90864E−03 |
| A7 | 9.31967E−03 | 2.40664E−02 | 2.99153E−03 | 4.89298E−03 |
| A8 | −1.03074E−02 | 2.08325E−04 | 1.63740E−03 | 2.52674E−03 |
| A9 | 4.63190E−03 | −9.44440E−04 | −1.19612E−03 | −6.01737E−04 |
| A10 | 3.31772E−03 | −2.04728E−03 | 1.27602E−04 | −4.22212E−04 |
| A11 | −3.08203E−04 | 3.55850E−04 | 4.38977E−04 | −2.54252E−05 |
| A12 | −4.43054E−03 | −7.49780E−06 | −3.19200E−04 | 1.19499E−05 |
| A13 | −5.29924E−04 | 1.87796E−06 | 1.25532E−04 | 3.75849E−05 |
| A14 | 2.13431E−03 | 2.39472E−04 | −9.32747E−05 | 6.29263E−06 |
| A15 | 1.13145E−03 | 7.60630E−05 | 4.47804E−05 | −4.27127E−06 |
| A16 | 5.76221E−04 | −1.13254E−05 | 1.61685E−05 | −7.47408E−07 |
| A17 | 1.15239E−04 | −3.79881E−05 | −2.44089E−06 | −2.96855E−07 |
| A18 | −3.85683E−04 | −2.61368E−05 | −5.80211E−06 | −6.14942E−08 |
| A19 | −3.34405E−04 | 1.95177E−06 | −6.57607E−07 | 1.75780E−08 |
| A20 | −6.50875E−05 | 4.71646E−06 | 7.73374E−07 | 2.25018E−08 |

| | 14 | 15 |
|---|---|---|
| C | −0.06885 | 0.59614 |
| K | 0.07699 | −5.40490 |
| A3 | 1.17144E−02 | −1.28300E−02 |
| A4 | −1.89048E−01 | −1.07184E−01 |
| A5 | 7.77965E−02 | 6.57324E−02 |
| A6 | 1.25390E−02 | −1.68054E−04 |
| A7 | −2.06926E−03 | −1.01604E−02 |
| A8 | −3.02595E−03 | 2.26649E−03 |
| A9 | 7.81190E−05 | 4.18290E−06 |
| A10 | 2.21518E−04 | 2.55821E−05 |
| A11 | 4.86481E−06 | 6.32132E−06 |
| A12 | −1.20646E−05 | −1.32922E−05 |
| A13 | 4.61372E−07 | −1.43364E−07 |
| A14 | 5.00069E−07 | 1.04691E−06 |
| A15 | −3.59261E−08 | −2.30481E−08 |
| A16 | −2.13049E−09 | −2.13412E−08 |
| A17 | −2.40420E−09 | 1.12287E−10 |
| A18 | −9.72834E−10 | 1.74249E−10 |
| A19 | −9.83997E−11 | −5.66017E−11 |
| A20 | 8.85321E−11 | −1.62386E−11 |

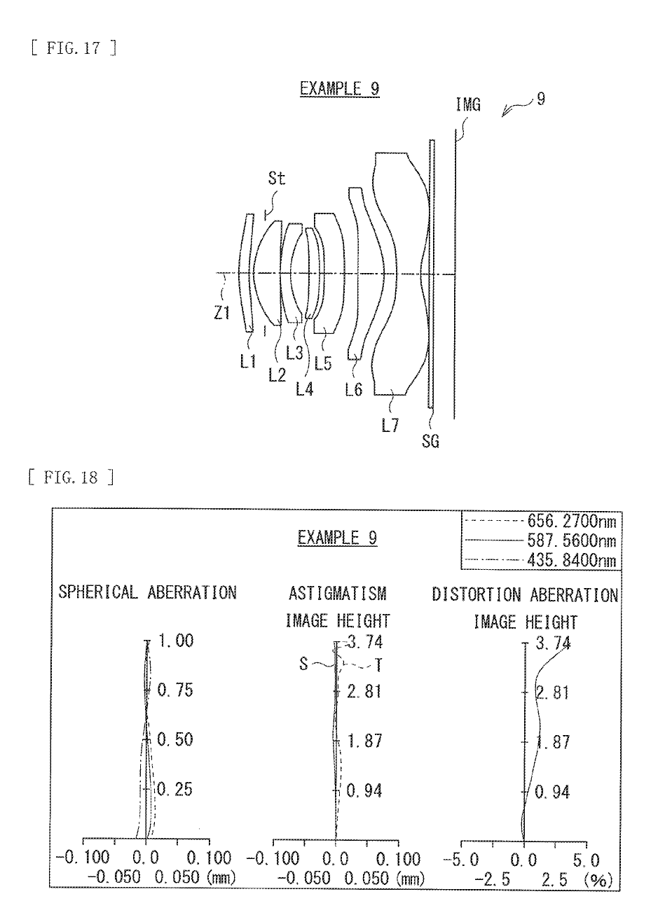

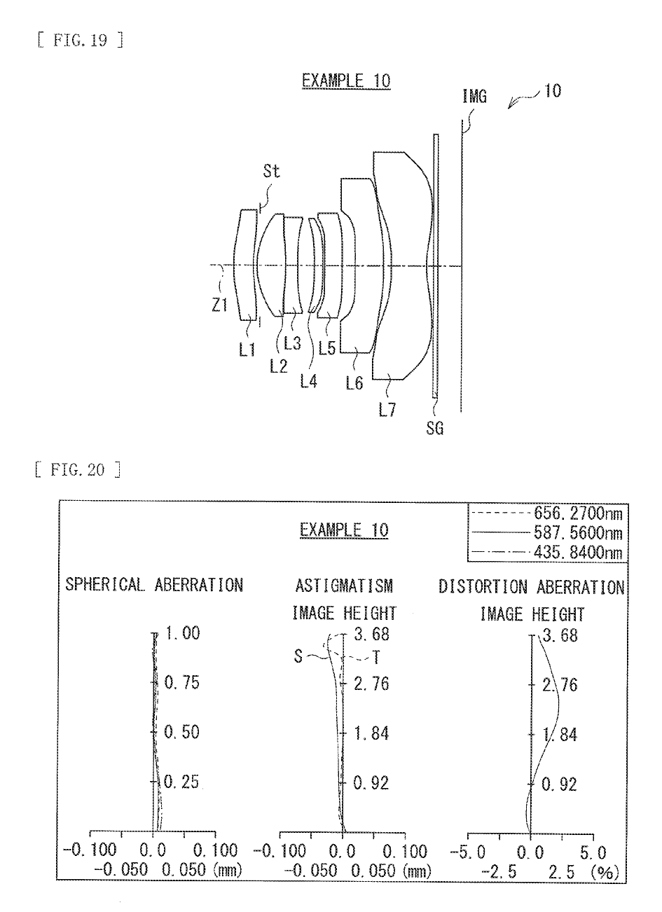

Various aberrations in Numerical example 9 above are illustrated in FIG. 18. As can be appreciated from the respective aberration diagrams, it is clear that the various aberrations are favorably corrected while the lens is small-sized, and excellent optical performance is achieved.

### Numerical Example 10

Table 28 shows basic lens data of Numerical Example 10 in which specific numerical values are applied to the imaging lens 10 illustrated in FIG. 19.

In the imaging lens 10 according to Numerical Example 10, both surfaces of each of the first lens L1 to the seventh lens L7 have aspherical shapes. Table 29 and Table 30 show values of coefficients representing these aspherical shapes.

In the imaging lens 10 according to Numerical Example 10, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has negative refractive power near the optical axis. The sixth lens L6 has positive refractive power near the optical axis. The seventh lens L7 has negative refractive power near the optical axis.

TABLE 28
Example 10

| Si | Li | Ri | Di | Ndi | νdi |
|---|---|---|---|---|---|
| 1 | OBJ | ∞ | ∞ | | |
| 2 | L1R1 ASP | 3.1104 | 0.5003 | 1.5432 | 56.02 |
| 3 | L1R2 ASP | 3.2704 | 0.0894 | | |
| 4 | L2R1 ASP | 1.8591 | 0.7381 | 1.5432 | 56.02 |
| 5 | L2R2 ASP | −4.7889 | 0.0010 | | |
| 6 | L3R1 ASP | −5.6637 | 0.3048 | 1.6353 | 23.83 |
| 7 | L3R2 ASP | 7.5029 | 0.4428 | | |
| 8 | L4R1 ASP | −11.7266 | 0.2200 | 1.5432 | 56.02 |
| 9 | L4R2 ASP | −20.7000 | 0.0431 | | |
| 10 | L5R1 ASP | 19.8182 | 0.4500 | 1.6607 | 20.36 |
| 11 | L5R2 ASP | 18.7442 | 0.3370 | | |
| 12 | L6R1 ASP | −1209.6700 | 0.7350 | 1.5432 | 56.02 |
| 13 | L6R2 ASP | −5.1921 | 0.1934 | | |
| 14 | L7R1 ASP | −10.8920 | 0.9000 | 1.5341 | 55.63 |
| 15 | L7R2 ASP | 2.2942 | 0.1812 | | |
| 16 | SGR1 | ∞ | 0.1100 | 1.5140 | 51.40 |
| 17 | SGR2 | ∞ | 0.6043 | | |

TABLE 29
Example 10

| | Si | | | |
|---|---|---|---|---|
| | 2 | 3 | 4 | 5 |
| C | 0.32150 | 0.30577 | 0.53791 | −0.20881 |
| K | 1.99147 | −9.97844 | −5.93873 | −20.00000 |
| A3 | 0.00000E+00 | 0.00000E+00 | 0.00000E+00 | 0.00000E+00 |
| A4 | −3.90895E−02 | −7.07246E−02 | 5.08472E−02 | 5.63290E−02 |
| A5 | 0.00000E+00 | 0.00000E+00 | 0.00000E+00 | 0.00000E+00 |
| A6 | −7.12606E−03 | 2.59742E−02 | −1.13609E−02 | −6.02270E−02 |
| A7 | 0.00000E+00 | 0.00000E+00 | 0.00000E+00 | 0.00000E+00 |
| A8 | −2.01923E−03 | −6.54867E−03 | 1.40356E−02 | 4.57806E−02 |
| A9 | 0.00000E+00 | 0.00000E+00 | 0.00000E+00 | 0.00000E+00 |
| A10 | 2.04905E−03 | 1.69919E−03 | −4.36004E−03 | −1.45575E−02 |
| A11 | 0.00000E+00 | 0.00000E+00 | 0.00000E+00 | 0.00000E+00 |
| A12 | −5.19512E−04 | −4.04039E−04 | 6.19361E−04 | 1.62750E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | −0.17656 | 0.13328 | −0.08528 | −0.04831 |
| K | −0.88429 | −0.44763 | 10.00000 | 8.41151 |
| A3 | 0.00000E+00 | 0.00000E+00 | 0.00000E+00 | 0.00000E+00 |
| A4 | 4.59235E−02 | −1.62710E−02 | −5.57473E−02 | −4.45981E−02 |
| A5 | 0.00000E+00 | 0.00000E+00 | 0.00000E+00 | 0.00000E+00 |
| A6 | −1.61339E−02 | 4.87713E−02 | −5.85189E−03 | −1.19716E−01 |
| A7 | 0.00000E+00 | 0.00000E+00 | 0.00000E+00 | 0.00000E+00 |
| A8 | 1.35094E−02 | −3.63826E−02 | −3.72487E−03 | 1.16457E−01 |
| A9 | 0.00000E+00 | 0.00000E+00 | 0.00000E+00 | 0.00000E+00 |
| A10 | −2.17196E−03 | 2.68727E−02 | 3.18006E−02 | −7.22733E−02 |
| A11 | 0.00000E+00 | 0.00000E+00 | 0.00000E+00 | 0.00000E+00 |
| A12 | −6.85217E−04 | −1.46477E−02 | −3.60388E−02 | 2.29582E−02 |
| A13 | 0.00000E+00 | 0.00000E+00 | 0.00000E+00 | 0.00000E+00 |
| A14 | 1.39094E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 30
Example 10

| | Si | | | |
|---|---|---|---|---|
| | 10 | 11 | 12 | 13 |
| C | 0.05046 | 0.05335 | −0.00083 | −0.19260 |
| K | −9.33322 | −9.80322 | 10.00000 | −3.28274 |
| A3 | −1.86467E−02 | −2.59077E−02 | −1.96627E−02 | −1.81502E−02 |
| A4 | 3.22213E−02 | 1.78482E−02 | 4.24845E−02 | 5.34688E−02 |
| A5 | −1.70557E−01 | −9.30303E−02 | −7.83425E−02 | −1.45678E−02 |
| A6 | 5.60673E−02 | 1.10491E−02 | −4.86868E−03 | −1.34664E−02 |
| A7 | 1.37934E−02 | 3.28973E−02 | 3.09255E−04 | 3.90395E−03 |
| A8 | −6.52646E−03 | 5.34892E−04 | 2.46179E−03 | 2.63105E−03 |
| A9 | 4.04569E−03 | −4.49982E−03 | −6.82468E−04 | −4.58628E−04 |
| A10 | −3.05749E−04 | −4.46082E−03 | −5.82880E−05 | −3.57995E−04 |
| A11 | −4.70751E−03 | −5.65948E−04 | 7.25872E−05 | −1.30123E−05 |
| A12 | −7.47985E−03 | 9.59386E−05 | −6.47701E−04 | 1.34250E−05 |
| A13 | −1.85722E−03 | 4.49755E−04 | −8.74261E−05 | 3.59646E−05 |
| A14 | 2.36555E−03 | 6.47292E−04 | −2.05112E−04 | 4.95415E−06 |
| A15 | 2.55419E−03 | 3.38016E−04 | −5.63558E−06 | −5.27156E−06 |
| A16 | 2.41433E−03 | 1.17498E−04 | −7.17558E−06 | −1.14096E−06 |
| A17 | 1.59853E−03 | −1.29966E−05 | −4.85148E−06 | −3.46035E−07 |
| A18 | 4.93032E−04 | −3.65003E−05 | 2.67763E−06 | −7.27155E−08 |
| A19 | −5.53143E−04 | −1.92244E−05 | 1.00205E−05 | 2.75273E−08 |
| A20 | −1.43828E−03 | −1.24771E−05 | 8.94196E−06 | 3.75501E−08 |

| | 14 | 15 |
|---|---|---|
| C | −0.09181 | 0.43589 |
| K | 0.07699 | −5.40490 |
| A3 | 5.79304E−03 | −1.24529E−02 |
| A4 | −1.69169E−01 | −1.10782E−01 |
| A5 | 8.10583E−02 | 6.83008E−02 |
| A6 | 1.22190E−02 | −1.18473E−03 |
| A7 | −2.40662E−03 | −1.03384E−02 |
| A8 | −3.16488E−03 | 2.30029E−03 |
| A9 | 2.85083E−05 | 2.41008E−05 |
| A10 | 2.06144E−04 | 2.92445E−05 |
| A11 | 4.05276E−07 | 6.38336E−06 |
| A12 | −1.32878E−05 | −1.35826E−05 |
| A13 | 1.25206E−07 | −2.83781E−07 |
| A14 | 4.13373E−07 | 1.00046E−06 |
| A15 | −5.30644E−08 | −3.44501E−08 |
| A16 | −1.74737E−09 | −2.33426E−08 |
| A17 | 2.10935E−09 | 4.58701E−11 |
| A18 | 3.14636E−09 | 3.76073E−10 |
| A19 | 2.85800E−09 | 8.41766E−11 |
| A20 | 2.03214E−09 | 5.08641E−11 |

Various aberrations in Numerical example 10 above are illustrated in FIG. 20. As can be appreciated from the respective aberration diagrams, it is clear that the various aberrations are favorably corrected while the lens is small-sized, and excellent optical performance is achieved.

### Numerical Example 11

Table 31 shows basic lens data of Numerical Example 11 in which specific numerical values are applied to the imaging lens 11 illustrated in FIG. 21.

In the imaging lens 11 according to Numerical Example 11, both surfaces of each of the first lens L1 to the seventh lens L7 have aspherical shapes. Table 32 and Table 33 show values of coefficients representing these aspherical shapes.

In the imaging lens 11 according to Numerical Example 11, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 31
Example 11

| Si | Li | Ri | Di | Ndi | νdi |
|---|---|---|---|---|---|
| 1 | OBJ | ∞ | ∞ | | |
| 2 | L1R1 ASP | 3.2040 | 0.3320 | 1.5432 | 56.02 |
| 3 | L1R2 ASP | 3.5294 | 0.0891 | | |
| 4 | L2R1 ASP | 2.0020 | 0.5555 | 1.5432 | 56.02 |
| 5 | L2R2 ASP | 6.0866 | 0.0010 | | |
| 6 | L3R1 ASP | 2.9885 | 0.2787 | 1.6607 | 20.36 |
| 7 | L3R2 ASP | 2.1253 | 0.4622 | | |
| 8 | L4R1 ASP | 8.8737 | 0.3923 | 1.5432 | 56.02 |
| 9 | L4R2 ASP | 26.0495 | 0.1860 | | |
| 10 | L5R1 ASP | 7.1889 | 0.4500 | 1.6607 | 20.36 |
| 11 | L5R2 ASP | 5.0891 | 0.2869 | | |
| 12 | L6R1 ASP | 36.4631 | 0.7701 | 1.5432 | 56.02 |
| 13 | L6R2 ASP | −2.1239 | 0.3271 | | |
| 14 | L7R1 ASP | 4.3603 | 0.5890 | 1.5341 | 55.63 |
| 15 | L7R2 ASP | 1.3200 | 0.3217 | | |
| 16 | SGR1 | ∞ | 0.1100 | 1.5140 | 51.40 |
| 17 | SGR2 | ∞ | 0.5775 | | |

TABLE 32
Example 11

| | Si | | | |
|---|---|---|---|---|
| | 2 | 3 | 4 | 5 |
| C | 0.31211 | 0.28333 | 0.49950 | 0.16430 |
| K | 1.83411 | −9.75472 | −5.45203 | −19.90891 |
| A3 | 0.00000E+00 | 0.00000E+00 | 0.00000E+00 | 0.00000E+00 |
| A4 | −4.10732E−02 | −7.27086E−02 | 4.20539E−02 | 2.33397E−02 |
| A5 | 0.00000E+00 | 0.00000E+00 | 0.00000E+00 | 0.00000E+00 |
| A6 | −3.04162E−03 | 2.73658E−02 | −1.10098E−02 | −6.16749E−02 |
| A7 | 0.00000E+00 | 0.00000E+00 | 0.00000E+00 | 0.00000E+00 |
| A8 | −1.05728E−03 | −4.83958E−03 | 1.06868E−02 | 4.07642E−02 |
| A9 | 0.00000E+00 | 0.00000E+00 | 0.00000E+00 | 0.00000E+00 |
| A10 | 1.48807E−03 | 5.68239E−04 | −3.57591E−03 | −1.15213E−02 |
| A11 | 0.00000E+00 | 0.00000E+00 | 0.00000E+00 | 0.00000E+00 |
| A12 | −3.69067E−04 | −1.04590E−04 | −2.63803E−04 | 9.37522E−04 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.33461 | 0.47053 | 0.11269 | 0.03839 |
| K | −8.40432 | −1.89705 | 10.00000 | 8.41151 |
| A3 | 0.00000E+00 | 0.00000E+00 | 0.00000E+00 | 0.00000E+00 |
| A4 | −1.53003E−02 | −2.71660E−02 | −2.26343E−02 | −3.98314E−03 |
| A5 | 0.00000E+00 | 0.00000E+00 | 0.00000E+00 | 0.00000E+00 |
| A6 | −1.84039E−02 | 3.82465E−02 | −1.89785E−02 | −1.04042E−01 |
| A7 | 0.00000E+00 | 0.00000E+00 | 0.00000E+00 | 0.00000E+00 |
| A8 | 2.38599E−02 | −2.27594E−02 | −1.08543E−02 | 1.14713E−01 |
| A9 | 0.00000E+00 | 0.00000E+00 | 0.00000E+00 | 0.00000E+00 |
| A10 | −4.19544E−03 | 2.40364E−02 | 3.03121E−02 | −7.93564E−02 |
| A11 | 0.00000E+00 | 0.00000E+00 | 0.00000E+00 | 0.00000E+00 |
| A12 | −1.24110E−04 | −1.46476E−02 | −3.60388E−02 | 2.30369E−02 |
| A13 | 0.00000E+00 | 0.00000E+00 | 0.00000E+00 | 0.00000E+00 |
| A14 | 1.39084E−04 | 5.04826E−03 | 1.44113E−02 | −6.42667E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 33
Example 11

| | Si | | | |
|---|---|---|---|---|
| | 10 | 11 | 12 | 13 |
| C | 0.13910 | 0.19650 | 0.02742 | −0.47084 |
| K | −9.33322 | −9.80322 | 10.00000 | −3.28274 |
| A3 | −2.60876E−02 | −3.66734E−02 | −4.14281E−02 | −5.28484E−02 |
| A4 | 6.51487E−02 | 7.28648E−02 | 1.04675E−01 | 4.23626E−02 |
| A5 | −1.72240E−01 | −9.74805E−02 | −6.87783E−02 | −3.53251E−03 |
| A6 | 5.63551E−02 | −9.55929E−03 | 2.07063E−03 | −9.42760E−03 |
| A7 | 1.47137E−02 | +2.61470E−02 | 1.08177E−03 | 4.25348E−03 |
| A8 | −5.36823E−03 | 2.91214E−03 | 1.59032E−03 | 2.22195E−03 |
| A9 | 6.12027E−03 | −5.75054E−04 | −9.30020E−04 | −6.89190E−04 |
| A10 | 2.63360E−03 | −2.20692E−03 | 2.81248E−04 | −4.28084E−04 |
| A11 | −1.84320E−03 | 6.32991E−05 | 4.88017E−04 | −2.48915E−05 |
| A12 | −5.57499E−03 | −1.35383E−04 | −3.17076E−04 | 1.45236E−05 |
| A13 | −1.33555E−03 | −5.61147E−05 | 1.22761E−04 | 3.85416E−05 |
| A14 | 1.64036E−03 | 2.22336E−04 | −9.68718E−05 | 6.73061E−06 |
| A15 | 9.71037E−04 | 7.95442E−05 | 4.30644E−05 | −4.40605E−06 |
| A16 | 5.97199E−04 | −1.97561E−07 | 1.55452E−05 | −7.84850E−07 |
| A17 | 1.10884E−04 | −2.96046E−05 | −2.62469E−06 | −2.19802E−07 |
| A18 | −2.04877E−04 | −1.99177E−05 | −5.79910E−06 | −5.61163E−08 |
| A19 | −2.58666E−04 | 2.20970E−06 | −6.13256E−07 | 2.05196E−08 |
| A20 | 7.37600E−05 | 3.13525E−06 | 8.21122E−07 | 2.44262E−08 |

| | 14 | 15 |
|---|---|---|
| C | 0.22934 | 0.75756 |
| K | 0.07699 | −5.40490 |
| A3 | −6.06086E−02 | 2.62341E−02 |
| A4 | −1.89178E−01 | −1.35607E−01 |
| A5 | 7.94618E−02 | 7.00884E−02 |
| A6 | 1.28906E−02 | 9.46161E−04 |
| A7 | −2.02447E−03 | −1.01596E−02 |
| A8 | −3.02041E−03 | 2.23446E−03 |
| A9 | 7.61575E−05 | −2.10503E−06 |
| A10 | 2.20734E−04 | 2.48186E−05 |
| A11 | 4.65686E−06 | 6.20248E−06 |
| A12 | −1.20972E−05 | −1.33320E−05 |
| A13 | 4.53250E−07 | −1.58484E−07 |
| A14 | 4.99236E−07 | 1.04146E−06 |
| A15 | −3.53065E−08 | −2.43526E−08 |
| A16 | −2.03441E−09 | −2.15370E−08 |
| A17 | −2.39410E−09 | 1.37674E−10 |
| A18 | −9.79496E−10 | 2.12350E−10 |
| A19 | −1.10037E−10 | −3.39753E−11 |
| A20 | 8.20385E−11 | −6.35288E−12 |

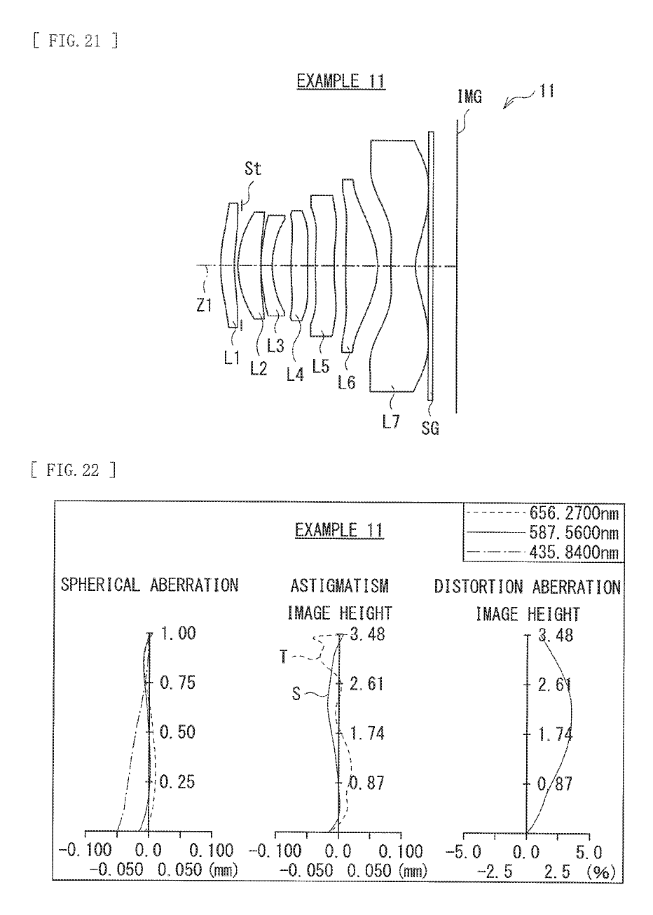

Various aberrations in Numerical example 11 above are illustrated in FIG. 22. As can be appreciated from the respective aberration diagrams, it is clear that the various aberrations are favorably corrected while the lens is small-sized, and excellent optical performance is achieved.

### Numerical Example 12

Table 34 shows basic lens data of Numerical Example 12 in which specific numerical values are applied to the imaging lens 12 illustrated in FIG. 23.

In the imaging lens 12 according to Numerical Example 12, both surfaces of each of the first lens L1 to the seventh lens L7 have aspherical shapes. Table 35 and Table 36 show values of coefficients representing these aspherical shapes.

In the imaging lens 12 according to Numerical Example 12, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has positive refractive power near the optical axis. The sixth lens L6 has positive refractive power near the optical axis. The seventh lens L7 has negative refractive power near the optical axis.

TABLE 34
Example 12

| Si | Li | Ri | Di | Ndi | νdi |
|---|---|---|---|---|---|
| 1 | OBJ | ∞ | ∞ | | |
| 2 | L1R1 ASP | 3.2926 | 0.4351 | 1.5432 | 56.02 |
| 3 | L1R2 ASP | 3.5558 | 0.1638 | | |
| 4 | L2R1 ASP | 1.9232 | 0.7628 | 1.5432 | 56.02 |
| 5 | L2R2 ASP | −5.2942 | 0.1241 | | |
| 6 | L3R1 ASP | −17.8103 | 0.2569 | 1.6349 | 23.89 |
| 7 | L3R2 ASP | 2.1041 | 0.3673 | | |
| 8 | L4R1 ASP | 5.1577 | 0.2690 | 1.5432 | 56.02 |
| 9 | L4R2 ASP | 6.6425 | 0.1742 | | |
| 10 | L5R1 ASP | 5.5634 | 0.3000 | 1.6370 | 23.54 |
| 11 | L5R2 ASP | 14.9015 | 0.4511 | | |
| 12 | L6R1 ASP | −6.8163 | 0.5505 | 1.5432 | 56.02 |
| 13 | L6R2 ASP | −2.1511 | 0.2063 | | |
| 14 | L7R1 ASP | 3.9370 | 0.6109 | 1.5341 | 55.63 |
| 15 | L7R2 ASP | 1.3625 | 0.3440 | | |
| 16 | SGR1 | ∞ | 0.1100 | 1.5140 | 51.40 |
| 17 | SGR2 | ∞ | 0.6927 | | |

TABLE 35
Example 12

| | Si | | | |
|---|---|---|---|---|
| | 2 | 3 | 4 | 5 |
| C | 0.30371 | 0.28123 | 0.51997 | −0.18889 |
| K | 1.82730 | −10.00000 | −5.54931 | −14.41940 |
| A3 | 0.00000E+00 | 0.00000E+00 | 0.00000E+00 | 0.00000E+00 |
| A4 | −3.79066E−02 | −6.56531E−02 | 3.55888E−02 | 3.62270E−02 |
| A5 | 0.00000E+00 | 0.00000E+00 | 0.00000E+00 | 0.00000E+00 |
| A6 | −2.66937E−03 | 2.52860E−02 | −1.49454E−02 | −6.39495E−02 |
| A7 | 0.00000E+00 | 0.00000E+00 | 0.00000E+00 | 0.00000E+00 |
| A8 | −1.51263E−03 | −5.73750E−03 | 1.01599E−02 | 4.20042E−02 |
| A9 | 0.00000E+00 | 0.00000E+00 | 0.00000E+00 | 0.00000E+00 |
| A10 | 1.26261E−03 | 9.61529E−04 | −3.06122E−03 | −1.38550E−02 |
| A11 | 0.00000E+00 | 0.00000E+00 | 0.00000E+00 | 0.00000E+00 |
| A12 | −3.80269E−04 | −2.41244E−04 | −3.83299E−04 | 1.54979E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | −0.05615 | 0.47527 | 0.19389 | 0.15055 |
| K | −10.00000 | −0.95520 | 10.00000 | 8.41151 |
| A3 | 0.00000E+00 | 0.00000E+00 | 0.00000E+00 | 0.00000E+00 |
| A4 | 1.33572E−02 | −2.09010E−02 | −3.86434E−02 | −2.17033E−03 |
| A5 | 0.00000E+00 | 0.00000E+00 | 0.00000E+00 | 0.00000E+00 |
| A6 | −1.73624E−02 | 4.44746E−02 | −1.35812E−02 | −1.01812E−01 |
| A7 | 0.00000E+00 | 0.00000E+00 | 0.00000E+00 | 0.00000E+00 |
| A8 | 1.77031E−02 | −2.21451E−02 | −1.78094E−02 | 1.11138E−01 |
| A9 | 0.00000E+00 | 0.00000E+00 | 0.00000E+00 | 0.00000E+00 |
| A10 | −3.08031E−03 | 2.27769E−02 | 3.42768E−02 | −7.84242E−02 |
| A11 | 0.00000E+00 | 0.00000E+00 | 0.00000E+00 | 0.00000E+00 |
| A12 | −4.84044E−04 | −1.46467E−02 | −3.60386E−02 | 2.28247E−02 |
| A13 | 0.00000E+00 | 0.00000E+00 | 0.00000E+00 | 0.00000E+00 |
| A14 | 1.37951E−04 | 5.04879E−03 | 1.44092E−02 | −6.42616E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 36
Example 12

| | Si | | | |
|---|---|---|---|---|
| | 10 | 11 | 12 | 13 |
| C | 0.17975 | 0.06711 | −0.14671 | −0.46487 |
| K | −9.33322 | −9.80322 | 10.00000 | −3.28274 |
| A3 | −1.16740E−02 | −3.29485E−02 | −4.24699E−02 | −5.75367E−02 |
| A4 | 7.25119E−02 | 6.46450E−02 | 1.11338E−01 | 6.59319E−02 |
| A5 | −1.71114E−01 | −1.06352E−01 | −6.77029E−02 | −5.65143E−03 |
| A6 | 5.46599E−02 | −1.07706E−02 | 9.29165E−04 | −1.16588E−02 |
| A7 | 1.33444E−02 | 2.69869E−02 | 4.76241E−04 | 3.56038E−03 |
| A8 | −5.93535E−03 | 3.42948E−03 | 1.59326E−03 | 2.10410E−03 |
| A9 | 6.06623E−03 | −5.26675E−04 | −8.24623E−04 | −6.87590E−04 |
| A10 | 2.63910E−03 | −2.27201E−03 | 3.64010E−04 | −4.16945E−04 |
| A11 | −1.89252E−03 | 2.11457E−05 | 5.26823E−04 | −1.76946E−05 |
| A12 | −5.68531E−03 | −1.42824E−04 | −3.03309E−04 | 1.79686E−05 |
| A13 | −1.43182E−03 | −4.74617E−05 | 1.27303E−04 | 3.99137E−05 |
| A14 | 1.58029E−03 | 2.36709E−04 | −9.59659E−05 | 7.16950E−06 |
| A15 | 9.56023E−04 | 8.93971E−05 | 4.31216E−05 | −4.32748E−06 |
| A16 | 6.13980E−04 | 4.77755E−06 | 1.54634E−05 | −7.75966E−07 |
| A17 | 1.43232E−04 | −3.02810E−05 | −2.71377E−06 | −1.91702E−07 |
| A18 | −1.85996E−04 | −2.12023E−05 | −5.84341E−06 | −3.19361E−08 |
| A19 | −2.50316E−04 | 1.32547E−06 | −6.39216E−07 | 1.64270E−08 |
| A20 | 7.24957E−05 | 2.12792E−06 | 8.22305E−07 | 2.30176E−08 |

| | 14 | 15 |
|---|---|---|
| C | 0.25400 | 0.73395 |
| K | 0.07699 | −5.40490 |
| A3 | −5.24216E−02 | 2.06452E−02 |
| A4 | −1.89120E−01 | −1.42835E−01 |
| A5 | 7.96517E−02 | 7.26850E−02 |
| A6 | 1.29830E−02 | 2.12831E−04 |
| A7 | −2.00411E−03 | −1.04050E−02 |
| A8 | −3.01564E−03 | 2.21204E−03 |
| A9 | 7.87746E−05 | 3.25335E−06 |
| A10 | 2.21853E−04 | 2.84444E−05 |
| A11 | 5.09330E−06 | 7.53624E−06 |
| A12 | −1.19675E−05 | −1.28925E−05 |
| A13 | 5.41051E−07 | −1.07409E−08 |
| A14 | 5.38866E−07 | 1.09448E−06 |
| A15 | −3.20070E−08 | −4.74486E−09 |
| A16 | −5.63269E−10 | −1.41016E−08 |
| A17 | −2.68226E−09 | 2.96553E−09 |
| A18 | −1.61049E−09 | 1.27604E−09 |
| A19 | −7.33160E−10 | 3.58215E−10 |
| A20 | −2.35002E−10 | 1.35225E−10 |

Various aberrations in Numerical example 12 above are illustrated in FIG. 24. As can be appreciated from the respective aberration diagrams, it is clear that the various aberrations are favorably corrected while the lens is small-sized, and excellent optical performance is achieved.

### Numerical Example 13

Table 37 shows basic lens data of Numerical Example 13 in which specific numerical values are applied to the imaging lens 13 illustrated in FIG. 25.

In the imaging lens 13 according to Numerical Example 13, both surfaces of each of the first lens L1 to the seventh lens L7 have aspherical shapes. Table 38 and Table 39 show values of coefficients representing these aspherical shapes.

In the imaging lens 13 according to Numerical Example 13, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 37
Example 13

| Si | Li | Ri | Di | Ndi | νdi |
|---|---|---|---|---|---|
| 1 | OBJ | ∞ | ∞ | | |
| 2 | L1R1 ASP | 3.2185 | 0.3133 | 1.5432 | 56.02 |
| 3 | L1R2 ASP | 3.5691 | 0.0898 | | |
| 4 | L2R1 ASP | 1.9417 | 0.5696 | 1.5432 | 56.02 |
| 5 | L2R2 ASP | 5.2222 | 0.0010 | | |
| 6 | L3R1 ASP | 2.6192 | 0.2884 | 1.6445 | 22.35 |
| 7 | L3R2 ASP | 2.0227 | 0.5073 | | |
| 8 | L4R1 ASP | 16.5776 | 0.3799 | 1.5432 | 56.02 |
| 9 | L4R2 ASP | −324.4500 | 0.1233 | | |
| 10 | L5R1 ASP | 8.7591 | 0.4217 | 1.6607 | 20.36 |
| 11 | L5R2 ASP | 5.4692 | 0.2971 | | |
| 12 | L6R1 ASP | 41.0690 | 0.7137 | 1.5432 | 56.02 |
| 13 | L6R2 ASP | −2.0371 | 0.2765 | | |
| 14 | L7R1 ASP | 4.2031 | 0.5991 | 1.5341 | 55.63 |
| 15 | L7R2 ASP | 1.3045 | 0.3150 | | |
| 16 | SGR1 | ∞ | 0.1100 | 1.5140 | 51.40 |
| 17 | SGR2 | ∞ | 0.5794 | | |

TABLE 38
Example 13

| | Si | | | |
|---|---|---|---|---|
| | 2 | 3 | 4 | 5 |
| C | 0.31070 | 0.28019 | 0.51500 | 0.19149 |
| K | 1.87802 | −10.00000 | −4.96710 | −20.00000 |
| A3 | 0.00000E+00 | 0.00000E+00 | 0.00000E+00 | 0.00000E+00 |
| A4 | −4.12862E−02 | −7.30490E−02 | 4.35381E−02 | 2.18983E−02 |
| A5 | 0.00000E+00 | 0.00000E+00 | 0.00000E+00 | 0.00000E+00 |
| A6 | −2.50822E−03 | 2.77857E−02 | −1.06601E−02 | −6.11401E−02 |
| A7 | 0.00000E+00 | 0.00000E+00 | 0.00000E+00 | 0.00000E+00 |
| A8 | −1.01417E−03 | −4.70340E−03 | 1.08218E−02 | 4.09423E−02 |
| A9 | 0.00000E+00 | 0.00000E+00 | 0.00000E+00 | 0.00000E+00 |
| A10 | 1.55594E−03 | 6.18835E−04 | −3.43760E−03 | −1.15417E−02 |
| A11 | 0.00000E+00 | 0.00000E+00 | 0.00000E+00 | 0.00000E+00 |
| A12 | −3.47632E−04 | −5.37232E−05 | −1.78129E−04 | 9.21098E−04 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.38179 | 0.49439 | 0.06032 | −0.00308 |
| K | −7.47797 | −1.82690 | 10.00000 | 8.41151 |
| A3 | 0.00000E+00 | 0.00000E+00 | 0.00000E+00 | 0.00000E+00 |
| A4 | −1.61758E−02 | −2.69500E−02 | −2.41497E−02 | −6.77761E−03 |
| A5 | 0.00000E+00 | 0.00000E+00 | 0.00000E+00 | 0.00000E+00 |
| A6 | −1.93424E−02 | 3.71956E−02 | −2.04750E−02 | −1.06814E−01 |
| A7 | 0.00000E+00 | 0.00000E+00 | 0.00000E+00 | 0.00000E+00 |
| A8 | 2.37230E−02 | −2.26621E−02 | −1.03091E−02 | 1.14702E−01 |
| A9 | 0.00000E+00 | 0.00000E+00 | 0.00000E+00 | 0.00000E+00 |
| A10 | −4.15928E−03 | 2.41818E−02 | 2.97899E−02 | −7.88329E−02 |
| A11 | 0.00000E+00 | 0.00000E+00 | 0.00000E+00 | 0.00000E+00 |
| A12 | −1.02325E−04 | −1.46476E−02 | −3.60388E−02 | 2.31251E−02 |
| A13 | 0.00000E+00 | 0.00000E+00 | 0.00000E+00 | 0.00000E+00 |
| A14 | 1.39087E−04 | 5.04826E−03 | 1.44113E−02 | −6.42667E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 39
Example 13

| | Si | | | |
|---|---|---|---|---|
| | 10 | 11 | 12 | 13 |
| C | 0.11417 | 0.18284 | 0.02435 | −0.49088 |
| K | −9.33322 | −9.80322 | 10.00000 | −3.28274 |
| A3 | −2.93214E−02 | −4.29690E−02 | −4.02937E−02 | −4.85141E−02 |
| A4 | 6.25332E−02 | 7.10146E−02 | 1.04982E−01 | 4.38907E−02 |
| A5 | −1.73124E−01 | −9.70205E−02 | −6.86616E−02 | −3.06269E−03 |
| A6 | 5.60158E−02 | −9.09262E−03 | 2.12519E−03 | −9.31272E−03 |
| A7 | 1.45626E−02 | 2.63191E−02 | 1.11451E−03 | 4.26682E−03 |
| A8 | −5.41668E−03 | 2.94854E−03 | 1.60759E−03 | 2.21794E−03 |
| A9 | 6.06734E−03 | −5.61123E−04 | −9.21628E−04 | −6.92670E−04 |
| A10 | 2.65668E−03 | −2.20359E−03 | 2.84753E−04 | −4.30046E−04 |
| A11 | −1.77050E−03 | 6.10205E−05 | 4.89437E−04 | −2.57188E−05 |
| A12 | −5.51076E−03 | −1.34144E−04 | −3.16528E−04 | 1.41027E−05 |
| A13 | −1.28224E−03 | −5.52281E−05 | 1.22975E−04 | 3.83813E−05 |
| A14 | 1.66707E−03 | 2.22421E−04 | −9.67987E−05 | 6.67336E−06 |
| A15 | 9.82921E−04 | 7.97053E−05 | 4.30911E−05 | −4.42423E−06 |
| A16 | 5.98856E−04 | 8.92385E−09 | 1.55511E−05 | −7.98745E−07 |
| A17 | 1.07801E−04 | −2.95125E−05 | −2.62820E−06 | −2.34038E−07 |
| A18 | −2.10192E−04 | −1.98324E−05 | −5.80388E−06 | −7.10841E−08 |
| A19 | −2.66598E−04 | 2.26034E−06 | −6.17113E−07 | 2.03782E−08 |
| A20 | 6.47989E−05 | 3.16812E−06 | 8.18882E−07 | 2.44091E−08 |

| | 14 | 15 |
|---|---|---|
| C | 0.23792 | 0.76659 |
| K | 0.07699 | −5.40490 |
| A3 | −5.84264E−02 | 2.69509E−02 |
| A4 | −1.88268E−01 | −1.37058E−01 |
| A5 | 7.96696E−02 | 7.01558E−02 |
| A6 | 1.29338E−02 | 9.84045E−04 |
| A7 | −2.01440E−03 | −1.01681E−02 |
| A8 | −3.01893E−03 | 2.22771E−03 |
| A9 | 7.59854E−05 | −4.15007E−06 |
| A10 | 2.20457E−04 | 2.44853E−05 |
| A11 | 4.49462E−06 | 6.22608E−06 |
| A12 | −1.21806E−05 | −1.32845E−05 |
| A13 | 4.21224E−07 | −1.34103E−07 |
| A14 | 4.85165E−07 | 1.05046E−06 |
| A15 | −4.07446E−08 | −2.13188E−08 |
| A16 | −3.92395E−09 | −2.06836E−08 |
| A17 | −2.98304E−09 | 3.37260E−10 |
| A18 | −1.12689E−09 | 2.50901E−10 |
| A19 | −1.24911E−10 | −3.23683E−11 |
| A20 | 1.00403E−10 | −9.89520E−12 |

Various aberrations in Numerical example 13 above are illustrated in FIG. 26. As can be appreciated from the respective aberration diagrams, it is clear that the various aberrations are favorably corrected while the lens is small-sized, and excellent optical performance is achieved.

### Numerical Example 14

Table 40 shows basic lens data of Numerical Example 14 in which specific numerical values are applied to the imaging lens 14 illustrated in FIG. 27.

In the imaging lens 14 according to Numerical Example 14, both surfaces of each of the first lens L1 to the seventh lens L7 have aspherical shapes. Table 41 and Table 42 show values of coefficients representing these aspherical shapes.

In the imaging lens 14 according to Numerical Example 14, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has negative refractive power near the optical axis. The sixth lens L6 has positive refractive power near the optical axis. The seventh lens L7 has negative refractive power near the optical axis.

TABLE 40
Example 14

| Si | Li | Ri | Di | Ndi | νdi |
|---|---|---|---|---|---|
| 1 | OBJ | ∞ | ∞ | | |
| 2 | L1R1 ASP | 3.3001 | 0.4307 | 1.5432 | 56.02 |
| 3 | L1R2 ASP | 3.5432 | 0.1221 | | |
| 4 | L2R1 ASP | 1.9788 | 0.6492 | 1.5432 | 56.02 |
| 5 | L2R2 ASP | −86.9003 | 0.0402 | | |
| 6 | L3R1 ASP | 7.3255 | 0.2003 | 1.6592 | 20.51 |
| 7 | L3R2 ASP | 2.7917 | 0.5407 | | |
| 8 | L4R1 ASP | 527.2880 | 0.2763 | 1.5432 | 56.02 |
| 9 | L4R2 ASP | 102.4260 | 0.1531 | | |
| 10 | L5R1 ASP | 7.2874 | 0.4124 | 1.6381 | 23.38 |
| 11 | L5R2 ASP | 6.7230 | 0.2878 | | |
| 12 | L6R1 ASP | −126.5150 | 0.7500 | 1.5432 | 56.02 |
| 13 | L6R2 ASP | −2.3754 | 0.2777 | | |
| 14 | L7R1 ASP | 4.3259 | 0.6804 | 1.5341 | 55.63 |
| 15 | L7R2 ASP | 1.3368 | 0.3447 | | |
| 16 | SGR1 | ∞ | 0.1100 | 1.5140 | 51.40 |
| 17 | SGR2 | ∞ | 0.5771 | | |

TABLE 41
Example 14

| | Si | | | |
|---|---|---|---|---|
| | 2 | 3 | 4 | 5 |
| C | 0.30302 | 0.28223 | 0.50536 | −0.01151 |
| K | 2.00024 | −9.98781 | −5.91977 | 10.00000 |
| A3 | 0.00000E+00 | 0.00000E+00 | 0.00000E+00 | 0.00000E+00 |
| A4 | −3.66690E−02 | −6.61453E−02 | 3.80565E−02 | 3.51315E−02 |
| A5 | 0.00000E+00 | 0.00000E+00 | 0.00000E+00 | 0.00000E+00 |
| A6 | −2.81554E−03 | 2.51583E−02 | −1.36734E−02 | −6.49347E−02 |
| A7 | 0.00000E+00 | 0.00000E+00 | 0.00000E+00 | 0.00000E+00 |
| A8 | −1.56701E−03 | −5.53958E−03 | 1.02637E−02 | 4.19695E−02 |
| A9 | 0.00000E+00 | 0.00000E+00 | 0.00000E+00 | 0.00000E+00 |
| A10 | 1.37247E−03 | 1.14572E−03 | −3.20164E−03 | −1.38747E−02 |
| A11 | 0.00000E+00 | 0.00000E+00 | 0.00000E+00 | 0.00000E+00 |
| A12 | −2.85937E−04 | −1.42879E−04 | −4.79909E−04 | 1.45062E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.13651 | 0.35821 | 0.00190 | 0.00976 |
| K | −2.69731 | −0.45217 | 10.00000 | 8.41151 |
| A3 | 0.00000E+00 | 0.00000E+00 | 0.00000E+00 | 0.00000E+00 |
| A4 | 4.42804E−03 | −1.55631E−02 | −3.99327E−02 | −1.60508E−02 |
| A5 | 0.00000E+00 | 0.00000E+00 | 0.00000E+00 | 0.00000E+00 |
| A6 | −1.60429E−02 | 3.37597E−02 | −1.38809E−02 | −1.03193E−01 |
| A7 | 0.00000E+00 | 0.00000E+00 | 0.00000E+00 | 0.00000E+00 |
| A8 | 1.80824E−02 | −2.30969E−02 | −1.83786E−02 | 1.12211E−01 |
| A9 | 0.00000E+00 | 0.00000E+00 | 0.00000E+00 | 0.00000E+00 |
| A10 | −2.68210E−03 | 2.39844E−02 | 3.40839E−02 | −7.76859E−02 |
| A11 | 0.00000E+00 | 0.00000E+00 | 0.00000E+00 | 0.00000E+00 |
| A12 | −1.28157E−04 | −1.46477E−02 | −3.60388E−02 | 2.30567E−02 |
| A13 | 0.00000E+00 | 0.00000E+00 | 0.00000E+00 | 0.00000E+00 |
| A14 | 1.39094E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 42
Example 14

| | Si | | | |
|---|---|---|---|---|
| | 10 | 11 | 12 | 13 |
| C | 0.13722 | 0.14874 | −0.00790 | −0.42098 |
| K | −9.33322 | −9.80322 | 10.00000 | −3.28274 |
| A3 | −2.00549E−02 | −2.53070E−02 | −3.28603E−02 | −6.76351E−02 |
| A4 | 7.01134E−02 | 6.96128E−02 | 1.08714E−01 | 6.35246E−02 |
| A5 | −1.73374E−01 | −1.03546E−01 | −7.10912E−02 | −4.83537E−03 |
| A6 | 5.42717E−02 | −1.09104E−02 | −3.23623E−04 | −1.12558E−02 |
| A7 | 1.35906E−02 | 2.62445E−02 | 1.25961E−04 | 3.65843E−03 |
| A8 | −5.71887E−03 | 2.92920E−03 | 1.50012E−03 | 2.11913E−03 |
| A9 | 6.14381E−03 | −7.60221E−04 | −8.45073E−04 | −6.86774E−04 |
| A10 | 2.63610E−03 | −2.36439E−03 | 3.53764E−04 | −4.17908E−04 |
| A11 | −1.91716E−03 | −1.00537E−05 | 5.20986E−04 | −1.82652E−05 |
| A12 | −5.71173E−03 | −1.48622E−04 | −3.05971E−04 | 1.75480E−05 |
| A13 | −1.44975E−03 | −4.58892E−05 | 1.25047E−04 | 3.97113E−05 |
| A14 | 1.55795E−03 | 2.37916E−04 | −9.67608E−05 | 7.09056E−06 |
| A15 | 9.40871E−04 | 9.09012E−05 | 4.26461E−05 | −4.30513E−06 |
| A16 | 6.00915E−04 | 5.99900E−06 | 1.52408E−05 | −7.73384E−07 |
| A17 | 1.35366E−04 | −2.76188E−05 | −2.77225E−06 | −2.30925E−07 |
| A18 | −1.89571E−04 | −1.99595E−05 | −5.85400E−06 | −6.40236E−08 |
| A19 | −2.53220E−04 | 1.77217E−06 | −6.27485E−07 | 1.11262E−08 |
| A20 | 6.94422E−05 | 2.41528E−06 | 8.21124E−07 | 1.89480E−08 |

| | 14 | 15 |
|---|---|---|
| C | 0.23117 | 0.74804 |
| K | 0.07699 | −5.40490 |
| A3 | −5.67353E−02 | 3.70351E−02 |
| A4 | −1.89317E−01 | −1.43898E−01 |
| A5 | 7.93154E−02 | 7.35665E−02 |
| A6 | 1.28534E−02 | 6.54339E−04 |
| A7 | −2.04030E−03 | −1.02962E−02 |
| A8 | −3.02601E−03 | 2.22717E−03 |
| A9 | 7.45605E−05 | 2.22978E−06 |
| A10 | 2.20319E−04 | 2.65991E−05 |
| A11 | 4.56175E−06 | 6.57465E−06 |
| A12 | −1.21171E−05 | −1.32943E−05 |
| A13 | 4.50797E−07 | −1.66706E−07 |
| A14 | 4.99589E−07 | 1.03567E−06 |
| A15 | −3.49324E−08 | −2.66133E−08 |
| A16 | −1.83615E−09 | −2.21974E−08 |
| A17 | −2.29950E−09 | −1.86670E−11 |
| A18 | −9.40092E−10 | 1.85386E−10 |
| A19 | −9.68581E−11 | −3.61924E−11 |
| A20 | 8.72262E−11 | −4.79176E−12 |

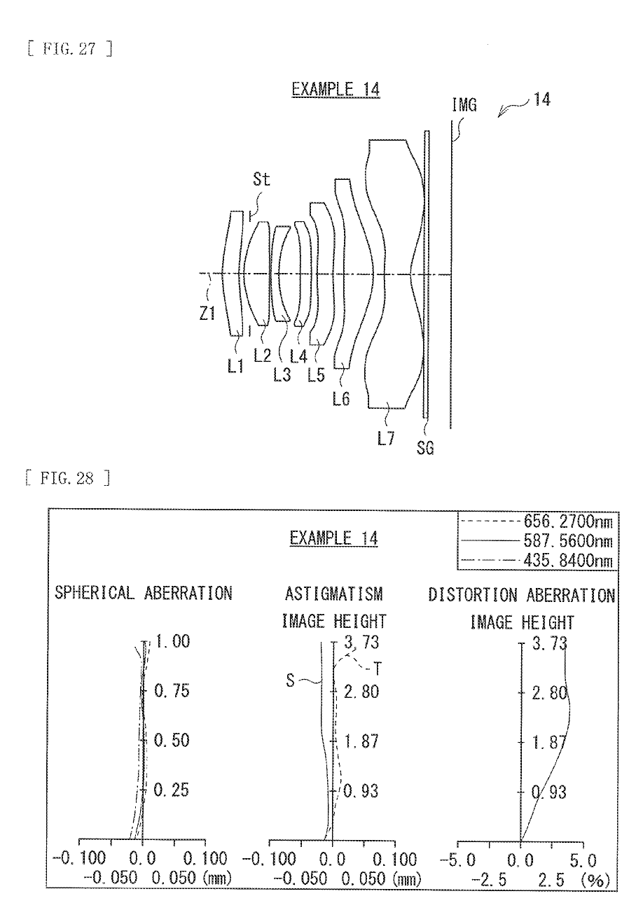

Various aberrations in Numerical example 14 above are illustrated in FIG. 28. As can be appreciated from the respective aberration diagrams, it is clear that the various aberrations are favorably corrected while the lens is small-sized, and excellent optical performance is achieved.

### Numerical Example 15

Table 43 shows basic lens data of Numerical Example 15 in which specific numerical values are applied to the imaging lens 15 illustrated in FIG. 29.

In the imaging lens 15 according to Numerical Example 15, both surfaces of each of the first lens L1 to the seventh lens L7 have aspherical shapes. Table 44 and Table 45 show values of coefficients representing these aspherical shapes.

In the imaging lens 15 according to Numerical Example 15, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 43
Example 15

| Si | Li | Ri | Di | Ndi | νdi |
|---|---|---|---|---|---|
| 1 | OBJ | ∞ | ∞ | | |
| 2 | L1R1 ASP | 3.2879 | 0.3773 | 1.5432 | 56.02 |
| 3 | L1R2 ASP | 3.4091 | 0.0823 | | |
| 4 | L2R1 ASP | 1.9140 | 0.6158 | 1.5432 | 56.02 |
| 5 | L2R2 ASP | −365.4640 | 0.0010 | | |
| 6 | L3R1 ASP | 10.0437 | 0.6245 | 1.6510 | 21.52 |
| 7 | L3R2 ASP | 2.8527 | 0.3672 | | |
| 8 | L4R1 ASP | 50.1913 | 0.3448 | 1.5432 | 56.02 |
| 9 | L4R2 ASP | −179.0370 | 0.1299 | | |
| 10 | L5R1 ASP | 7.1602 | 0.3436 | 1.6491 | 21.77 |
| 11 | L5R2 ASP | 6.2758 | 0.3229 | | |
| 12 | L6R1 ASP | 36.5692 | 0.7781 | 1.5432 | 56.02 |
| 13 | L6R2 ASP | −2.3389 | 0.2603 | | |
| 14 | L7R1 ASP | 11.3685 | 0.5755 | 1.5341 | 55.63 |
| 15 | L7R2 ASP | 1.5537 | 0.2465 | | |
| 16 | SGR1 | ∞ | 0.1100 | 1.5140 | 51.40 |
| 17 | SGR2 | ∞ | 0.5736 | | |

TABLE 44
Example 15

| | Si | | | |
|---|---|---|---|---|
| | 2 | 3 | 4 | 5 |
| C | 0.30414 | 0.29333 | 0.52248 | −0.00274 |
| K | 1.63847 | −9.99996 | −5.35042 | 5.57108 |
| A3 | 0.00000E+00 | 0.00000E+00 | 0.00000E+00 | 0.00000E+00 |
| A4 | −4.27145E−02 | −7.40761E−02 | 4.35567E−02 | 3.18594E−02 |
| A5 | 0.00000E+00 | 0.00000E+00 | 0.00000E+00 | 0.00000E+00 |
| A6 | −4.00402E−03 | 2.39539E−02 | −9.86987E−03 | −5.98932E−02 |
| A7 | 0.00000E+00 | 0.00000E+00 | 0.00000E+00 | 0.00000E+00 |
| A8 | −9.31637E−04 | −4.90163E−03 | 9.45883E−03 | 3.78226E−02 |
| A9 | 0.00000E+00 | 0.00000E+00 | 0.00000E+00 | 0.00000E+00 |
| A10 | 1.55649E−03 | 1.45418E−03 | −4.39474E−03 | −1.12334E−02 |
| A11 | 0.00000E+00 | 0.00000E+00 | 0.00000E+00 | 0.00000E+00 |
| A12 | −2.90712E−04 | −1.86884E−04 | 3.70981E−04 | 1.29345E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.09957 | 0.35055 | 0.01992 | −0.00559 |
| K | −6.36502 | −0.18419 | 10.00000 | 8.41151 |
| A3 | 0.00000E+00 | 0.00000E+00 | 0.00000E+00 | 0.00000E+00 |
| A4 | −3.38004E−03 | −1.29912E−02 | −2.20144E−02 | −3.81869E−03 |
| A5 | 0.00000E+00 | 0.00000E+00 | 0.00000E+00 | 0.00000E+00 |
| A6 | −2.14912E−02 | 3.30394E−02 | −2.77640E−02 | −1.08013E−01 |
| A7 | 0.00000E+00 | 0.00000E+00 | 0.00000E+00 | 0.00000E+00 |
| A8 | 2.24345E−02 | −2.10629E−02 | −3.66092E−03 | 1.20162E−01 |
| A9 | 0.00000E+00 | 0.00000E+00 | 0.00000E+00 | 0.00000E+00 |
| A10 | −4.70454E−03 | 2.32881E−02 | 3.19589E−02 | −7.92263E−02 |
| A11 | 0.00000E+00 | 0.00000E+00 | 0.00000E+00 | 0.00000E+00 |
| A12 | −9.27192E−05 | −1.46503E−02 | −3.60391E−02 | 2.30579E−02 |
| A13 | 0.00000E+00 | 0.00000E+00 | 0.00000E+00 | 0.00000E+00 |
| A14 | 1.39972E−04 | 5.04826E−03 | 1.44093E−02 | −6.42610E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 45
Example 15

| | Si | | | |
|---|---|---|---|---|
| | 10 | 11 | 12 | 13 |
| C | 0.13966 | 0.15934 | 0.02735 | −0.42756 |
| K | −9.33322 | −9.80322 | 10.00000 | −3.28274 |
| A3 | −2.81992E−02 | −2.82240E−02 | −2.55679E−02 | −2.84980E−02 |
| A4 | 5.67793E−02 | 4.18702E−02 | 8.74706E−02 | 5.48036E−02 |
| A5 | −1.72648E−01 | −9.85550E−02 | −7.03203E−02 | −1.22348E−02 |
| A6 | 5.63334E−02 | −3.19072E−03 | 2.64046E−03 | −1.17377E−02 |
| A7 | 1.47615E−02 | 2.80069E−02 | 1.26556E−03 | 4.05461E−03 |
| A8 | −4.92451E−03 | 2.57056E−03 | 1.71233E−03 | 2.29514E−03 |
| A9 | 6.38578E−03 | −8.98094E−04 | −8.94256E−04 | −6.40928E−04 |
| A10 | 2.56642E−03 | −2.31342E−03 | 3.03650E−04 | −4.09659E−04 |
| A11 | −2.09049E−03 | 3.19989E−05 | 4.94663E−04 | −1.75936E−05 |
| A12 | −5.86710E−03 | −1.44426E−04 | −3.15883E−04 | 1.69792E−05 |
| A13 | −1.51685E−03 | −5.81964E−05 | 1.21936E−04 | 3.93266E−05 |
| A14 | 1.54370E−03 | 2.23862E−04 | −9.74553E−05 | 6.93391E−06 |
| A15 | 9.44017E−04 | 8.11923E−05 | 4.26204E−05 | −4.37688E−06 |
| A16 | 6.10696E−04 | 5.84250E−07 | 1.53283E−05 | −7.99288E−07 |
| A17 | 1.41559E−04 | −3.02204E−05 | −2.70883E−06 | −2.40163E−07 |
| A18 | −1.85533E−04 | −2.03431E−05 | −5.81705E−06 | −6.59320E−08 |
| A19 | −2.56160E−04 | 2.09456E−06 | −6.12022E−07 | 1.19297E−08 |
| A20 | 6.48343E−05 | 2.95439E−06 | 8.26701E−07 | 1.95937E−08 |

| | 14 | 15 |
|---|---|---|
| C | 0.08796 | 0.64364 |
| K | 0.07699 | −5.40490 |
| A3 | −2.10969E−02 | 8.92196E−04 |
| A4 | −1.90029E−01 | −1.22940E−01 |
| A5 | 7.89697E−02 | 7.05426E−02 |
| A6 | 1.27646E−02 | −7.76378E−05 |
| A7 | −2.05655E−03 | −1.03393E−02 |
| A8 | −3.02720E−03 | 2.23397E−03 |
| A9 | 7.51300E−05 | 4.85699E−06 |
| A10 | 2.20654E−04 | 2.73029E−05 |
| A11 | 4.68579E−06 | 6.81410E−06 |
| A12 | −1.20788E−05 | −1.31993E−05 |
| A13 | 4.60827E−07 | −1.31360E−07 |
| A14 | 5.01915E−07 | 1.04719E−06 |
| A15 | −3.45136E−08 | −2.33819E−08 |
| A16 | −1.79946E−09 | −2.14586E−08 |
| A17 | −2.31209E−09 | 9.12004E−11 |
| A18 | −9.48250E−10 | 1.73611E−10 |
| A19 | −9.89265E−11 | −5.55517E−11 |
| A20 | 8.64277E−11 | −1.59253E−11 |

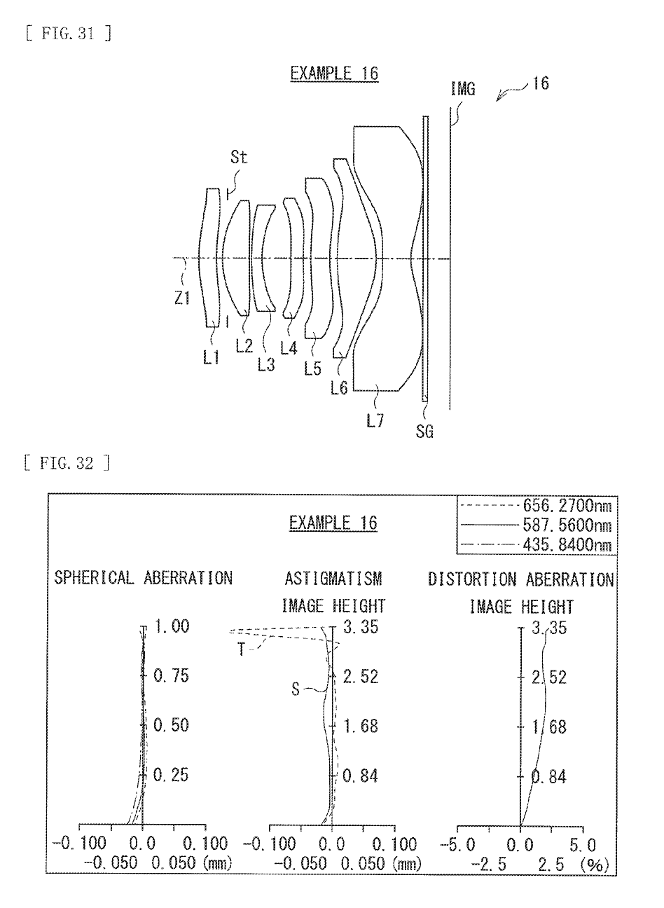

Various aberrations in Numerical example 15 above are illustrated in FIG. 30. As can be appreciated from the respective aberration diagrams, it is clear that the various aberrations are favorably corrected while the lens is small-sized, and excellent optical performance is achieved.

### Numerical Example 16

Table 46 shows basic lens data of Numerical Example 16 in which specific numerical values are applied to the imaging lens 16 illustrated in FIG. 31.

In the imaging lens 16 according to Numerical Example 16, both surfaces of each of the first lens L1 to the seventh lens L7 have aspherical shapes. Table 47 and Table 48 show values of coefficients representing these aspherical shapes.

In the imaging lens 16 according to Numerical Example 16, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has negative refractive power near the optical axis. The sixth lens L6 has positive refractive power near the optical axis. The seventh lens L7 has negative refractive power near the optical axis.

TABLE 46
Example 16

| Si | Li | Ri | Di | Ndi | νdi |
|---|---|---|---|---|---|
| 1 | OBJ | ∞ | ∞ | | |
| 2 | L1R1 ASP | 3.3055 | 0.4089 | 1.5432 | 56.02 |
| 3 | L1R2 ASP | 3.6270 | 0.1331 | | |
| 4 | L2R1 ASP | 1.9020 | 0.6283 | 1.5432 | 56.02 |
| 5 | L2R2 ASP | 256.3370 | 0.0445 | | |
| 6 | L3R1 ASP | 5.1185 | 0.2470 | 1.6604 | 20.39 |
| 7 | L3R2 ASP | 2.3629 | 0.6706 | | |
| 8 | L4R1 ASP | −69.2928 | 0.2957 | 1.5432 | 56.02 |
| 9 | L4R2 ASP | 23.0445 | 0.1677 | | |
| 10 | L5R1 ASP | 5.1958 | 0.4500 | 1.6349 | 23.89 |
| 11 | L5R2 ASP | 4.1215 | 0.1743 | | |
| 12 | L6R1 ASP | 7.0501 | 0.8988 | 1.5432 | 56.02 |
| 13 | L6R2 ASP | −1.8608 | 0.1484 | | |
| 14 | L7R1 ASP | 29.0334 | 0.6507 | 1.5341 | 55.63 |
| 15 | L7R2 ASP | 1.2809 | 0.2771 | | |
| 16 | SGR1 | ∞ | 0.1100 | 1.5140 | 51.40 |
| 17 | SGR2 | ∞ | 0.5249 | | |

TABLE 47
Example 16

| | Si | | | |
|---|---|---|---|---|
| | 2 | 3 | 4 | 5 |
| C | 0.30253 | 0.27571 | 0.52575 | 0.00390 |
| K | 1.81526 | −10.00000 | −5.22259 | −9.91842 |
| A3 | 0.00000E+00 | 0.00000E+00 | 0.00000E+00 | 0.00000E+00 |
| A4 | −3.74886E−02 | −6.99371E−02 | 3.96646E−02 | 3.18949E−02 |
| A5 | 0.00000E+00 | 0.00000E+00 | 0.00000E+00 | 0.00000E+00 |
| A6 | −3.34869E−03 | 2.38419E−02 | −1.28038E−02 | −6.25755E−02 |
| A7 | 0.00000E+00 | 0.00000E+00 | 0.00000E+00 | 0.00000E+00 |
| A8 | −1.84266E−03 | −5.68511E−03 | 1.03647E−02 | 4.23627E−02 |
| A9 | 0.00000E+00 | 0.00000E+00 | 0.00000E+00 | 0.00000E+00 |
| A10 | 1.32468E−03 | 1.18118E−03 | −3.12330E−03 | −1.37028E−02 |
| A11 | 0.00000E+00 | 0.00000E+00 | 0.00000E+00 | 0.00000E+00 |
| A12 | −2.53850E−04 | −1.65647E−04 | −1.26908E−04 | 1.58180E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.19537 | 0.42321 | −0.01443 | 0.04339 |
| K | −9.21852 | −0.71158 | 10.00000 | 8.41151 |
| A3 | 0.00000E+00 | 0.00000E+00 | 0.00000E+00 | 0.00000E+00 |
| A4 | 8.70723E−04 | −1.78377E−02 | −4.76927E−02 | −2.15574E−02 |
| A5 | 0.00000E+00 | 0.00000E+00 | 0.00000E+00 | 0.00000E+00 |
| A6 | −1.86288E−02 | 3.60446E−02 | −1.60057E−02 | −1.07134E−01 |
| A7 | 0.00000E+00 | 0.00000E+00 | 0.00000E+00 | 0.00000E+00 |
| A8 | 1.88036E−02 | −2.66492E−02 | −1.38418E−02 | 1.13741E−01 |
| A9 | 0.00000E+00 | 0.00000E+00 | 0.00000E+00 | 0.00000E+00 |
| A10 | −2.62142E−03 | 2.63717E−02 | 3.16935E−02 | −7.70701E−02 |
| A11 | 0.00000E+00 | 0.00000E+00 | 0.00000E+00 | 0.00000E+00 |
| A12 | −2.90124E−04 | −1.46477E−02 | −3.60373E−02 | 2.21318E−02 |
| A13 | 0.00000E+00 | 0.00000E+00 | 0.00000E+00 | 0.00000E+00 |
| A14 | 1.39090E−04 | 5.04826E−03 | 1.44090E−02 | −6.41593E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 48
Example 16

| | Si | | | |
|---|---|---|---|---|
| | 10 | 11 | 12 | 13 |
| C | 0.19246 | 0.24263 | 0.14184 | −0.53741 |
| K | −9.33322 | −9.80322 | 9.89343 | −3.28274 |
| A3 | −2.46767E−02 | −1.09918E−02 | 7.35593E−03 | −3.18857E−02 |
| A4 | 7.64449E−02 | 6.53652E−02 | 7.69606E−02 | 5.88220E−02 |
| A5 | −1.67105E−01 | −1.05854E−01 | −7.36480E−02 | −7.53528E−03 |
| A6 | 5.50544E−02 | −1.03878E−02 | 1.75719E−03 | −1.22551E−02 |
| A7 | −3.23893E−02 | 2.65450E−02 | 1.04767E−03 | 3.39536E−03 |
| A8 | −6.71311E−03 | 2.75979E−03 | 1.62267E−03 | 2.07792E−03 |
| A9 | 5.65718E−03 | −9.06837E−04 | −9.29650E−04 | −6.84045E−04 |
| A10 | 2.48197E−03 | −2.42653E−03 | 2.79651E−04 | −4.12310E−04 |
| A11 | −1.93483E−03 | −1.84953E−05 | 4.82869E−04 | −1.52278E−05 |
| A12 | −5.71146E−03 | −1.42796E−04 | −3.21894E−04 | 1.88340E−05 |
| A13 | −1.45577E−03 | −3.97146E−05 | 1.19605E−04 | 4.01680E−05 |
| A14 | 1.54804E−03 | 2.40862E−04 | −9.83536E−05 | 7.24838E−06 |
| A15 | 9.30191E−04 | 9.18286E−05 | 4.24886E−05 | −4.26461E−06 |
| A16 | 5.94817E−04 | 6.03215E−06 | 1.53557E−05 | −7.61721E−07 |
| A17 | 1.34705E−04 | −2.74459E−05 | −2.68446E−06 | −2.27147E−07 |
| A18 | −1.84845E−04 | −2.00478E−05 | −5.80198E−06 | −6.48264E−08 |
| A19 | −2.46038E−04 | 1.71526E−06 | −6.05353E−07 | 1.08417E−08 |
| A20 | 7.72651E−05 | 2.41872E−06 | 8.28443E−07 | 1.87719E−08 |

| | 14 | 15 |
|---|---|---|
| C | 0.03444 | 0.78071 |
| K | 0.07699 | −5.40490 |
| A3 | −6.34442E−02 | −9.95861E−03 |
| A4 | −1.78565E−01 | −1.22688E−01 |
| A5 | 8.21233E−02 | 7.51836E−02 |
| A6 | 1.32910E−02 | −2.69558E−04 |
| A7 | −2.01782E−03 | −1.06425E−02 |
| A8 | −3.04405E−03 | 2.16972E−03 |
| A9 | 6.39700E−05 | 2.11123E−06 |
| A10 | 2.16133E−04 | 2.98619E−05 |
| A11 | 3.13430E−06 | 7.91927E−06 |
| A12 | −1.25584E−05 | −1.29135E−05 |
| A13 | 3.23353E−07 | −8.05477E−08 |
| A14 | 4.66165E−07 | 1.05001E−06 |
| A15 | −4.21463E−08 | −2.56573E−08 |
| A16 | −2.67855E−09 | −2.27578E−08 |
| A17 | −2.03056E−09 | −3.62211E−10 |
| A18 | −6.43780E−10 | 5.57456E−11 |
| A19 | 7.40210E−11 | −7.43906E−11 |
| A20 | 1.67785E−10 | −1.40422E−11 |

Various aberrations in Numerical example 16 above are illustrated in FIG. 32. As can be appreciated from the respective aberration diagrams, it is clear that the various aberrations are favorably corrected while the lens is small-sized, and excellent optical performance is achieved.

### Numerical Example 17

Table 49 shows basic lens data of Numerical Example 17 in which specific numerical values are applied to the imaging lens 17 illustrated in FIG. 33.

In the imaging lens 17 according to Numerical Example 17, both surfaces of each of the first lens L1 to the seventh lens L7 have aspherical shapes. Table 50 and Table 51 show values of coefficients representing these aspherical shapes.

In the imaging lens 17 according to Numerical Example 17, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 49
Example 17

| Si | Li | Ri | Di | Ndi | νdi |
|---|---|---|---|---|---|
| 1 | OBJ | ∞ | ∞ | | |
| 2 | L1R1 ASP | 3.3601 | 0.4384 | 1.5831 | 59.46 |
| 3 | L1R2 ASP | 3.2710 | 0.1262 | | |
| 4 | L2R1 ASP | 1.9347 | 0.6935 | 1.5439 | 56.07 |
| 5 | L2R2 ASP | −71.6293 | 0.0286 | | |
| 6 | L3R1 ASP | 8.2477 | 0.2456 | 1.6589 | 20.55 |
| 7 | L3R2 ASP | 2.8873 | 0.4462 | | |
| 8 | L4R1 ASP | 15.6613 | 0.3126 | 1.5418 | 56.05 |
| 9 | L4R2 ASP | 20.5422 | 0.1822 | | |
| 10 | L5R1 ASP | 6.6055 | 0.4166 | 1.6349 | 23.89 |
| 11 | L5R2 ASP | 6.3885 | 0.2737 | | |
| 12 | L6R1 ASP | 62.3008 | 0.7180 | 1.5432 | 56.02 |
| 13 | L6R2 ASP | −2.5938 | 0.3230 | | |
| 14 | L7R1 ASP | 4.1811 | 0.6526 | 1.5341 | 55.63 |
| 15 | L7R2 ASP | 1.3409 | 0.3531 | | |
| 16 | SGR1 | ∞ | 0.1100 | 1.5140 | 51.40 |
| 17 | SGR2 | ∞ | 0.4834 | | |

TABLE 50
Example 17

| | Si | | | |
|---|---|---|---|---|
| | 2 | 3 | 4 | 5 |
| C | 0.29761 | 0.30572 | 0.51687 | −0.01396 |
| K | 1.65050 | −1.55215 | −5.17979 | 10.00000 |
| A3 | 0.00000E+00 | 0.00000E+00 | 0.00000E+00 | 0.00000E+00 |
| A4 | −3.40084E−02 | −9.36064E−02 | 1.97911E−02 | 3.45136E−02 |
| A5 | 0.00000E+00 | 0.00000E+00 | 0.00000E+00 | 0.00000E+00 |
| A6 | 3.51919E−04 | 4.62860E−02 | 3.55692E−03 | −6.25527E−02 |
| A7 | 0.00000E+00 | 0.00000E+00 | 0.00000E+00 | 0.00000E+00 |
| A8 | −1.64914E−03 | −1.77699E−02 | −2.27601E−03 | 3.89502E−02 |
| A9 | 0.00000E+00 | 0.00000E+00 | 0.00000E+00 | 0.00000E+00 |
| A10 | 1.22195E−03 | 5.53353E−03 | 1.52777E−03 | −1.31748E−02 |
| A11 | 0.00000E+00 | 0.00000E+00 | 0.00000E+00 | 0.00000E+00 |
| A12 | −2.32784E−04 | −7.90426E−04 | −1.12904E−03 | 1.49333E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.12125 | 0.34635 | 0.06385 | 0.04868 |
| K | 6.63887 | −0.47958 | 10.00000 | 0.07653 |
| A3 | 0.00000E+00 | 0.00000E+00 | 0.00000E+00 | 0.00000E+00 |
| A4 | 6.92958E−03 | −1.54806E−02 | −4.28631E−02 | −1.10842E−02 |
| A5 | 0.00000E+00 | 0.00000E+00 | 0.00000E+00 | 0.00000E+00 |
| A6 | −1.85101E−02 | 3.10955E−02 | −7.78639E−03 | −1.04332E−01 |
| A7 | 0.00000E+00 | 0.00000E+00 | 0.00000E+00 | 0.00000E+00 |
| A8 | 1.85809E−02 | −2.16208E−02 | −2.13280E−02 | 1.13784E−01 |
| A9 | 0.00000E+00 | 0.00000E+00 | 0.00000E+00 | 0.00000E+00 |
| A10 | −3.58214E−03 | 2.27016E−02 | 3.58357E−02 | −7.80486E−02 |
| A11 | 0.00000E+00 | 0.00000E+00 | 0.00000E+00 | 0.00000E+00 |
| A12 | −1.28599E−04 | −1.46477E−02 | −3.60389E−02 | 2.30758E−02 |
| A13 | 0.00000E+00 | 0.00000E+00 | 0.00000E+00 | 0.00000E+00 |
| A14 | 1.39082E−04 | 5.04830E−03 | 1.44093E−02 | −6.42601E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 51
Example 17

| | Si | | | |
|---|---|---|---|---|
| | 10 | 11 | 12 | 13 |
| C | 0.15139 | 0.15653 | 0.01605 | −0.38554 |
| K | −10.00000 | −8.33608 | 10.00000 | −3.18792 |
| A3 | −1.18117E−02 | −1.77046E−02 | −3.99272E−02 | −6.55907E−02 |
| A4 | 7.81897E−02 | 7.37638E−02 | 1.08604E−01 | 6.35120E−02 |
| A5 | −1.70552E−01 | −1.03801E−01 | −6.95441E−02 | −4.75433E−03 |
| A6 | 5.21517E−02 | −1.02317E−02 | −9.50597E−05 | −1.12209E−02 |
| A7 | 1.25173E−02 | 2.63639E−02 | 1.46719E−04 | 3.66244E−03 |
| A8 | −5.72448E−03 | 2.78772E−03 | 1.50313E−03 | 2.11421E−03 |
| A9 | 6.30572E−03 | −8.81602E−04 | −8.50395E−04 | −6.88232E−04 |
| A10 | 2.69700E−03 | −2.43687E−03 | 3.49696E−04 | −4.18186E−04 |
| A11 | −1.95154E−03 | −4.49689E−05 | 5.18559E−04 | −1.83223E−05 |
| A12 | −5.77120E−03 | −1.60364E−04 | −3.07099E−04 | 1.76229E−05 |
| A13 | −1.49970E−03 | −4.72839E−05 | 1.24728E−04 | 3.97301E−05 |
| A14 | 1.52864E−03 | 2.39347E−04 | −9.68421E−05 | 7.08375E−06 |
| A15 | 9.29550E−04 | 9.27964E−05 | 4.26485E−05 | −4.30065E−06 |
| A16 | 6.00658E−04 | 7.31453E−06 | 1.52393E−05 | −7.68898E−07 |
| A17 | 1.40280E−04 | −2.69688E−05 | −2.76309E−06 | −2.29299E−07 |
| A18 | −1.84303E−04 | −1.96971E−05 | −5.84836E−06 | −6.18574E−08 |
| A19 | −2.48424E−04 | 1.79693E−06 | −6.24768E−07 | 1.06118E−08 |
| A20 | 7.26951E−05 | 2.31199E−06 | 8.22173E−07 | 1.87197E−08 |

| | 14 | 15 |
|---|---|---|
| C | 0.23917 | 0.74580 |
| K | 0.07898 | −5.47391 |
| A3 | −5.71129E−02 | 4.05614E−02 |
| A4 | −1.89637E−01 | −1.45181E−01 |
| A5 | 7.92826E−02 | 7.38286E−02 |
| A6 | 1.28400E−02 | 7.45485E−04 |
| A7 | −2.04222E−03 | −1.03560E−02 |
| A8 | −3.02504E−03 | 2.21531E−03 |
| A9 | 7.49090E−05 | 4.60538E−06 |
| A10 | 2.20497E−04 | 2.75116E−05 |
| A11 | 4.63033E−06 | 6.81198E−06 |
| A12 | −1.21021E−05 | −1.32483E−05 |
| A13 | 4.52162E−07 | −1.61056E−07 |
| A14 | 4.99528E−07 | 1.03218E−06 |
| A15 | −3.57671E−08 | −2.78788E−08 |
| A16 | −2.09280E−09 | −2.25547E−08 |
| A17 | −2.41035E−09 | −1.00432E−10 |
| A18 | −9.54295E−10 | 1.72661E−10 |
| A19 | −9.86854E−11 | −3.08360E−11 |
| A20 | 9.35218E−11 | −1.69685E−12 |

Various aberrations in Numerical example 17 above are illustrated in FIG. 34. As can be appreciated from the respective aberration diagrams, it is clear that the various aberrations are favorably corrected while the lens is small-sized, and excellent optical performance is achieved.

### Numerical Example 18

Table 52 shows basic lens data of Numerical Example 18 in which specific numerical values are applied to the imaging lens 18 illustrated in FIG. 35.

In the imaging lens 18 according to Numerical Example 18, both surfaces of each of the first lens L1 to the seventh lens L7 have aspherical shapes. Table 53 and Table 54 show values of coefficients representing these aspherical shapes.

In the imaging lens 18 according to Numerical Example 18, the first lens L1 has positive refractive power near the optical axis. The second lens L2 has positive refractive power near the optical axis. The third lens L3 has negative refractive power near the optical axis. The fourth lens L4 has positive refractive power near the optical axis. The fifth lens L5 has negative refractive power near the optical axis. The sixth lens L6 has positive refractive power near the optical axis. The seventh lens L7 has negative refractive power near the optical axis.

TABLE 52
Example 18

| Si | Li | Ri | Di | Ndi | νdi |
|---|---|---|---|---|---|
| 1 | OBJ | ∞ | ∞ | | |
| 2 | L1R1 ASP | −1000.0000 | 0.5073 | 1.5432 | 56.02 |
| 3 | L1R2 ASP | −14.4644 | 0.1538 | | |
| 4 | L2R1 ASP | 1.7290 | 0.5466 | 1.5432 | 56.02 |
| 5 | L2R2 ASP | 12.6081 | 0.0300 | | |
| 6 | L3R1 ASP | 6.7743 | 0.2170 | 1.6504 | 21.51 |
| 7 | L3R2 ASP | 2.7368 | 0.3700 | | |
| 8 | L4R1 ASP | −34.2957 | 0.4000 | 1.5432 | 56.02 |
| 9 | L4R2 ASP | −12.0791 | 0.1030 | | |
| 10 | L5R1 ASP | −13.7686 | 0.3356 | 1.6349 | 23.91 |
| 11 | L5R2 ASP | 17.5735 | 0.3291 | | |
| 12 | L6R1 ASP | 5.7658 | 0.6531 | 1.5341 | 55.63 |
| 13 | L6R2 ASP | −3.1445 | 0.5115 | | |
| 14 | L7R1 ASP | 5.1859 | 0.6333 | 1.5341 | 55.63 |
| 15 | L7R2 ASP | 1.2087 | 0.2900 | | |
| 16 | SGR1 | ∞ | 0.1100 | 1.5140 | 51.40 |
| 17 | SGR2 | ∞ | 0.3514 | | |

TABLE 53
Example 18

| | Si | | | |
|---|---|---|---|---|
| | 2 | 3 | 4 | 5 |
| C | −0.00100 | −0.06914 | 0.57837 | 0.07931 |
| K | 0.00000 | 0.00000 | 0.16277 | 10.00000 |
| A3 | 0.00000E+00 | 0.00000E+00 | 0.00000E+00 | 0.00000E+00 |
| A4 | −1.96839E−02 | −2.39915E−02 | 2.45431E−04 | −1.74249E−02 |
| A5 | 0.00000E+00 | 0.00000E+00 | 0.00000E+00 | 0.00000E+00 |
| A6 | 2.80181E−03 | 6.57063E−03 | 1.98682E−02 | −1.33236E−02 |
| A7 | 0.00000E+00 | 0.00000E+00 | 0.00000E+00 | 0.00000E+00 |
| A8 | −4.74053E−04 | −1.29178E−03 | −4.98347E−02 | 3.92602E−02 |
| A9 | 0.00000E+00 | 0.00000E+00 | 0.00000E+00 | 0.00000E+00 |
| A10 | 5.95366E−05 | 1.35114E−04 | 3.35891E−02 | −3.49090E−02 |
| A11 | 0.00000E+00 | 0.00000E+00 | 0.00000E+00 | 0.00000E+00 |
| A12 | 0.00000E+00 | 0.00000E+00 | −2.07350E−03 | 1.21064E−02 |
| A13 | 0.00000E+00 | 0.00000E+00 | 0.00000E+00 | 0.00000E+00 |
| A14 | 0.00000E+00 | 0.00000E+00 | −9.92830E−03 | −5.91960E−03 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.14762 | 0.36539 | −0.02916 | −0.08279 |
| K | −10.00000 | −20.00000 | −10.00000 | 10.00000 |
| A3 | 0.00000E+00 | 0.00000E+00 | 0.00000E+00 | 0.00000E+00 |
| A4 | −3.98733E−02 | 8.84625E−02 | −4.64440E−02 | −1.04947E−01 |
| A5 | 0.00000E+00 | 0.00000E+00 | 0.00000E+00 | 0.00000E+00 |
| A6 | 6.38755E−02 | 9.76155E−02 | −5.67319E−02 | −9.27599E−03 |
| A7 | 0.00000E+00 | 0.00000E+00 | 0.00000E+00 | 0.00000E+00 |
| A8 | −2.61545E−02 | −6.30905E−01 | 2.51844E−02 | 6.51513E−02 |
| A9 | 0.00000E+00 | 0.00000E+00 | 0.00000E+00 | 0.00000E+00 |
| A10 | 9.51409E−02 | 1.85966E+00 | 2.99192E−02 | −1.58747E−01 |
| A11 | 0.00000E+00 | 0.00000E+00 | 0.00000E+00 | 0.00000E+00 |
| A12 | −1.41545E−01 | −2.73398E+00 | −1.11975E−01 | 8.03031E−02 |
| A13 | 0.00000E+00 | 0.00000E+00 | 0.00000E+00 | 0.00000E+00 |
| A14 | 1.01735E−01 | 2.05419E+00 | 7.88893E−02 | 9.70840E−03 |
| A15 | 0.00000E+00 | 0.00000E+00 | 0.00000E+00 | 0.00000E+00 |
| A16 | −2.90403E−02 | −6.13763E−01 | −5.66430E−03 | −1.00560E−02 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 54
Example 18

| | Si | | | |
|---|---|---|---|---|
| | 10 | 11 | 12 | 13 |
| C | −0.07263 | 0.05690 | 0.17344 | −0.31802 |
| K | −10.00000 | 6.56388 | 9.98161 | −10.00000 |
| A3 | −1.10022E−02 | 4.46362E−03 | −3.21576E−02 | −4.83648E−02 |
| A4 | −1.55340E−01 | −2.14482E−01 | 4.33993E−02 | 1.73151E−02 |
| A5 | −1.98580E−01 | 5.46265E−02 | −1.02753E−01 | −5.75905E−03 |
| A6 | 3.09166E−01 | 4.32848E−02 | 2.70693E−02 | −2.10778E−02 |
| A7 | 4.07564E−02 | 1.71674E−02 | 2.43654E−02 | 1.38868E−02 |
| A8 | −1.43639E−01 | −2.34402E−02 | 6.38943E−04 | 1.19176E−02 |
| A9 | −7.36449E−02 | −3.65612E−03 | −1.15556E−02 | −1.98217E−03 |
| A10 | 1.50820E−02 | −9.54716E−03 | −1.73845E−03 | −3.24368E−03 |
| A11 | 4.12845E−02 | 2.76758E−03 | 3.54339E−03 | −8.87579E−04 |
| A12 | 2.68042E−03 | 4.71398E−04 | −2.23777E−03 | −2.30060E−04 |
| A13 | −2.05168E−03 | 8.61729E−04 | 1.44608E−03 | 3.18021E−04 |
| A14 | −5.44856E−04 | 3.84112E−03 | −1.36215E−03 | 1.07129E−04 |
| A15 | −1.24726E−02 | 1.25526E−03 | 5.48015E−04 | −3.32942E−05 |
| A16 | −3.74491E−03 | −5.19072E−04 | 2.63434E−04 | 7.77106E−06 |
| A17 | 1.32949E−02 | −1.18190E−03 | −1.90145E−05 | 5.26070E−06 |
| A18 | 1.37252E−02 | −8.24849E−04 | −1.29623E−04 | 1.49916E−06 |
| A19 | 4.69955E−03 | 1.04130E−05 | −1.20394E−05 | −8.19988E−07 |
| A20 | −1.56804E−02 | 4.08066E−04 | 2.17353E−05 | −8.28519E−07 |

| | 14 | 15 |
|---|---|---|
| C | 0.19283 | 0.82734 |
| K | −0.64166 | −3.96613 |
| A3 | −1.88444E−02 | −4.48750E−02 |
| A4 | −3.63127E−01 | −1.34004E−01 |
| A5 | 1.56460E−01 | 8.47924E−02 |
| A6 | 3.54802E−02 | 2.70976E−02 |
| A7 | −5.16444E−03 | −3.73731E−02 |
| A8 | −1.14147E−02 | 8.62086E−03 |
| A9 | 4.78550E−04 | 1.65792E−04 |
| A10 | 1.29257E−03 | 2.03557E−04 |
| A11 | 2.43352E−05 | 4.53241E−05 |
| A12 | −1.10906E−04 | −1.19769E−04 |
| A13 | 1.68697E−06 | −2.61524E−06 |
| A14 | 5.47145E−06 | 1.24612E−05 |
| A15 | −6.53928E−07 | −3.11783E−07 |
| A16 | 1.23000E−08 | −3.67976E−07 |
| A17 | 1.13706E−09 | −2.73872E−09 |
| A18 | −1.33274E−09 | 7.31638E−11 |
| A19 | −2.05865E−10 | 2.11359E−10 |
| A20 | 7.58893E−11 | 1.28216E−10 |

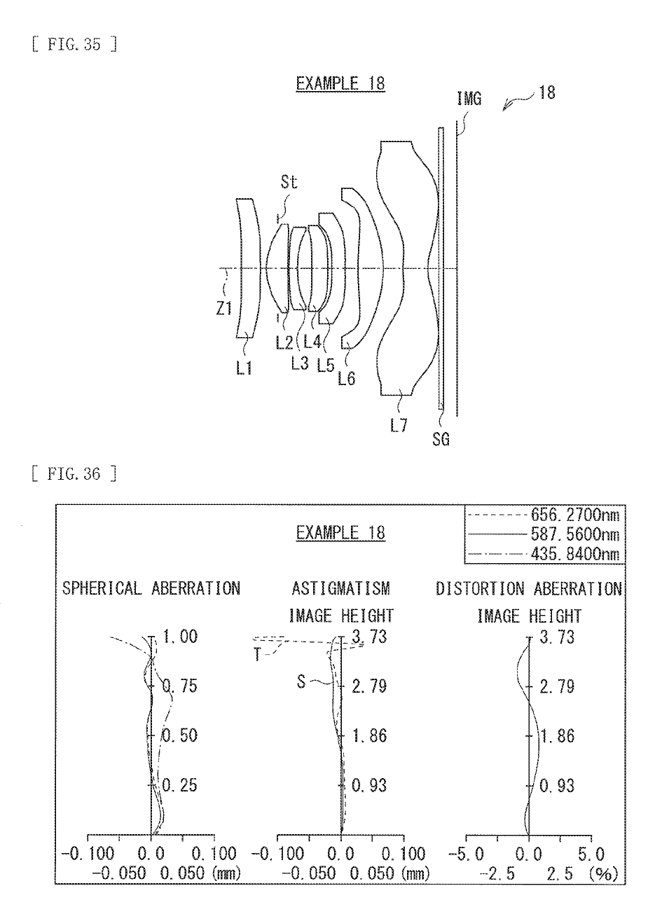

Various aberrations in Numerical example 18 above are illustrated in FIG. 36. As can be appreciated from the respective aberration diagrams, it is clear that the various aberrations are favorably corrected while the lens is small-sized, and excellent optical performance is achieved.

### Numerical Example 19

Table 55 shows basic lens data of Numerical Example 19 in which specific numerical values are applied to the imaging lens 19 illustrated in FIG. 37.

In the imaging lens 19 according to Numerical Example 19, both surfaces of each of the first lens L1 to the seventh lens L7 have aspherical shapes. Table 56 and Table 57 show values of coefficients representing these aspherical shapes.

In the imaging lens 19 according to Numerical Example 19, the first lens L1 has positive refractive power near the optical axis. The second lens L2 has positive refractive power near the optical axis. The third lens L3 has negative refractive power near the optical axis. The fourth lens L4 has negative refractive power near the optical axis. The fifth lens L5 has negative refractive power near the optical axis. The sixth lens L6 has positive refractive power near the optical axis. The seventh lens L7 has negative refractive power near the optical axis.

TABLE 55
Example 19

| Si | Li | Ri | Di | Ndi | νdi |
|---|---|---|---|---|---|
| 1 | OBJ | ∞ | ∞ | | |
| 2 | L1R1 ASP | 3.2902 | 0.4347 | 1.4786 | 77.03 |
| 3 | L1R2 ASP | 3.7255 | 0.1208 | | |
| 4 | L2R1 ASP | 2.0475 | 0.6707 | 1.5432 | 56.02 |
| 5 | L2R2 ASP | −32.3349 | 0.0431 | | |
| 6 | L3R1 ASP | 8.0240 | 0.2204 | 1.6579 | 20.51 |
| 7 | L3R2 ASP | 2.7909 | 0.5333 | | |
| 8 | L4R1 ASP | 96.5658 | 0.2713 | 1.5432 | 56.02 |
| 9 | L4R2 ASP | 64.3756 | 0.1497 | | |
| 10 | L5R1 ASP | 7.4790 | 0.4058 | 1.6325 | 24.77 |
| 11 | L5R2 ASP | 6.6407 | 0.2930 | | |
| 12 | L6R1 ASP | −340.9500 | 0.7140 | 1.5432 | 56.02 |
| 13 | L6R2 ASP | −2.3989 | 0.2973 | | |
| 14 | L7R1 ASP | 4.3559 | 0.6862 | 1.5341 | 55.63 |
| 15 | L7R2 ASP | 1.3375 | 0.3479 | | |
| 16 | SGR1 | ∞ | 0.1100 | 1.5140 | 51.40 |
| 17 | SGR2 | ∞ | 0.5532 | | |

TABLE 56
Example 19

Si

| | 2 | 3 | 4 | 5 |
|---|---|---|---|---|
| C | 0.30394 | 0.26842 | 0.48839 | −0.03093 |
| K | 2.00665 | −10.00000 | −5.97674 | 10.00000 |
| A3 | 0.00000E+00 | 0.00000E+00 | 0.00000E+00 | 0.00000E+00 |
| A4 | −3.66256E−02 | −6.62636E−02 | 3.83536E−02 | 3.49364E−02 |
| A5 | 0.00000E+00 | 0.00000E+00 | 0.00000E+00 | 0.00000E+00 |
| A6 | −3.01205E−03 | 2.53738E−02 | −1.41420E−02 | −6.48280E−02 |
| A7 | 0.00000E+00 | 0.00000E+00 | 0.00000E+00 | 0.00000E+00 |
| A8 | −1.57537E−03 | −5.48695E−03 | 1.00228E−02 | 4.19189E−02 |
| A9 | 0.00000E+00 | 0.00000E+00 | 0.00000E+00 | 0.00000E+00 |
| A10 | 1.38229E−03 | 1.14719E−03 | −3.23170E−03 | −1.39158E−02 |
| A11 | 0.00000E+00 | 0.00000E+00 | 0.00000E+00 | 0.00000E+00 |
| A12 | −2.86520E−04 | −1.37673E−04 | −4.40196E−04 | 1.47002E−03 |
| A13 | 0.00000E+00 | 0.00000E+00 | 0.00000E+00 | 0.00000E+00 |
| A14 | 0.00000E+00 | 0.00000E+00 | 0.00000E+00 | 0.00000E+00 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |
| | 6 | 7 | 8 | 9 |
| C | 0.12463 | 0.35831 | 0.01036 | 0.01553 |
| K | −1.70646 | −0.44326 | 10.00000 | 8.41151 |
| A3 | 0.00000E+00 | 0.00000E+00 | 0.00000E+00 | 0.00000E+00 |
| A4 | 5.05269E−03 | −1.68157E−02 | −4.09103E−02 | −1.47092E−02 |
| A5 | 0.00000E+00 | 0.00000E+00 | 0.00000E+00 | 0.00000E+00 |
| A6 | −1.64374E−02 | 3.39539E−02 | −1.38403E−02 | −1.03226E−01 |
| A7 | 0.00000E+00 | 0.00000E+00 | 0.00000E+00 | 0.00000E+00 |
| A8 | 1.79075E−02 | −2.32521E−02 | −1.82579E−02 | 1.12210E−01 |
| A9 | 0.00000E+00 | 0.00000E+00 | 0.00000E+00 | 0.00000E+00 |
| A10 | −2.73612E−03 | 2.36862E−02 | 3.40708E−02 | −7.75992E−02 |
| A11 | 0.00000E+00 | 0.00000E+00 | 0.00000E+00 | 0.00000E+00 |
| A12 | −1.28157E−04 | −1.46477E−02 | −3.60388E−02 | 2.30567E−02 |
| A13 | 0.00000E+00 | 0.00000E+00 | 0.00000E+00 | 0.00000E+00 |
| A14 | 1.39094E−04 | 5.04826E−03 | 1.44093E−02 | −6.42619E−04 |
| A15 | 0.00000E+00 | 0.00000E+00 | 0.00000E+00 | 0.00000E+00 |
| A16 | 0.00000E+00 | 0.00000E+00 | 0.00000E+00 | 0.00000E+00 |
| A17 | 0.00000E+00 | 0.00000E+00 | 0.00000E+00 | 0.00000E+00 |
| A18 | 0.00000E+00 | 0.00000E+00 | 0.00000E+00 | 0.00000E+00 |
| A19 | 0.00000E+00 | 0.00000E+00 | 0.00000E+00 | 0.00000E+00 |
| A20 | 0.00000E+00 | 0.00000E+00 | 0.00000E+00 | 0.00000E+00 |

TABLE 57
Example 19

| | Si | | | |
|---|---|---|---|---|
| | 10 | 11 | 12 | 13 |
| C | 0.13371 | 0.15059 | −0.00293 | −0.41685 |
| K | −9.33322 | −9.80322 | 10.00000 | −3.28274 |
| A3 | −2.00474E−02 | −2.73051E−02 | −3.46987E−02 | −6.81147E−02 |
| A4 | 7.00754E−02 | 6.89117E−02 | 1.08503E−01 | 6.29961E−02 |
| A5 | −1.73313E−01 | −1.03649E−01 | −7.10799E−02 | −4.90647E−03 |
| A6 | 5.43967E−02 | −1.08731E−02 | −3.12067E−04 | −1.12430E−02 |
| A7 | 1.36910E−02 | 2.62813E−02 | 1.27120E−04 | 3.67443E−03 |
| A8 | −5.65953E−03 | 2.94494E−03 | 1.49932E−03 | 2.12699E−03 |
| A9 | 6.17256E−03 | −7.55557E−04 | −8.45752E−04 | −6.83859E−04 |
| A10 | 2.64809E−03 | −2.36334E−03 | 3.53524E−04 | −4.16984E−04 |
| A11 | −1.91143E−03 | −9.44170E−06 | 5.21014E−04 | −1.80123E−05 |
| A12 | −5.70903E−03 | −1.48036E−04 | −3.05897E−04 | 1.76047E−05 |
| A13 | −1.44852E−03 | −4.54777E−05 | 1.25117E−04 | 3.97182E−05 |
| A14 | 1.55828E−03 | 2.38092E−04 | −9.67182E−05 | 7.08817E−06 |
| A15 | 9.40796E−04 | 9.08823E−05 | 4.26682E−05 | −4.30751E−06 |
| A16 | 6.00578E−04 | 5.89901E−06 | 1.52506E−05 | −7.74609E−07 |
| A17 | 1.34884E−04 | −2.77555E−05 | −2.76830E−06 | −2.31494E−07 |
| A18 | −1.90199E−04 | −2.00907E−05 | −5.85261E−06 | −6.44290E−08 |
| A19 | −2.53861E−04 | 1.70815E−06 | −6.27136E−07 | 1.10228E−08 |
| A20 | 6.88803E−05 | 2.37636E−06 | 8.21125E−07 | 1.89100E−08 |

| | 14 | 15 |
|---|---|---|
| C | 0.22957 | 0.74766 |
| K | 0.07699 | −5.40490 |
| A3 | −5.76551E−02 | 3.68796E−02 |
| A4 | −1.89207E−01 | −1.43486E−01 |
| A5 | 7.93428E−02 | 7.35342E−02 |
| A6 | 1.28564E−02 | 6.51944E−04 |
| A7 | −2.04002E−03 | −1.02959E−02 |
| A8 | −3.02596E−03 | 2.22635E−03 |
| A9 | 7.45797E−05 | 1.80261E−06 |
| A10 | 2.20328E−04 | 2.64740E−05 |
| A11 | 4.56422E−06 | 6.54846E−06 |
| A12 | −1.21163E−05 | −1.32982E−05 |
| A13 | 4.51029E−07 | −1.66848E−07 |
| A14 | 4.99638E−07 | 1.03583E−06 |
| A15 | −3.49211E−08 | −2.65262E−08 |
| A16 | −1.83488E−09 | −2.21659E−08 |
| A17 | −2.29962E−09 | −9.16898E−12 |
| A18 | −9.40204E−10 | 1.88048E−10 |
| A19 | −9.69356E−11 | −3.55039E−11 |
| A20 | 8.71850E−11 | −4.63174E−12 |

Various aberrations in Numerical example 19 above are illustrated in FIG. 38. As can be appreciated from the respective aberration diagrams, it is clear that the various aberrations are favorably corrected while the lens is small-sized, and excellent optical performance is achieved.

### Other Numerical Data of Each Example

Table 58 shows a summarization, for each of Numerical Examples, of a focal length of a lens system as a whole f, an F value, a half angle of view ω, and values of the respective focal lengths f1, f2, f3, f4, f5, f6, and f7 of the first lens L1, the second lens L2, the third lens L3, the fourth lens L4, the fifth lens L5, the sixth lens L6, and the seventh lens L7.

Further, Table 59 and Table 60 each show a summarization, for each of Numerical Examples, of values relating to the above-described respective conditional expressions. It is to be noted that Example 18 falls outside the range of conditional expression (2).

TABLE 58

| | Example | Example | Example | Example | Example | Example | Example |
|---|---|---|---|---|---|---|---|
| | 1 | 2 | 3 | 4 | 5 | 6 | 7 |
| f | 4.409 | 4.486 | 4.447 | 4.621 | 4.481 | 4.786 | 4.746 |
| F | 1.649 | 1.668 | 1.598 | 1.716 | 1.606 | 1.641 | 1.672 |
| Value | | | | | | | |
| Total | 5.852 | 5.845 | 5.856 | 6.018 | 5.855 | 5.854 | 5.855 |
| Length | | | | | | | |
| ω | 40.3 | 39.8 | 40.1 | 38.8 | 39.9 | 37.8 | 38.1 |
| f1 | 50.679 | 19.581 | −8.909 | 283.635 | 553.175 | 56.176 | 52.915 |
| f2 | 3.575 | 3.887 | 2.290 | 3.618 | 3.881 | 3.503 | 3.595 |
| f3 | −6.803 | −6.484 | −6.792 | −6.588 | −12.284 | −6.875 | −6.871 |
| f4 | 20141.700 | 375.405 | −16.990 | 49.636 | −1982.170 | 14.496 | 30.157 |
| f5 | −111.228 | −103.895 | 106.995 | −81.684 | −16.311 | 59.970 | 85.421 |
| f6 | 4.414 | 4.574 | 4.008 | 4.426 | 3.507 | 4.800 | 6.037 |
| f7 | −3.918 | −3.859 | −3.347 | −3.945 | −3.032 | −2.533 | −3.261 |
| | Example | Example | Example | Example | Example | Example | Example |
| | 8 | 9 | 10 | 11 | 12 | 13 | 14 |
| f | 4.497 | 4.700 | 4.986 | 4.227 | 4.634 | 4.124 | 4.414 |
| F | 1.650 | 1.651 | 1.876 | 1.591 | 1.739 | 1.555 | 1.647 |
| Value | | | | | | | |
| Total | 5.855 | 5.855 | 5.851 | 5.729 | 5.819 | 5.585 | 5.853 |
| Length | | | | | | | |
| ω | 39.8 | 38.4 | 36.4 | 39.5 | 33.2 | 37.4 | 40.2 |
| f1 | 80.096 | 80.195 | 55.709 | 47.067 | 51.770 | 45.892 | 54.544 |
| f2 | 3.853 | 3.762 | 2.566 | 5.241 | 2.697 | 5.363 | 3.571 |
| f3 | −10.991 | −8.140 | −5.035 | −12.778 | −2.949 | −17.003 | −6.964 |
| f4 | −315.696 | 33.779 | −50.233 | 24.578 | 39.929 | 29.046 | −234.070 |
| f5 | −22.687 | −29.013 | −628.260 | −28.830 | 13.765 | −23.225 | −190.158 |
| f6 | 3.709 | 3.839 | 9.597 | 3.721 | 5.555 | 3.594 | 4.447 |
| f7 | −3.004 | −2.776 | −3.466 | −3.801 | −4.252 | −3.816 | −3.934 |

| | Example | Example | Example | Example | Example |
|---|---|---|---|---|---|
| | 15 | 16 | 17 | 18 | 19 |
| f | 4.436 | 4.400 | 4.280 | 3.934 | 4.405 |
| F | 1.683 | 1.648 | 1.600 | 1.730 | 1.615 |
| Value | | | | | |
| Total | 5.753 | 5.830 | 5.804 | 5.542 | 5.851 |
| Length | | | | | |
| ω | 38.7 | 37.3 | 40.7 | 43.4 | 40.3 |
| f1 | 81.240 | 47.413 | 260.379 | 27.014 | 44.463 |
| f2 | 3.507 | 3.525 | 3.475 | 3.625 | 3.569 |
| f3 | −6.337 | −6.892 | −6.868 | −7.213 | −6.615 |
| f4 | 72.206 | −31.800 | 118.991 | 34.111 | −356.575 |
| f5 | −92.407 | −37.496 | 1205.600 | −12.109 | −115.298 |
| f6 | 4.076 | 2.810 | 4.602 | 3.909 | 4.444 |
| f7 | −3.440 | −2.530 | −4.017 | −3.124 | −3.925 |

TABLE 59

| | | Example | Example | Example | Example | Example |
|---|---|---|---|---|---|---|
| Conditional Expressions | | 1 | 2 | 3 | 4 | 5 |
| (1) | f/f1 | 0.087 | 0.229 | −0.499 | 0.016 | 0.008 |
| (2) | θmax(L1R1) | 8.73 | 8.55 | 4.54 | 21.88 | 7.97 |
| (3) | R(L3R2)/f | 0.639 | 0.600 | 0.542 | 0.647 | 4.990 |
| (4) | θmax(L6R1) | 0.68 | 0.00 | 0.62 | 0.65 | 3.16 |
| (4) | θmin(L6R1) | 0.00 | −0.21 | 0.00 | 0.00 | 0.00 |
| (5) | θmax(L6R2) | 0.00 | 0.00 | 0.00 | 0.00 | 0.00 |
| (5) | θmin(L6R2) | −17.09 | −17.86 | −15.29 | −16.74 | −21.15 |
| (6) | θmax (L3R2) | 32.77 | 33.82 | 34.05 | 30.18 | 22.16 |
| (7) | f12/f | 0.794 | 0.762 | 0.746 | 0.800 | 0.889 |
| (8) | f3/f | −1.543 | −1.445 | −1.527 | −1.426 | −2.741 |
| (9) | T(L3)/f | 0.054 | 0.052 | 0.063 | 0.072 | 0.062 |
| (10) | νd(L1) | 56.02 | 56.02 | 56.02 | 56.02 | 56.02 |
| (11) | νd(L3) | 20.36 | 20.36 | 20.37 | 20.37 | 20.36 |
| (12) | νd(L5) | 23.89 | 23.58 | 23.91 | 23.91 | 20.36 |
| (13) | νd(L4) | 56.02 | 56.02 | 56.02 | 56.02 | 56.02 |
| (14) | νd(L6) | 56.02 | 56.02 | 56.02 | 56.02 | 56.02 |
| (15) | νd(L7) | 55.63 | 55.63 | 55.63 | 55.63 | 55.63 |
| | | Example | Example | Example | Example | Example |
| Conditional Expressions | | 6 | 7 | 8 | 9 | 10 |
| (1) | f/f1 | 0.085 | 0.090 | 0.056 | 0.059 | 0.090 |
| (2) | θmax(L1R1) | 6.08 | 9.24 | 9.55 | 13.18 | 5.39 |
| (3) | R(L3R2)/f | 0.454 | 0.463 | 2.031 | 0.429 | 1.505 |
| (4) | θmax(L6R1) | 0.00 | 0.00 | 3.61 | 0.27 | 0.00 |
| (4) | θmin(L6R1) | −14.97 | −5.01 | 0.00 | 0.00 | −2.19 |
| (5) | θmax(L6R2) | 0.00 | 0.00 | 0.00 | 0.00 | 0.00 |
| (5) | θmin(L6R2) | −30.54 | −6.96 | −20.82 | −20.18 | −9.93 |
| (6) | θmax (L3R2) | 34.94 | 34.08 | 5.99 | 37.11 | 20.90 |
| (7) | f12/f | 0.718 | 0.739 | 0.859 | 0.789 | 0.522 |
| (8) | f3/f | −1.436 | −1.448 | −2.444 | −1.732 | −1.010 |
| (9) | T(L3)/f | 0.065 | 0.076 | 0.058 | 0.060 | 0.061 |
| (10) | νd(L1) | 56.02 | 56.02 | 56.02 | 56.02 | 56.02 |
| (11) | νd(L3) | 20.36 | 20.36 | 20.36 | 20.37 | 23.83 |
| (12) | νd(L5) | 22.70 | 23.37 | 20.36 | 23.89 | 20.36 |
| (13) | νd(L4) | 56.02 | 56.02 | 56.02 | 56.02 | 56.02 |
| (14) | νd(L6) | 56.02 | 56.02 | 56.02 | 56.02 | 56.02 |
| (15) | νd(L7) | 55.63 | 55.63 | 55.63 | 55.63 | 55.63 |

TABLE 60

| | | Example | Example | Example | Example | Example |
|---|---|---|---|---|---|---|
| Conditional Expressions | | 11 | 12 | 13 | 14 | 15 |
| (1) | f/f1 | 0.090 | 0.090 | 0.090 | 0.081 | 0.055 |
| (2) | θmax(L1R1) | 8.40 | 5.49 | 10.30 | 8.72 | 5.94 |
| (3) | R(L3R2)/f | 0.503 | 0.454 | 0.490 | 0.632 | 0.643 |
| (4) | θmax(L6R1) | 1.31 | 0.00 | 1.26 | 0.61 | 1.25 |
| (4) | θmin(L6R1) | 0.00 | −4.91 | 0.00 | 0.00 | 0.00 |
| (5) | θmax(L6R2) | 0.00 | 0.00 | 0.00 | 0.00 | 0.00 |
| (5) | θmin(L6R2) | −21.77 | −19.82 | −20.06 | −18.68 | −19.92 |
| (6) | θmax (L3R2) | 34.33 | 31.00 | 34.48 | 33.51 | 29.61 |
| (7) | f12/f | 1.152 | 0.582 | 1.198 | 0.795 | 0.789 |
| (8) | f3/f | −3.023 | −0.636 | −4.123 | −1.578 | −1.429 |
| (9) | T(L3)/f | 0.066 | 0.055 | 0.070 | 0.045 | 0.141 |
| (10) | νd(L1) | 56.02 | 56.02 | 56.02 | 56.02 | 56.02 |
| (11) | νd(L3) | 20.36 | 23.89 | 22.35 | 20.51 | 21.52 |
| (12) | νd(L5) | 20.36 | 23.54 | 20.36 | 23.38 | 21.77 |
| (13) | νd(L4) | 56.02 | 56.02 | 56.02 | 56.02 | 56.02 |
| (14) | νd(L6) | 56.02 | 56.02 | 56.02 | 56.02 | 56.02 |
| (15) | νd(L7) | 55.63 | 55.63 | 55.63 | 55.63 | 55.63 |

| | | Example | Example | Example | Example |
|---|---|---|---|---|---|
| Conditional Expressions | | 16 | 17 | 18 | 19 |
| (1) | f/f1 | 0.093 | 0.016 | 0.146 | 0.099 |
| (2) | θmax(L1R1) | 5.77 | 11.85 | — | 8.5 |
| (3) | R(L3R2)/f | 0.537 | 0.675 | 0.696 | 0.634 |
| (4) | θmax(L6R1) | 7.95 | 1.10 | 3.64 | 0.00 |
| (4) | θmin(L6R1) | 0.00 | 0.00 | 0.00 | −0.63 |
| (5) | θmax(L6R2) | 0.00 | 0.00 | 0.00 | 0.00 |
| (5) | θmin(L6R2) | −20.59 | −16.38 | −24.50 | −18.94 |
| (6) | θmax (L3R2) | 34.85 | 32.91 | 34.68 | 32.79 |
| (7) | f12/f | 0.779 | 0.842 | 0.815 | 0.783 |
| (8) | f3/f | −1.566 | −1.604 | −1.833 | −1.502 |
| (9) | T(L3)/f | 0.056 | 0.057 | 0.055 | 0.050 |
| (10) | νd(L1) | 56.02 | 59.46 | 56.02 | 77.03 |
| (11) | νd(L3) | 20.39 | 20.55 | 21.51 | 20.51 |
| (12) | νd(L5) | 23.89 | 23.89 | 23.91 | 24.77 |
| (13) | νd(L4) | 56.02 | 56.05 | 56.02 | 56.02 |
| (14) | νd(L6) | 56.02 | 56.02 | 55.63 | 56.02 |
| (15) | νd(L7) | 55.63 | 55.63 | 55.63 | 55.63 |

### 5. Other Embodiments

A technique of the present disclosure is not limited to the above description of the embodiments and the examples, and may be variously modified.

For example, the shapes of the respective sections and the numerical values illustrated in the above-described Numerical Examples are merely illustrative for carrying out the technology, and should not be used to construe the technical scope of the technology in a limitative manner.

In addition, the configuration substantially including seven lenses has been described in the embodiment and the examples described above; however, a configuration further including a lens that does not have refractive power substantially is adoptable.

Further, the technology may achieve the following configuration, for example.

[1]

An imaging lens including, in order from object side toward image plane side:

a first lens having a meniscus shape, the meniscus shape having a shape that is positioned near an optical axis and includes a convex surface that faces the object side;

a second lens including a convex surface that faces, near the optical axis, the object side, and having, near the optical axis, positive refractive power;

a third lens having, near the optical axis, negative refractive power;

a fourth lens;

a fifth lens;

a sixth lens having, near the optical axis, positive refractive power; and

a seventh lens having, near the optical axis, negative refractive power, and including a lens surface, the lens surface being positioned on the image plane side and having an aspherical shape that has an inflection point.

[2]

The imaging lens according to [1], in which a following conditional expression is satisfied:

−0.5<f/f1<0.23 (1)

where

f is a focal length of a lens system as a whole, and

f1 is a focal length of the first lens.

[3]

The imaging lens according to [1] or [2], in which following conditional expressions are satisfied:

0<θmax(L1R1)<25 (2)

0.3<R(L3R2)/f<5 (3)

where

θmax (L1R1) is a maximum value of a surface angle of a lens surface, on the object side, of the first lens within an effective diameter (where inclination of the lens surface toward the image plane side is defined as positive, and where a unit is “degree”),

R (L3R2) is radius of curvature of a lens surface, on the image plane side, of the third lens, and

f is a focal length of a lens system as a whole.

[4]

The imaging lens according to any one of [1] to [3], in which following conditional expressions are satisfied:

−15<θmin(L6R1)<θmax(L6R1)<8 (4)

−31<θmin(L6R2)<θmax(L6R2)<−5 (5)

where

θmax (L6R1) is a maximum value of a surface angle of a lens surface, on the object side, of the sixth lens within a diameter of 30% of an effective diameter (where inclination of the lens surface toward the image plane side is defined as positive, and where a unit is “degree”),

θmin (L6R1) is a minimum value of the surface angle of the lens surface, on the object side, of the sixth lens within the diameter of 30% of the effective diameter (where inclination of the lens surface toward the image plane side is defined as positive, and where a unit is “degree”),

θmax (L6R2) is a maximum value of a surface angle of a lens surface, on the image plane side, of the sixth lens within a diameter of 70% of an effective diameter (where inclination of the lens surface toward the image plane side is defined as positive, and where a unit is “degree”), and

θmin (L6R2) is a minimum value of the surface angle of the lens surface, on the image plane side, of the sixth lens within the diameter of 70% of the effective diameter (where inclination of the lens surface toward the image plane side is defined as positive, and where a unit is “degree”).

[5]

The imaging lens according to any one of [1] to [4], in which a following conditional expression is satisfied:

5<θmax(L3R2)<40 (6)

where

θmax (L3R2) is a maximum value of a surface angle of a lens surface, on the image plane side, of the third lens within an effective diameter (where inclination of the lens surface toward the image plane side is defined as positive, and where a unit is “degree”).

[6]

The imaging lens according to any one of [1] to [5], in which a following conditional expression is satisfied:

0.3<f12/f<2.0 (7)

where

f is a focal length of a lens system as a whole, and

f12 is a composite focal length of the first lens and the second lens.

[7]

The imaging lens according to any one of [1] to [6], in which a following conditional expression is satisfied:

−5<f3/f<−0.5 (8)

where

f is a focal length of a lens system as a whole, and

f3 is a focal length of the third lens.

[8]

The imaging lens according to any one of [1] to [7], in which a following conditional expression is satisfied:

0.023<T(L3)/f<0.15 (9)

where

f is a focal length of a lens system as a whole, and

T(L3) is a center thickness of the third lens.

[9]

The imaging lens according to any one of [1] to [9], in which a following conditional expression is satisfied:

νd(L1)>50 (10)

where

νd (L1) is Abbe number of the first lens to d line.

[10]

The imaging lens according to any one of [1] to [10], in which following conditional expressions are satisfied:

νd(L3)<35 (11)

νd(L5)<35 (12)

where

νd (L3) is Abbe number of the third lens to d line, and

νd (L5) is Abbe number of the fifth lens to the d line.

[11]

The imaging lens according to any one of [1] to [11], in which following conditional expressions are satisfied:

νd(L4)>50 (13),

νd(L6)>50 (14)

νd(L7)>50 (15).

where

νd (L4) is Abbe number of the fourth lens to d line,

νd (L6) is Abbe number of the sixth lens to the d line, and

νd (L7) is Abbe number of the seventh lens to the d line.

[12]

An imaging lens including, in order from object side toward image plane side:

a first lens;

a second lens having, near an optical axis, positive refractive power;

a third lens having, near the optical axis, negative refractive power;

a fourth lens;

a fifth lens;

a sixth lens having, near the optical axis, positive refractive power; and

a seventh lens that having, near the optical axis, negative refractive power, and including a lens surface, the lens surface being positioned on the image plane side and having an aspherical shape that has an inflection point,

in which a following conditional expression is satisfied,

−0.5<f/f1<0.23 (1)

where

f is a focal length of a lens system as a whole, and

f1 is a focal length of the first lens.

[13]

The imaging lens according to [12], in which a following conditional expression is satisfied:

0.3<R(L3R2)/f<5 (3)

where

R (L3R2) is radius of curvature of a lens surface, on the image plane side, of the third lens, and

f is the focal length of the lens system as a whole.

[14]

The imaging lens according to [12] or [13], in which following conditional expressions are satisfied:

−15<θmin(L6R1)<θmax(L6R1)<8 (4)

−31<θmin(L6R2)<θmax(L6R2)<−5 (5)

where

θmax (L6R1) is a maximum value of a surface angle of a lens surface, on the object side, of the sixth lens within a diameter of 30% of an effective diameter (where inclination of the lens surface toward the image plane side is defined as positive, and where a unit is “degree”),

θmin (L6R1) is a minimum value of the surface angle of the lens surface, on the object side, of the sixth lens within the diameter of 30% of the effective diameter (where inclination of the lens surface toward the image plane side is defined as positive, and where a unit is “degree”).

θmax (L6R2) is a maximum value of a surface angle of a lens surface, on the image plane side, of the sixth lens within a diameter of 70% of an effective diameter (where inclination of the lens surface toward the image plane side is defined as positive, and where a unit is “degree”), and

θmin (L6R2) is a minimum value of the surface angle of the lens surface, on the image plane side, of the sixth lens within the diameter of 70% of the effective diameter (where inclination of the lens surface toward the image plane side is defined as positive, and where a unit is “degree”).

[15]

The imaging lens according to any one of [12] to [14], in which a following conditional expression is satisfied:

5<θmax(L3R2)<40 (6)

where

θmax (L3R2) is a maximum value of a surface angle of a lens surface, on the image plane side, of the third lens within an effective diameter (where inclination of the lens surface toward the image plane side is defined as positive, and where a unit is “degree”).

[16]

The imaging lens according to any one of [12] to [15], in which a following conditional expression is satisfied:

0.3<f12/f<2.0 (7)

where

f is the focal length of the lens system as a whole, and

f12 is a composite focal length of the first lens and the second lens.

[17]

The imaging lens according to any one of [12] to [16], in which a following conditional expression is satisfied:

−5<f3/f<−0.5 (8)

where

f is the focal length of the lens system as a whole, and

f3 is a focal length of the third lens.

[18]

The imaging lens according to any one of [12] to [17], in which a following conditional expression is satisfied:

0.023<T(L3)/f<0.15 (9)

where

f is the focal length of the lens system as a whole, and

T (L3) is a center thickness of the third lens.

[19]

The imaging lens according to any one of [1] to [18], further including a lens that does not substantially have refractive power.

[20]

An imaging apparatus provided with an imaging lens and an imaging device that outputs an imaging signal corresponding to an optical image formed by the imaging lens, the imaging lens including, in order from object side toward image plane side:

a first lens having a meniscus shape, the meniscus shape having a shape that is positioned near an optical axis and includes a convex surface that faces the object side;

a second lens including a convex surface that faces, near the optical axis, the object side, and having, positive refractive power near the optical axis;

a third lens having, near the optical axis, negative refractive power;

a fourth lens;

a fifth lens;

a sixth lens having, near the optical axis, positive refractive power; and

a seventh lens having, near the optical axis, negative refractive power, and including a lens surface, the lens surface being positioned on the image plane side and having an aspherical shape that has an inflection point.

[21]

An imaging apparatus provided with an imaging lens and an imaging device that outputs an imaging signal corresponding to an optical image formed by the imaging lens, the imaging lens including, in order from object side toward image plane side:

a first lens;

a second lens having, near the optical axis, positive refractive power;

a third lens having, near the optical axis, negative refractive power;

a fourth lens;

a fifth lens;

a sixth lens having, near the optical axis, positive refractive power; and

a seventh lens having, near the optical axis, negative refractive power, and including a lens surface, the lens surface being positioned on the image plane side and having an aspherical shape that has an inflection point,

in which a following conditional expression is satisfied,

−0.5<f/f1<0.23 (1)

where

f is a focal length of a lens system as a whole, and

f1 is a focal length of the first lens.

[22]

The imaging apparatus according to [20] or [21], in which the imaging lens further includes a lens that does not substantially have refractive power.

This application is based upon and claims the benefit of priority of the Japanese Patent Application No. 2016-100377 filed with the Japan Patent Office on May 19, 2016, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An imaging lens comprising, in order from object side toward image plane side:
a first lens having a meniscus shape, the meniscus shape having a shape that is positioned near an optical axis and includes a convex surface that faces the object side;
a second lens including a convex surface that faces, near the optical axis, the object side, and having, near the optical axis, positive refractive power;
a third lens having, near the optical axis, negative refractive power;
a fourth lens;
a fifth lens;
a sixth lens having, near the optical axis, positive refractive power; and
a seventh lens having, near the optical axis, negative refractive power, and including a lens surface, the lens surface being positioned on the image plane side and having an aspherical shape that has an inflection point.

2. The imaging lens according to claim 1, wherein a following conditional expression is satisfied:
−0.5<f/f1<0.23 (1)
where
f is a focal length of a lens system as a whole, and
f1 is a focal length of the first lens.

3. The imaging lens according to claim 1, wherein following conditional expressions are satisfied:
0<θmax(L1R1)<25 (2)
0.3<R(L3R2)/f<5 (3)
where
θmax (L1R1) is a maximum value of a surface angle of a lens surface, on the object side, of the first lens within an effective diameter (where inclination of the lens surface toward the image plane side is defined as positive, and where a unit is “degree”),
R (L3R2) is radius of curvature of a lens surface, on the image plane side, of the third lens, and
f is a focal length of a lens system as a whole.

4. The imaging lens according to claim 1, wherein following conditional expressions are satisfied:
−15<θmin(L6R1)<θmax(L6R1)<8 (4)
−31<θmin(L6R2)<θmax(L6R2)<−5 (5)
where
θmax (L6R1) is a maximum value of a surface angle of a lens surface, on the object side, of the sixth lens within a diameter of 30% of an effective diameter (where inclination of the lens surface toward the image plane side is defined as positive, and where a unit is “degree”),
θmin (L6R1) is a minimum value of the surface angle of the lens surface, on the object side, of the sixth lens within the diameter of 30% of the effective diameter (where inclination of the lens surface toward the image plane side is defined as positive, and where a unit is “degree”),
θmax (L6R2) is a maximum value of a surface angle of a lens surface, on the image plane side, of the sixth lens within a diameter of 70% of an effective diameter (where inclination of the lens surface toward the image plane side is defined as positive, and where a unit is “degree”), and
θmin (L6R2) is a minimum value of the surface angle of the lens surface, on the image plane side, of the sixth lens within the diameter of 70% of the effective diameter (where inclination of the lens surface toward the image plane side is defined as positive, and where a unit is “degree”).

5. The imaging lens according to claim 1, wherein a following conditional expression is satisfied:
5<θmax(L3R2)<40 (6)
where
θmax (L3R2) is a maximum value of a surface angle of a lens surface, on the image plane side, of the third lens within an effective diameter (where inclination of the lens surface toward the image plane side is defined as positive, and where a unit is “degree”).

6. The imaging lens according to claim 1, wherein a following conditional expression is satisfied:
0.3<f12/f<2.0 (7)
where
f is a focal length of a lens system as a whole, and
f12 is a composite focal length of the first lens and the second lens.

7. The imaging lens according to claim 1, wherein a following conditional expression is satisfied:
−5<f3/f<−0.5 (8)
where
f is a focal length of a lens system as a whole, and
f3 is a focal length of the third lens.

8. The imaging lens according to claim 1, wherein a following conditional expression is satisfied:
0.023<T(L3)/f<0.15 (9)
where
f is a focal length of a lens system as a whole, and
T(L3) is a center thickness of the third lens.

9. The imaging lens according to claim 1, wherein a following conditional expression is satisfied:
νd(L1)>50 (10)
where
νd (L1) is Abbe number of the first lens to d line.

10. The imaging lens according to claim 1, wherein following conditional expressions are satisfied:
νd(L3)<35 (11)
νd(L5)<35 (12)
where
νd (L3) is Abbe number of the third lens to d line, and
νd (L5) is Abbe number of the fifth lens to the d line.

11. The imaging lens according to claim 1, wherein following conditional expressions are satisfied:
νd(L4)>50 (13),
νd(L6)>50 (14)
νd(L7)>50 (15),
where
νd (L4) is Abbe number of the fourth lens to d line,
νd (L6) is Abbe number of the sixth lens to the d line, and
νd (L7) is Abbe number of the seventh lens to the d line.

12. An imaging lens comprising, in order from object side toward image plane side:
a first lens;
a second lens having, near an optical axis, positive refractive power;
a third lens having, near the optical axis, negative refractive power;
a fourth lens;
a fifth lens;
a sixth lens having, near the optical axis, positive refractive power; and
a seventh lens having, near the optical axis, negative refractive power, and including a lens surface, the lens surface being positioned on the image plane side and having an aspherical shape that has an inflection point,
wherein a following conditional expression is satisfied,
−0.5<f/f1<0.23 (1)
where
f is a focal length of a lens system as a whole, and
f1 is a focal length of the first lens.

13. The imaging lens according to claim 12, wherein a following conditional expression is satisfied:
0.3<R(L3R2)/f<5 (3)
where
R (L3R2) is radius of curvature of a lens surface, on the image plane side, of the third lens, and
f is the focal length of the lens system as a whole.

14. The imaging lens according to claim 12, wherein following conditional expressions are satisfied:
−15<θmin(L6R1)<θmax(L6R1)<8 (4)
−31<θmin(L6R2)<θmax(L6R2)<−5 (5)
where
θmax (L6R1) is a maximum value of a surface angle of a lens surface, on the object side, of the sixth lens within a diameter of 30% of an effective diameter (where inclination of the lens surface toward the image plane side is defined as positive, and where a unit is “degree”),
θmin (L6R1) is a minimum value of the surface angle of the lens surface, on the object side, of the sixth lens within the diameter of 30% of the effective diameter (where inclination of the lens surface toward the image plane side is defined as positive, and where a unit is “degree”),
θmax (L6R2) is a maximum value of a surface angle of a lens surface, on the image plane side, of the sixth lens within a diameter of 70% of an effective diameter (where inclination of the lens surface toward the image plane side is defined as positive, and where a unit is “degree”), and
θmin (L6R2) is a minimum value of the surface angle of the lens surface, on the image plane side, of the sixth lens within the diameter of 70% of the effective diameter (where inclination of the lens surface toward the image plane side is defined as positive, and where a unit is “degree”).

15. The imaging lens according to claim 12, wherein a following conditional expression is satisfied:
5<θmax(L3R2)<40 (6)
where
θmax (L3R2) is a maximum value of a surface angle of a lens surface, on the image plane side, of the third lens within an effective diameter (where inclination of the lens surface toward the image plane side is defined as positive, and where a unit is “degree”).

16. The imaging lens according to claim 12, wherein a following conditional expression is satisfied:
0.3<f12/f<2.0 (7)
where
f is the focal length of the lens system as a whole, and
f12 is a composite focal length of the first lens and the second lens.

17. The imaging lens according to claim 12, wherein a following conditional expression is satisfied:
−5<f3/f<−0.5 (8)
where
f is the focal length of the lens system as a whole, and
f3 is a focal length of the third lens.

18. The imaging lens according to claim 12, wherein a following conditional expression is satisfied:
0.023<T(L3)/f<0.15 (9)
where
f is the focal length of the lens system as a whole, and
T (L3) is a center thickness of the third lens.

19. An imaging apparatus provided with an imaging lens and an imaging device that outputs an imaging signal corresponding to an optical image formed by the imaging lens, the imaging lens comprising, in order from object side toward image plane side:
a first lens having a meniscus shape, the meniscus shape having a shape that is positioned near an optical axis and includes a convex surface that faces the object side;
a second lens including a convex surface that faces, near the optical axis, the object side, and having, positive refractive power near the optical axis;
a third lens having, near the optical axis, negative refractive power;
a fourth lens;
a fifth lens;
a sixth lens having, near the optical axis, positive refractive power; and
a seventh lens having, near the optical axis, negative refractive power, and including a lens surface, the lens surface being positioned on the image plane side and having an aspherical shape that has an inflection point.

20. An imaging apparatus provided with an imaging lens and an imaging device that outputs an imaging signal corresponding to an optical image formed by the imaging lens, the imaging lens comprising, in order from object side toward image plane side:
a first lens;
a second lens having, near the optical axis, positive refractive power;
a third lens having, near the optical axis, negative refractive power;
a fourth lens;
a fifth lens;
a sixth lens having, near the optical axis, positive refractive power; and
a seventh lens having, near the optical axis, negative refractive power, and including a lens surface, the lens surface being positioned on the image plane side and having an aspherical shape that has an inflection point,
wherein a following conditional expression is satisfied,
−0.5<f/f1<0.23 (1)
where
f is a focal length of a lens system as a whole, and
f1 is a focal length of the first lens.
